(19) United States
(12) Patent Application Publication
(10) Pub. No.: US 2007/0106492 A1
(43) Pub. Date: May 10, 2007

(54) Apparatus and method for inputting alphabet characters

(76) Inventor: Min Kyum Kim, Seoul (KR)

Correspondence Address: Jonathan Y Kang;Lee Hong Degerman Kang & Schmadeka, 14th Floor, 801 South Figueroa Street, Los Angeles, CA, 90017-5554, US

(21) Appl. No.: 10/484,313

(22) PCT Filed: Jul. 18, 2002
(86) PCT No.: PCT/KR02/01355

§ 371 Date: Jan. 20, 2004

(30) Foreign Application Priority Data
Jul. 18, 2001 (KR) 2001/0043248
Jul. 19, 2001 (KR) 2001-0043591
Jul. 20, 2001 (KR) 2001-0043911
Jul. 24, 2001 (KR) 2001-0046078
Aug. 11, 2001 (KR) 2001-0048585
Aug. 14, 2001 (KR) 2001-0049456
Aug. 18, 2001 (KR) 2001-0049832
Oct. 23, 2001 (KR) 2001-0065210
Dec. 26, 2001 (WO) PCT/KR01/02267
Dec. 26, 2001 (KR) 2002-0000357
May 25, 2002 (KR) 2002-0035811
Jul. 16, 2002 (KR) PCTKR02/01346

(51) Int. Cl. G06F 17/27

(52) U.S. Cl. 704/9

(57) ABSTRACT

The invention shows that words or phrases may be input without ambiguity in some languages and with a little ambiguity in most languages by applying (language restricted) RSM and CVSK. Moreover, this invention proposes an innovative system which recognizes in early stage of input whether an input value is a simple code or a full code by CIM (i.e. Language Restricted CIM) with a language restricted input method as FIM.

### BACKGROUND OF THE INVENTION

(a) Field of the Invention

The present invention relates to an apparatus and method for inputting characters from a keypad. More specifically, the present invention relates to an apparatus and method for inputting characters from a keypad having a small number of buttons such as a telephone keypad.

(b) Description of the Related Art

With the progress of mobile communications, a function of receiving and sending digital information such as text messages is added to a mobile station chiefly used for voice calls. Hence, the keypad provided on the mobile station for the entry of a telephone number additionally has a function of entering characters, thus reducing the size of the keypad used as an input means in the mobile station and hence limiting the number of buttons included on the keypad. Alphabets of every language are usually much more than 12 keys on the keypad. Therefore a need exists to represent every character with buttons on a telephone keypad alone or in combination of two or more different types.

### SUMMARY OF THE INVENTION

The invention disclosed in the prior documents published by the present applicant (i.e., Application No. 10-2000-0031879 and PCT/KR00/00601) can be summarized as follows.

First, so-called “Part-Whole Selection Method (PWSM)” assigns characters to a given number of lattices provided to every button on the keypad in correspondence to the arrangement of buttons on the keypad, so that the user can enter a desired character (hereinafter, referred to as “target character”) by pressing a first button for the target character in combination with a second button provided on the keypad in correspondence to the arranged position of the character in the lattices of the first button. For example, the user may enter“A=[1]+[2]” in FIG. 1-1.

The core of PWSM is using part of the lattice elements of every button including a base lattice element (BLE), for which the first button is identical to the second one, and particularly, in the Order of Proximity to a BLE that is most convenient in button combination. As such, the base lattice element forms the core of PWSM and a keypad making the use of the conception of the Base Lattice Element is called “Base Keypad (BK)”.

Next, so-called “Base Repeat Selection Method (BRSM)” enables the user to select an character depending on the number of times of pressing a button on a Base Keypad designed to use PWSM in the order of proximity to a BLE, i.e., the Convenient Order of Button Combination (COBC) in PWSM. BRSM makes the user of a Repeat Selection Method (RSM) on the Base Keypad. Expediently, a keypad using only RSM is called “Plain Keypad (PK)”, and a method of using RSM in a PK as is usual is referred to as “Simple Repeat Selection Method (SRSM)”.

There is also a “Control Processing Method (CPM)”, which includes an “Affix Control Processing Method (ACPM)” and a “Succession Control Processing Method (SCPM)”. The affix control processing method is to enter affixed characters by a combination of affix control and basic character. The succession control processing method defines a group of characters assigned to a button as the relation among a representative character and its succession characters, and compounds the representative character and the priority associated with the representative character. For example, the user may enter as [symbol] in FIG. 4-1.

The Affix Control Processing Method (ACPM) is in substance similar to the Succession Character Control Processing (SCPM). The latter is more general than the former, because a specific character group also includes affixed characters belonging to basic characters in a defined sequent order in SCPM. The ACPM has a close connection with the character group in shape because affixed characters are decomposed into an affix and a basic character, while SCPM is closely connected to sequent order and pronunciation.

The CPM are advantageous in that succession (or affixed) characters are not displayed on the keypad through the relation between a basic character and its succession (or affixed) characters to provide a simple arrangement of the keypad and enter character without ambiguity. A keypad that excludes succession characters is called “Succession Keypad (SK)” and one excluding affixed characters is called “Abbreviated Keypad (AK)”. Both SK and AK are referred to as “Concise Keypad (CK)”. A keypad that displays all succession (or affixed) characters in contrast to CK is called “full keypad (FK)”.

The full keypad also enables the entry of succession (or affixed) characters using CPM, while CK allows the user who memorizes the arrangement of the full keypad to perform the entry procedure on the full keypad. As described above, CK can be expanded to the FK and the user can expediently enter succession characters by CPM, which guarantees compatibility characteristic of the prior document.

The control processing method not only removes ambiguity but also simplifies the arrangement of the keypad by “hiding” the succession characters via the relation between a representative character and its succession characters as described in the prior documents. Expediently, this is called “Hiding Control Processing Method (HCPM)”. The succession (or affixed) characters may be input by CPM even on the full keypad on which the succession (or affixed) characters are displayed, as described in the prior documents. Expediently, this is called “Non-hiding Control Processing Method (NCPM)”.

The present invention suggests the improvement of the prior documents of the applicant (Application No. 10-2000-0031879 and PCT/KR00/00601). More particularly, it provides (a) a method for entering commonly used words with a small number of strokes, (b) a method for entering all target characters using a concurrent input method (CIM) that involves both a short-cut input method (SIM) and a full input method (FIM), to reduce input strokes and thereby enhance the convenience in entering characters, (c) a method for entering various symbols on a keypad, and (d) a method for using a move button, not frequently used in the character input mode, as a control button.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1

### DETAILED DESCRIPTION OF THE PREFERRED EMBODIMENTS

First, the content of the prior documents will be explained by language as follows. It is apparent that although not specifically described, the content of the prior documents related to a certain language is also applicable to other languages.

1. Common Supplementary Explanation

1.1. Applications of Keypad in Prior Documents and Present Invention

It is apparent that the keypad proposed in the prior documents and the present invention can be used in all applications that have the form of a telephone keypad, including a numeral keypad of mobile terminals or standard keyboards, a keypad implemented on a screen in software, or a door lock. Although the numeral keypad of the standard keyboards differs in the arrangement of numeral buttons from the keypad of the prior documents and the present invention, the arrangement of the buttons on the keypad of the prior documents and the present invention may be applicable to the keypad of the keyboards. For example, the character assigned to a button [1] in the prior documents and the present invention is set to the button [1] on the numeral keypad of a keyboard, et cetera, which method is applicable to the entry of a character, the use of simple codes and memorization of various codes.

1.2. Determination of Successive Stroke Delay Time (SSDT) and Discrete Stroke Delay Time (DSDT)

For some languages such as Korean and Hindi in which consonants and vowels alternately appear, a pair of a representative consonant and a vowel is assigned to each button such that the consonant is input with one stroke and the vowel is input with two strokes. An algorithm may be implemented to first recognize two strokes of a button given at a predetermined delay time (for example, 0.1 second) interval as a vowel and enable the user to efficiently enter the vowel easily. The delay time has to be determined in consideration of the time interval commonly spent for a stroke in successively pressing the same button. Expediently, such a delay time is called “Successive Stroke Delay Time (SSDT)”. Also, an algorithm may be implemented to first recognize two strokes of a button given at a predetermined delay time (for example, 1 second) interval as two consonants. Expediently, such a delay time is called “Discrete Stroke Delay Time (DSDT)”. This may also be applicable to three or more strokes of the same button.

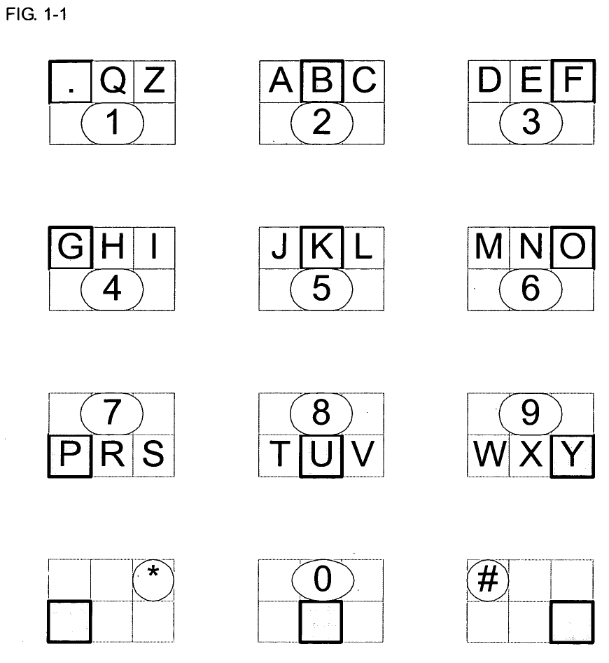

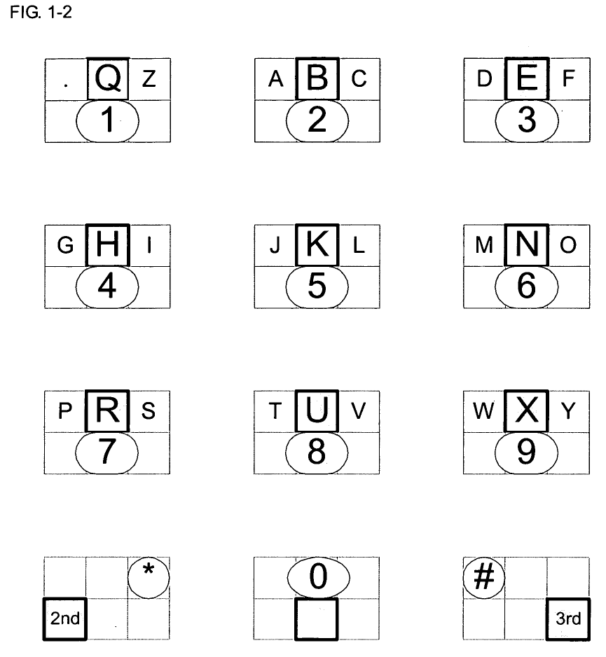

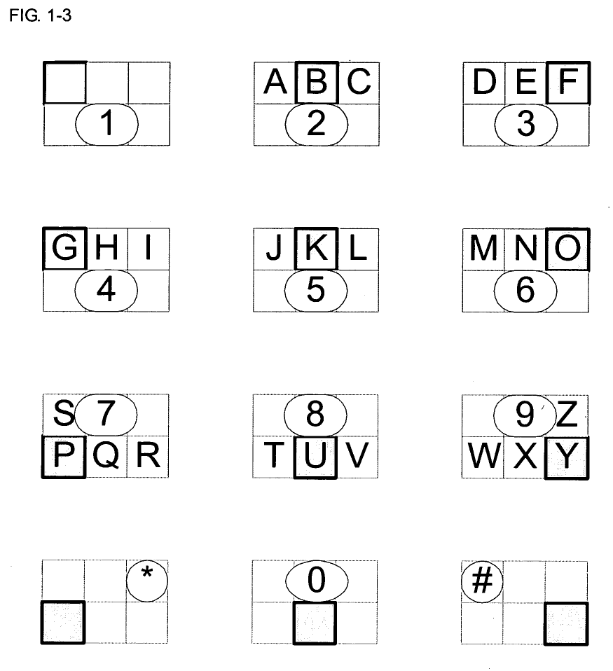

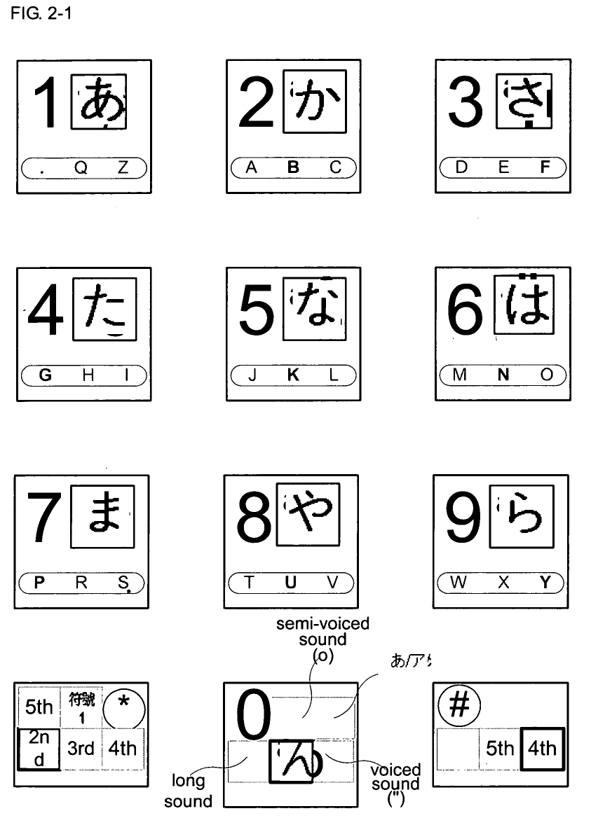

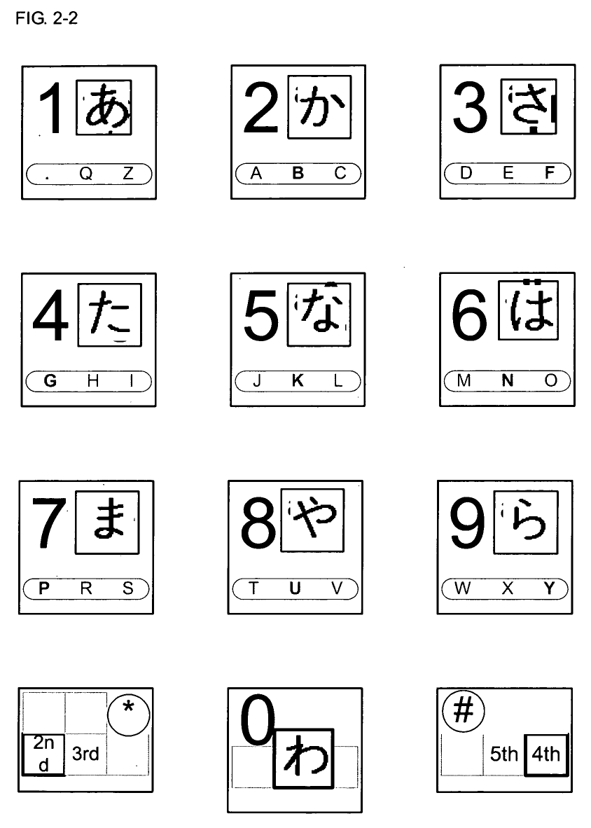

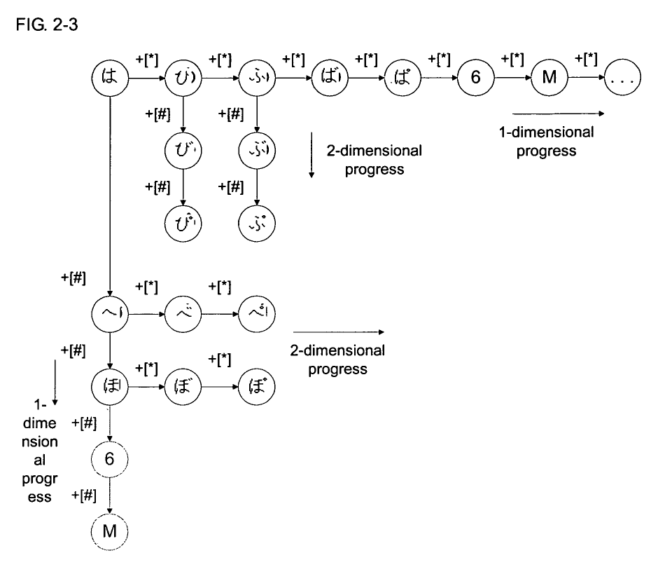

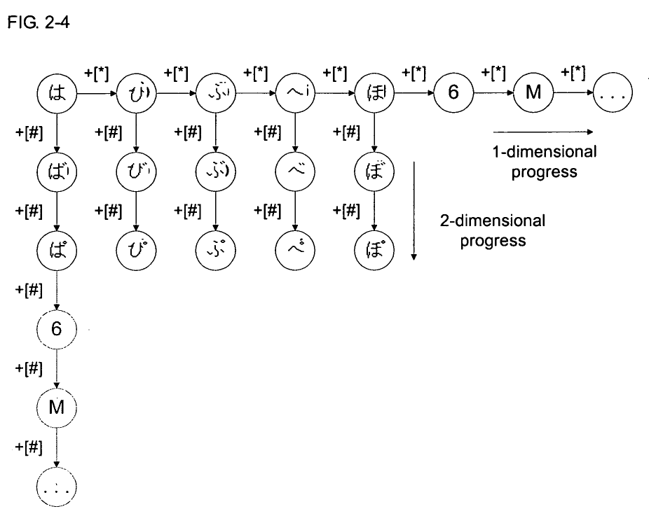

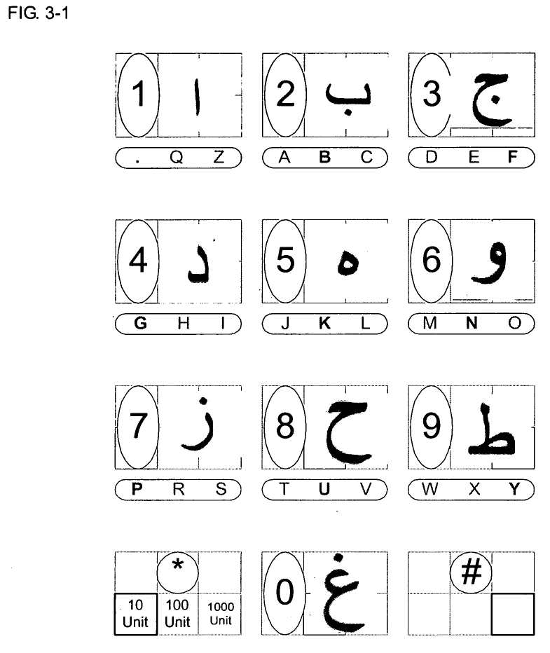

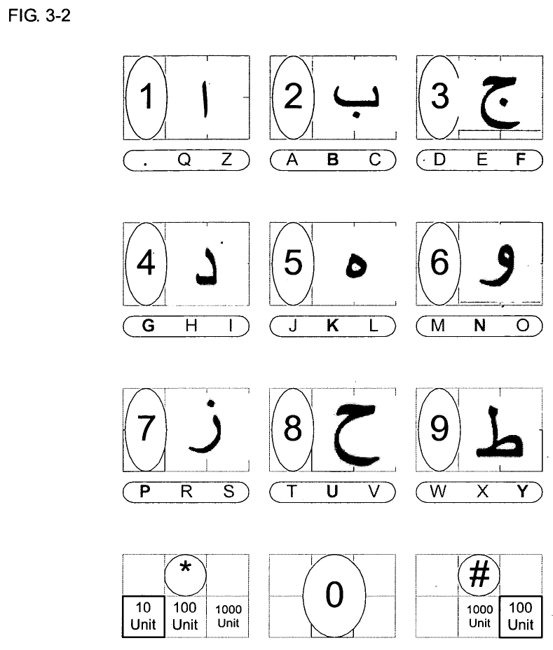

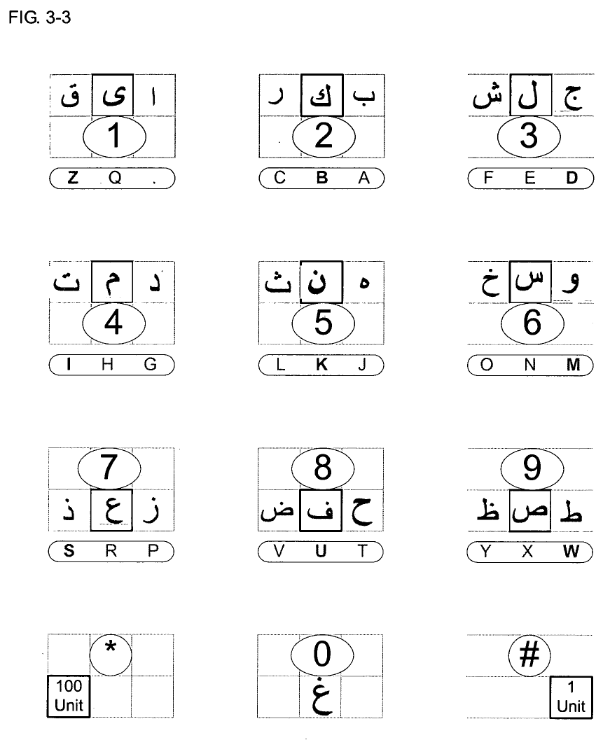

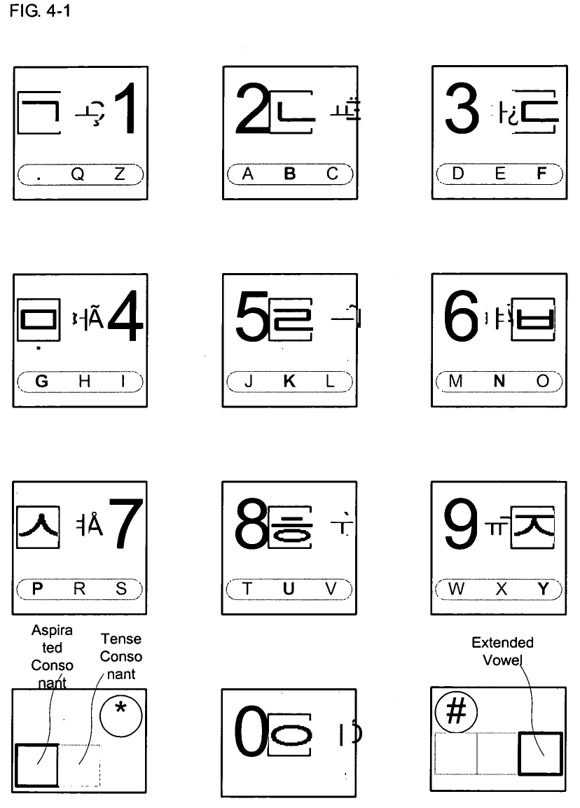

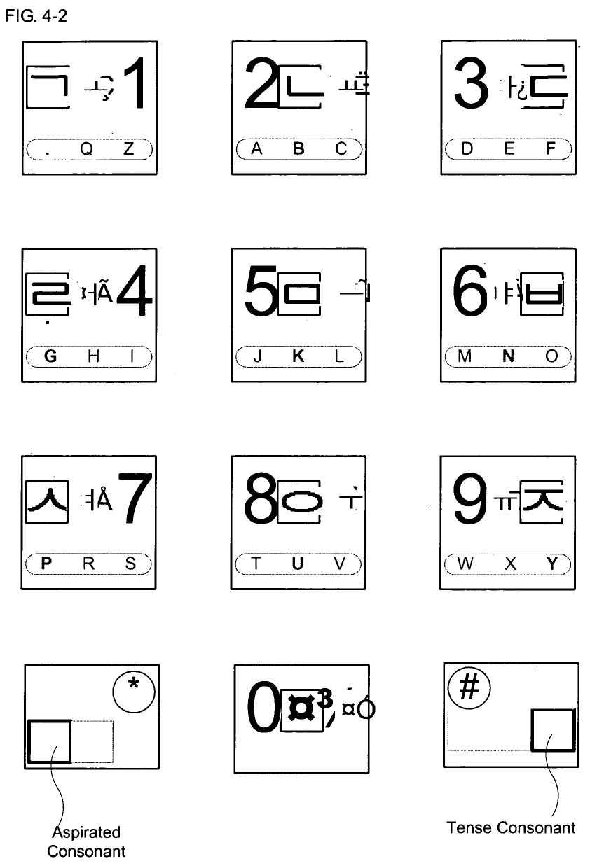

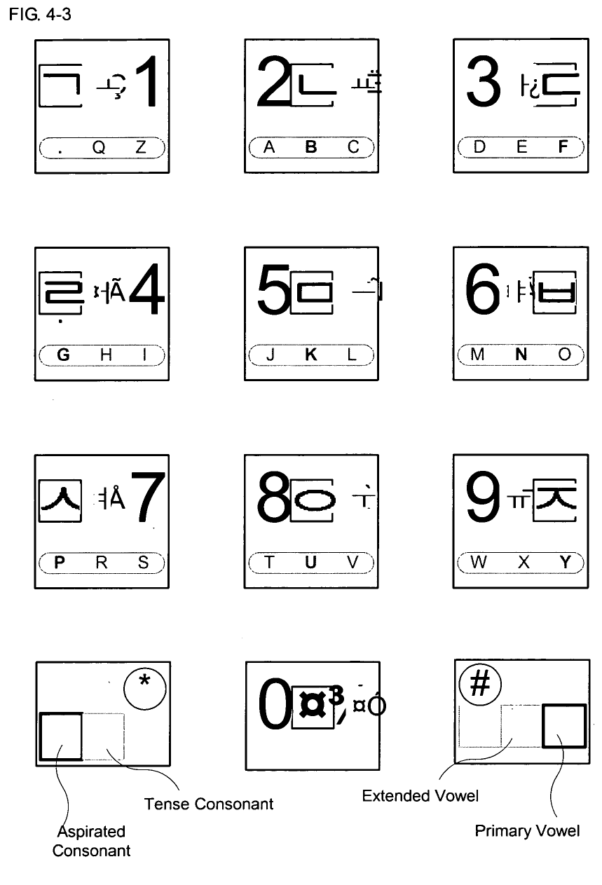

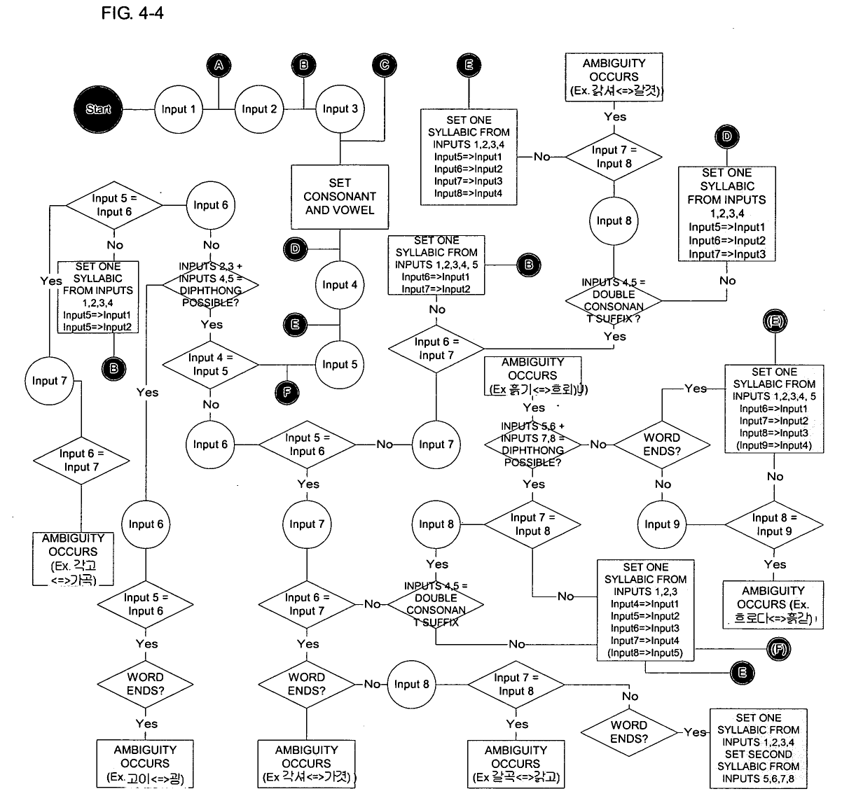

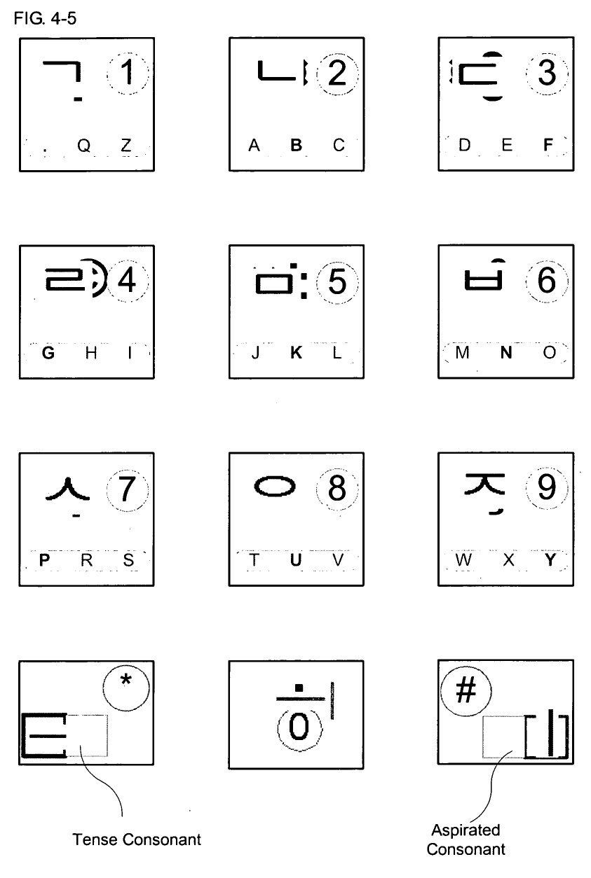

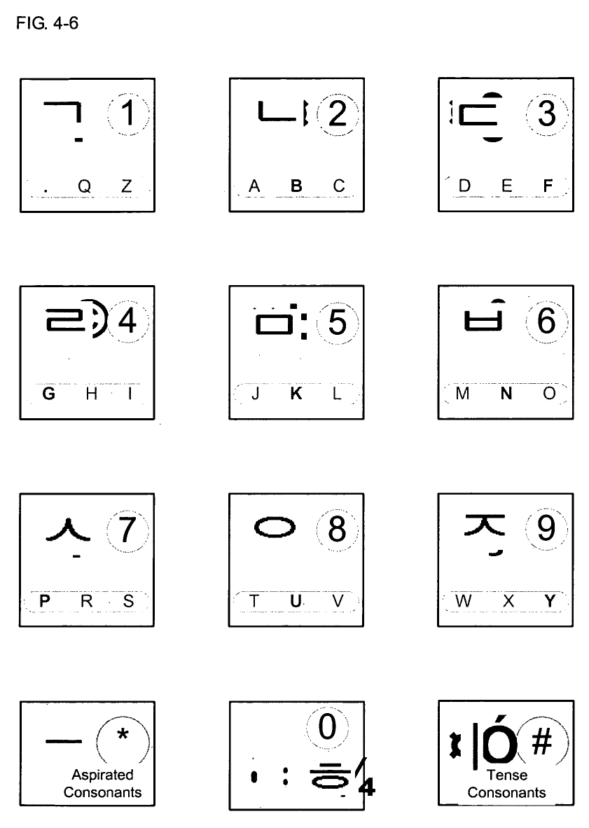

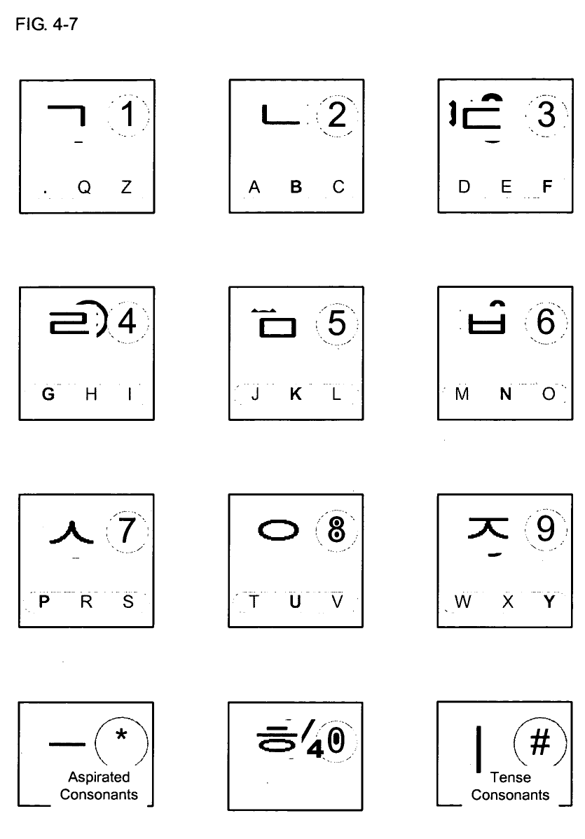

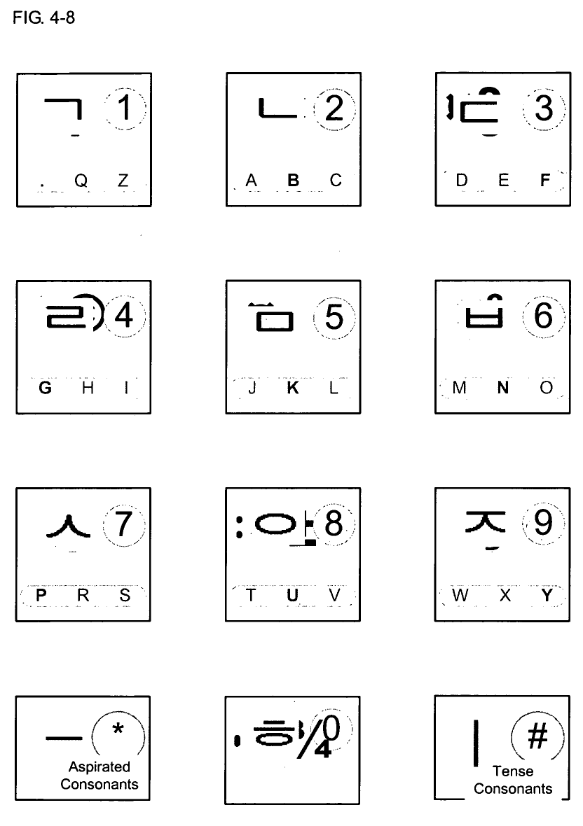

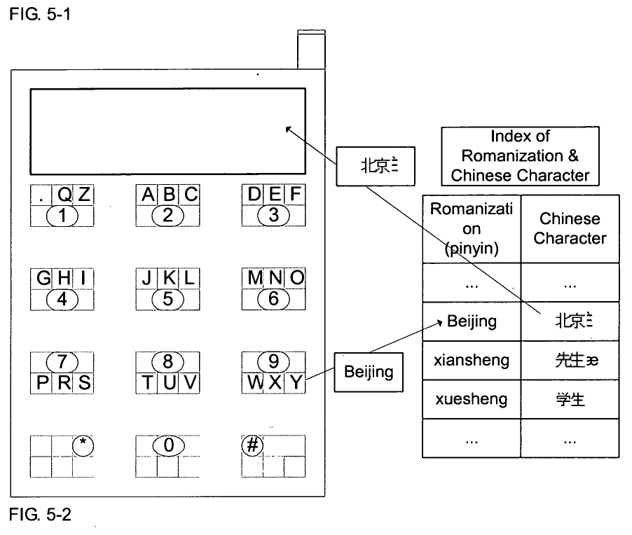

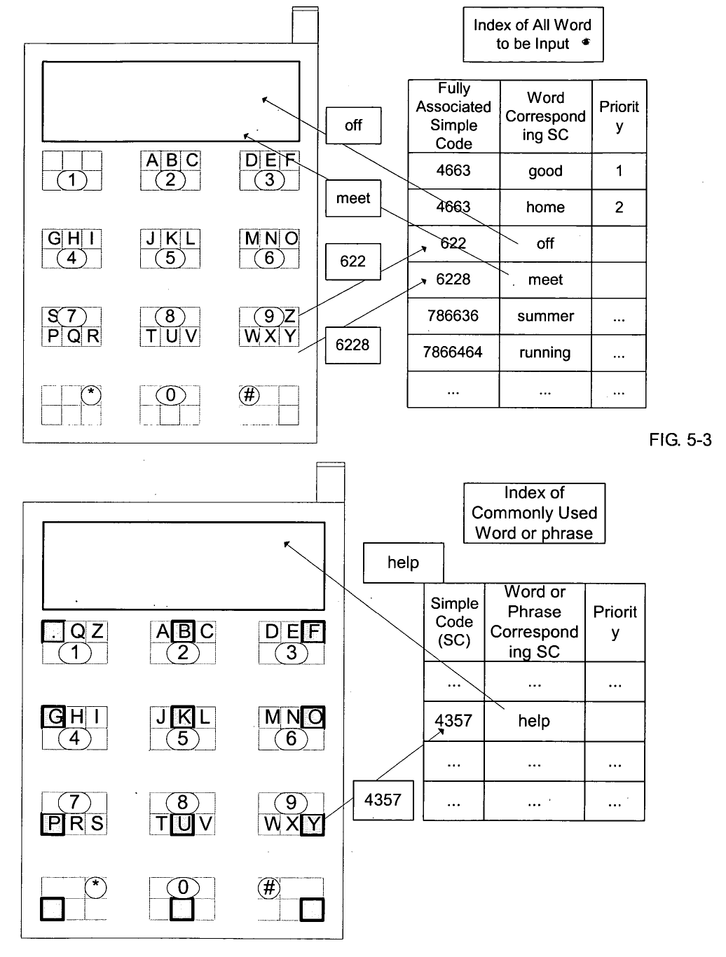

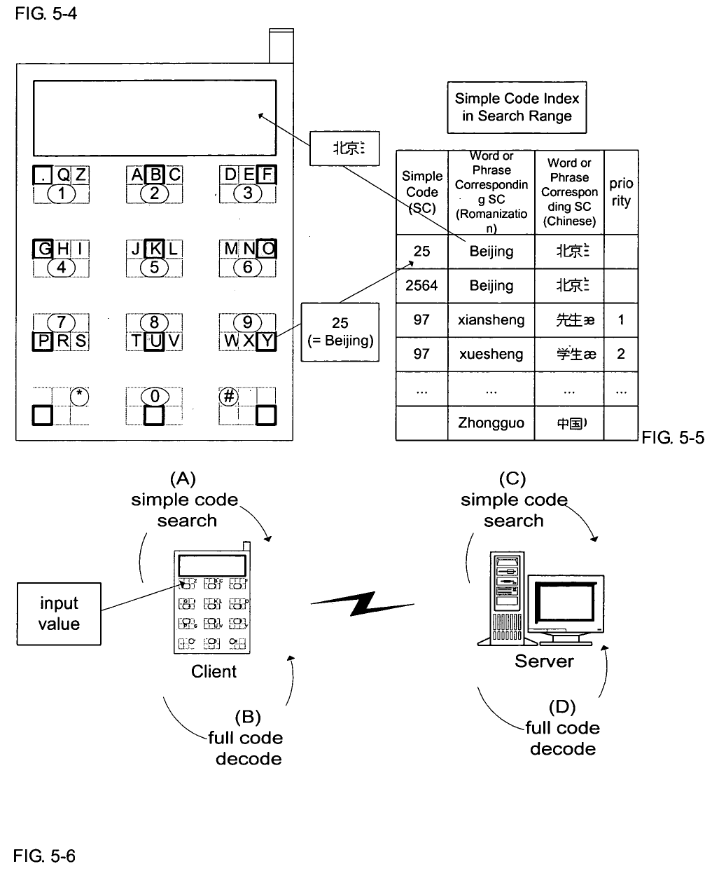

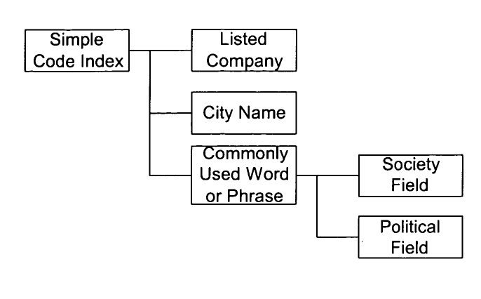

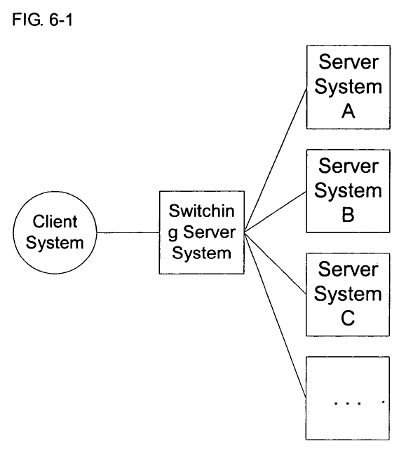

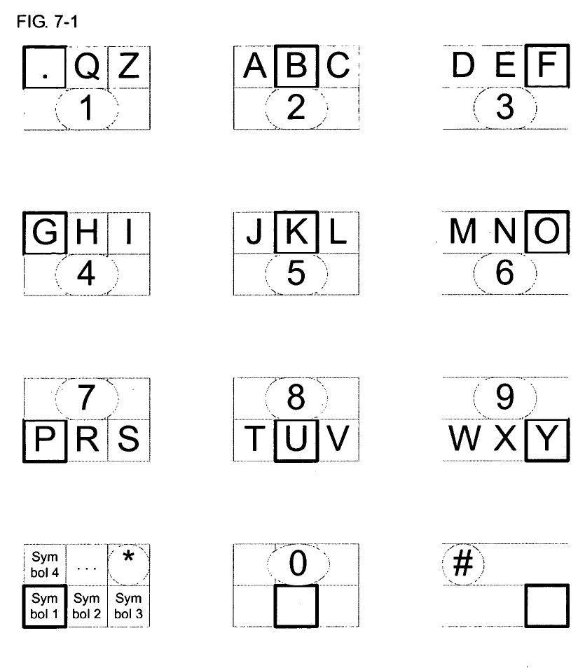

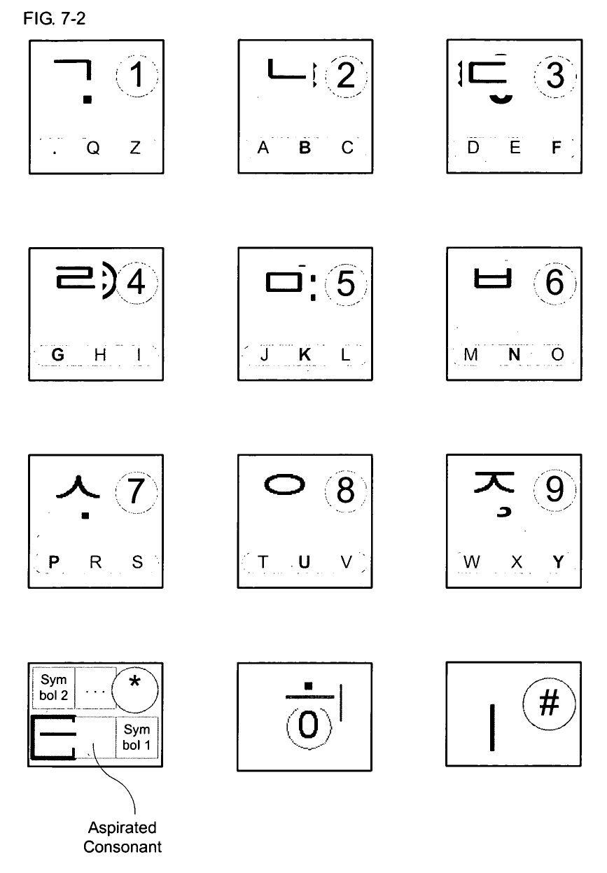

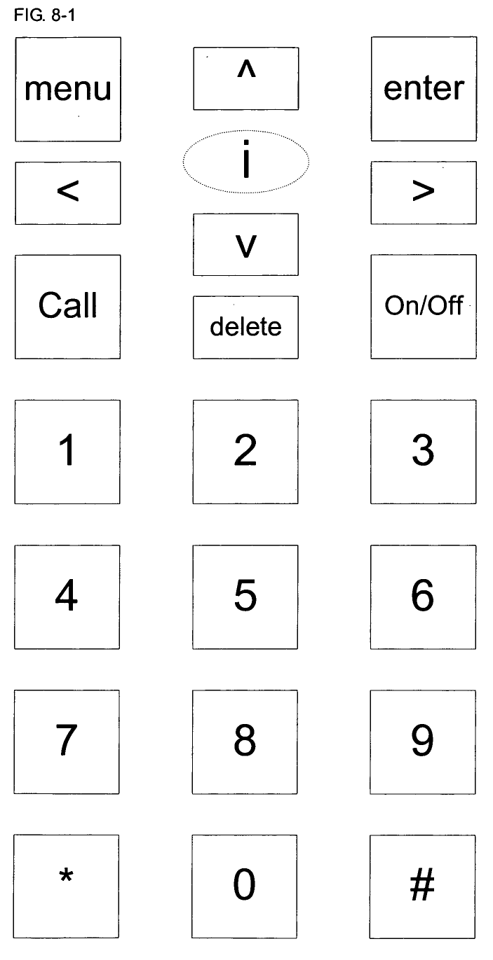

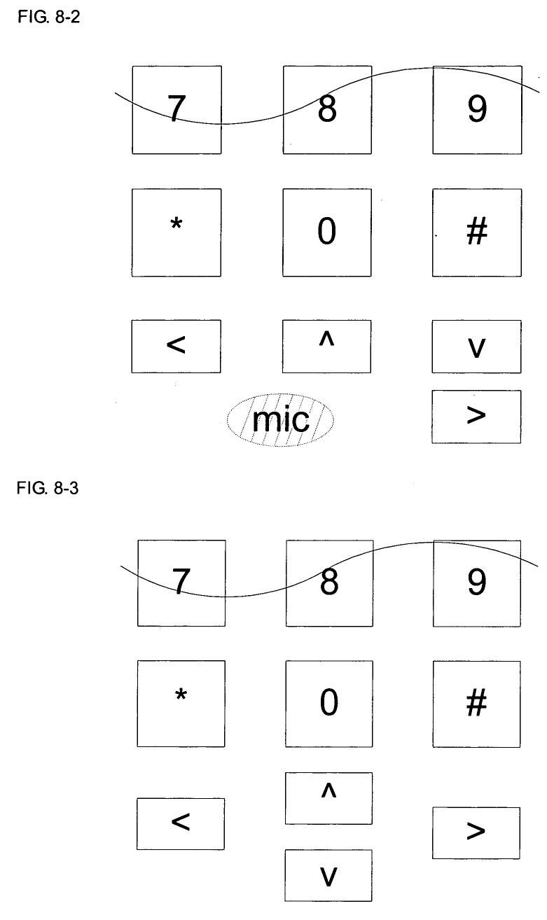

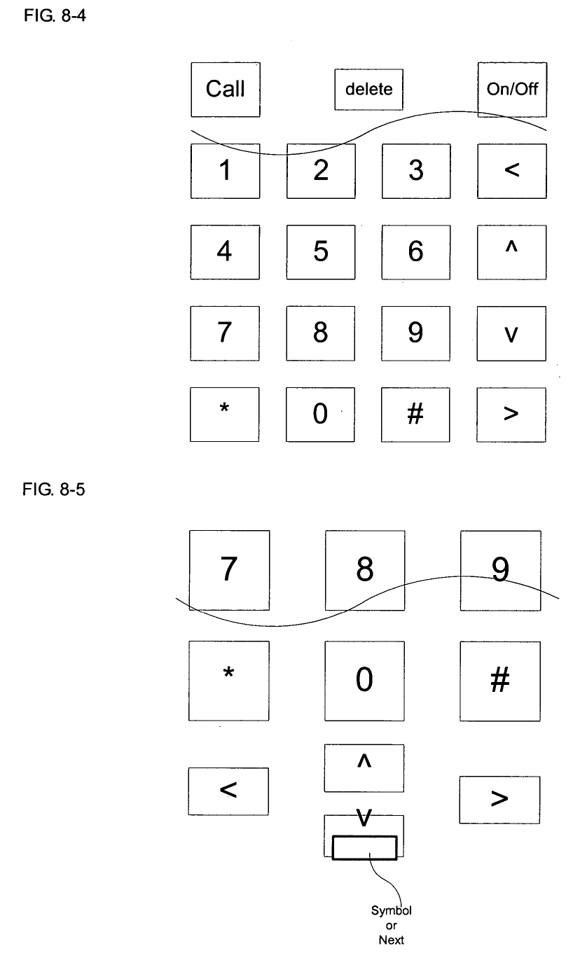

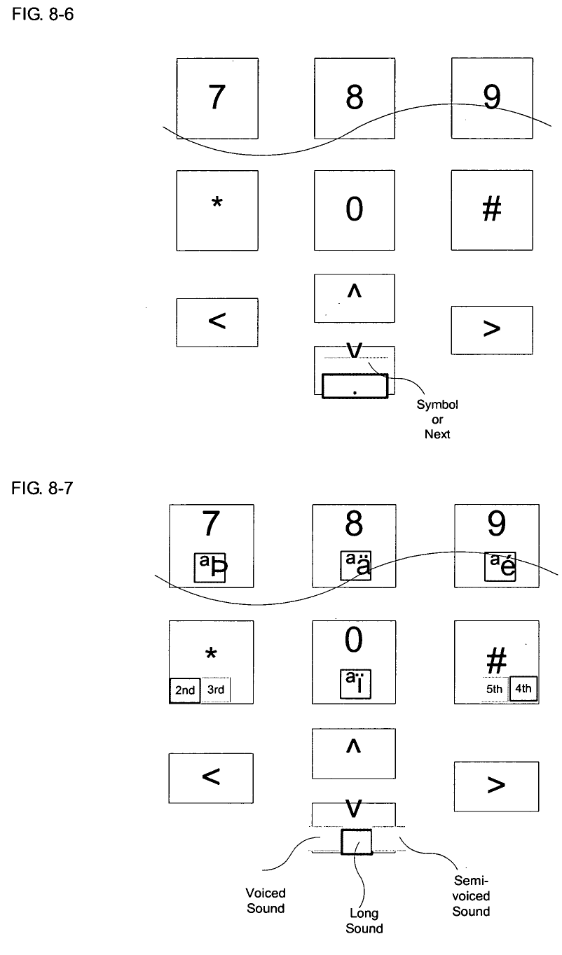

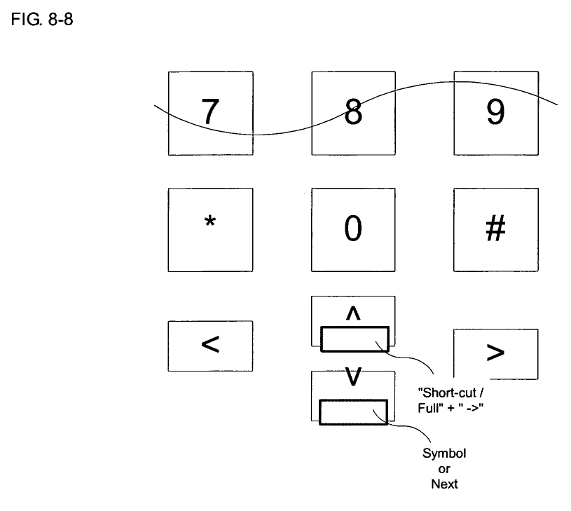

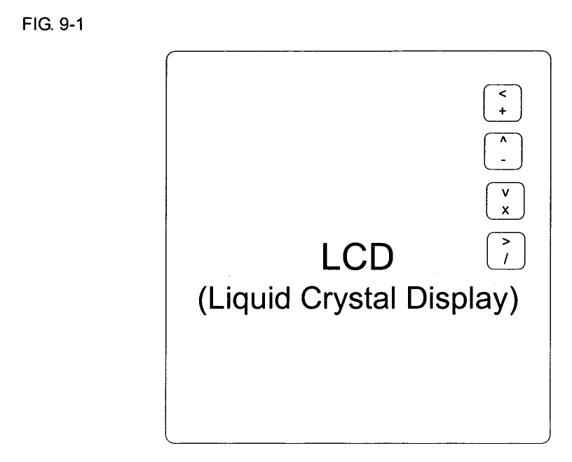

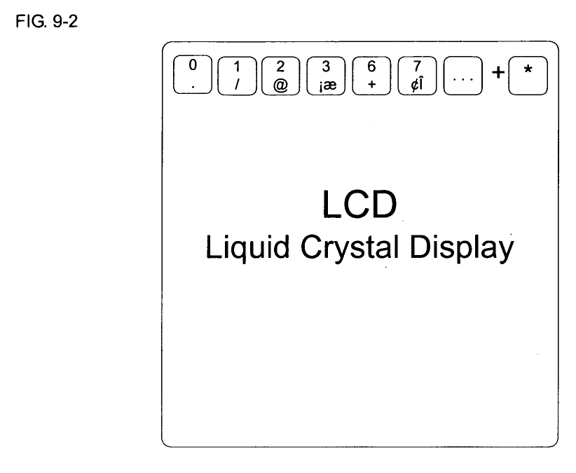

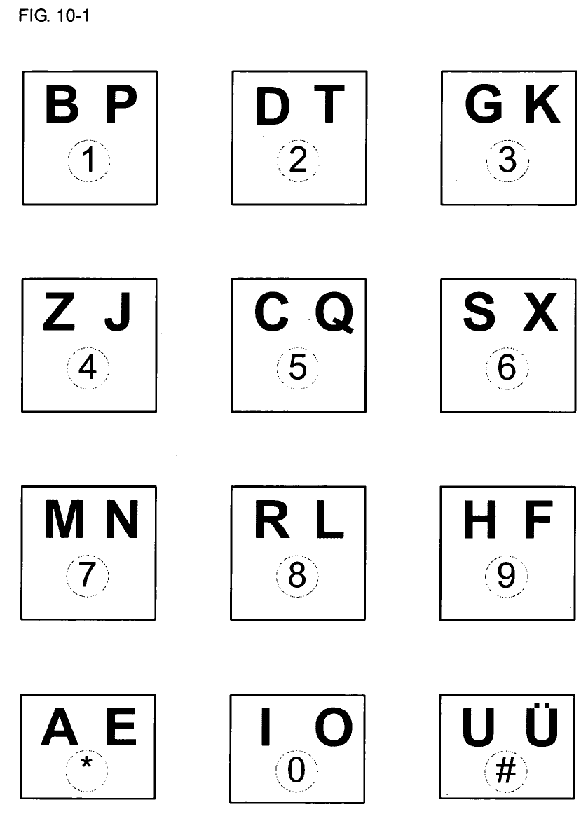

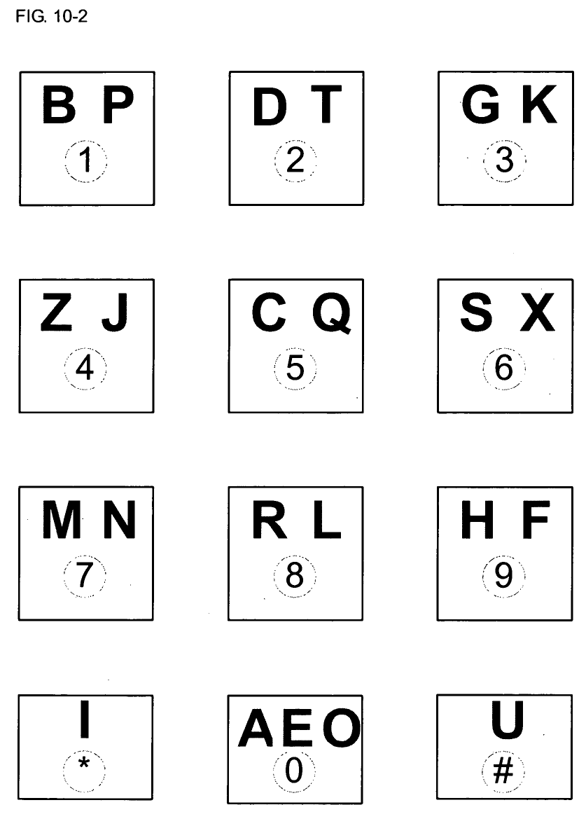

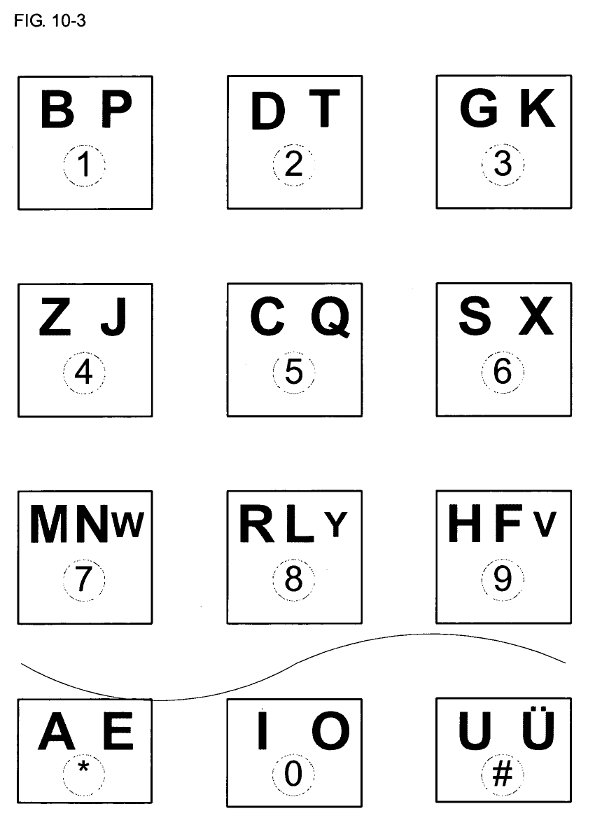

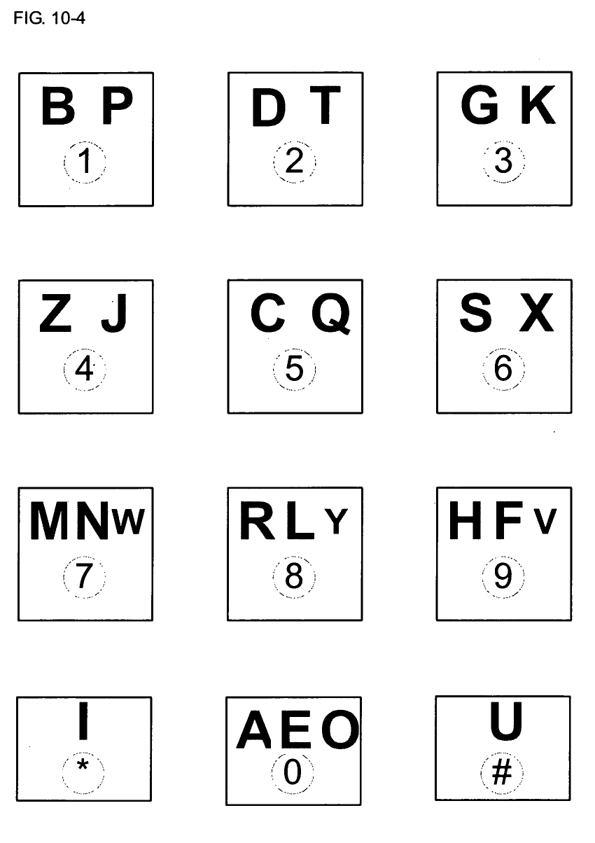

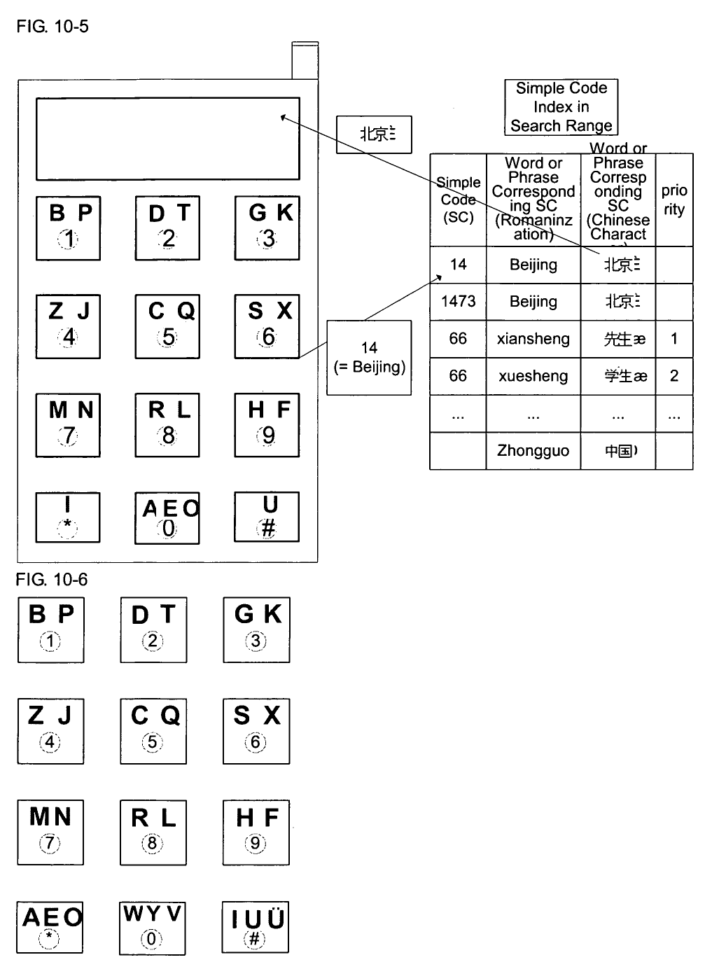

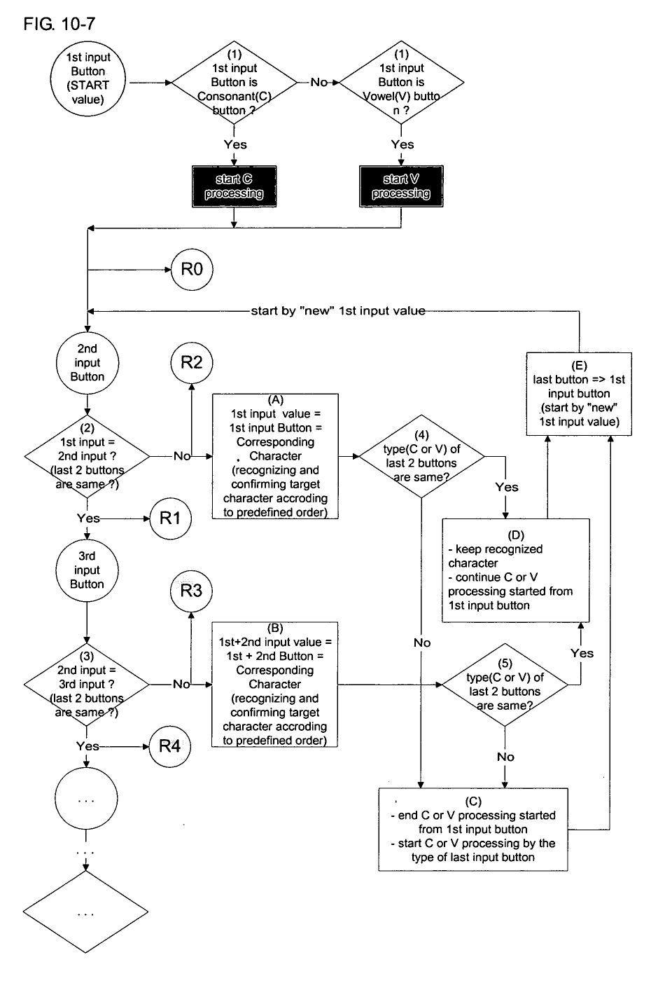

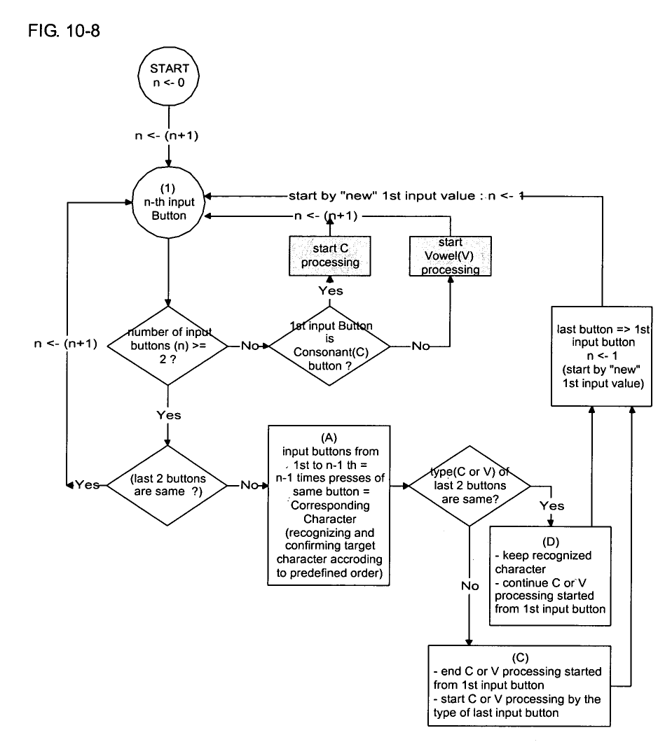

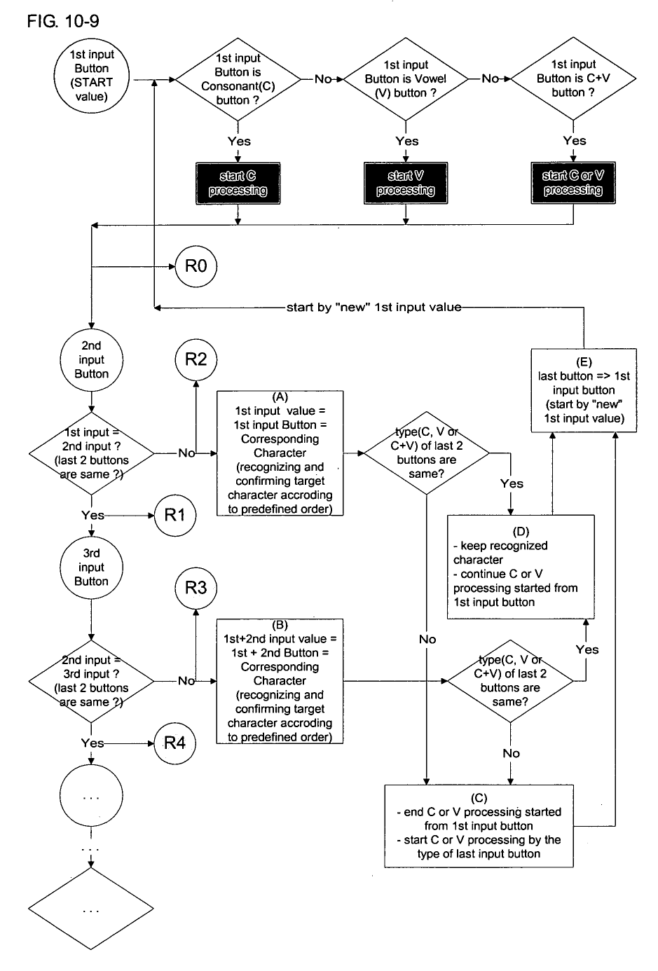

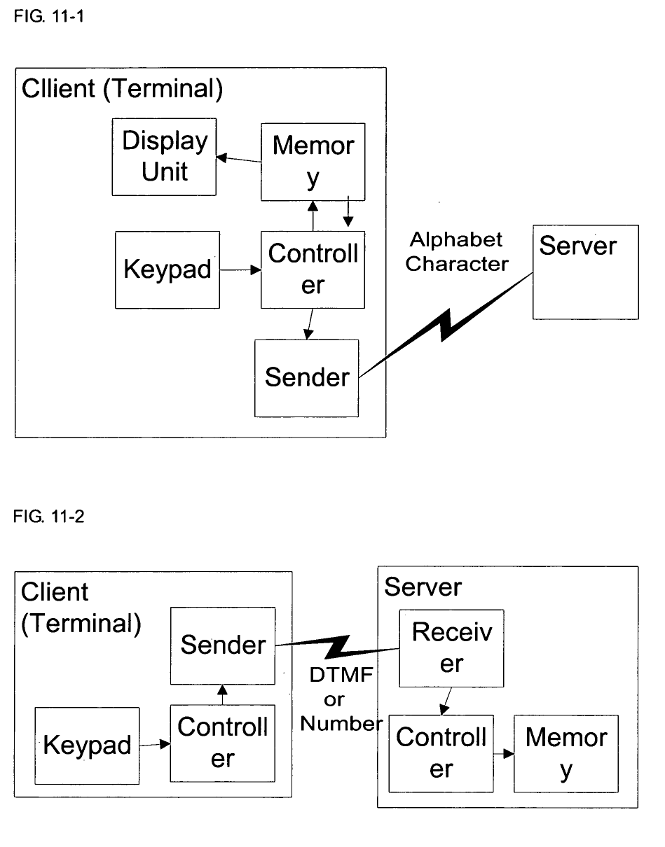

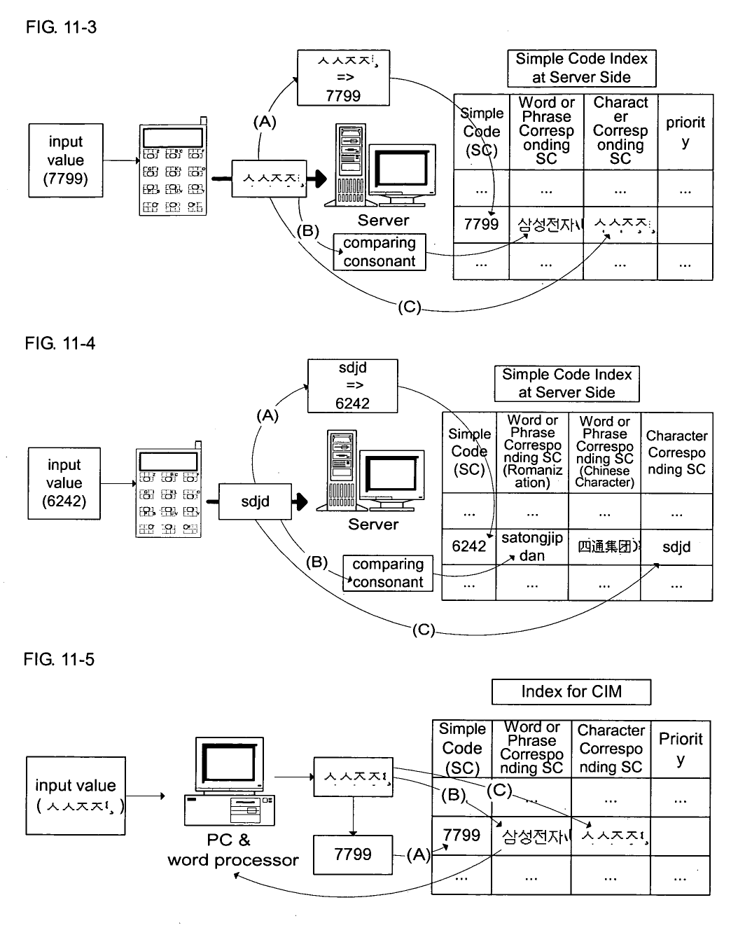

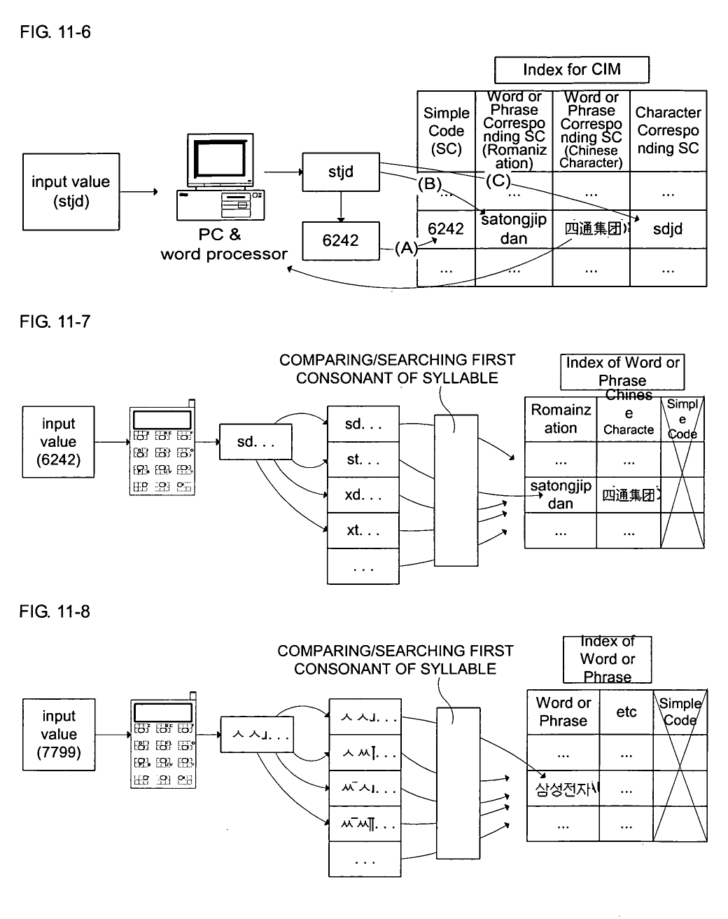

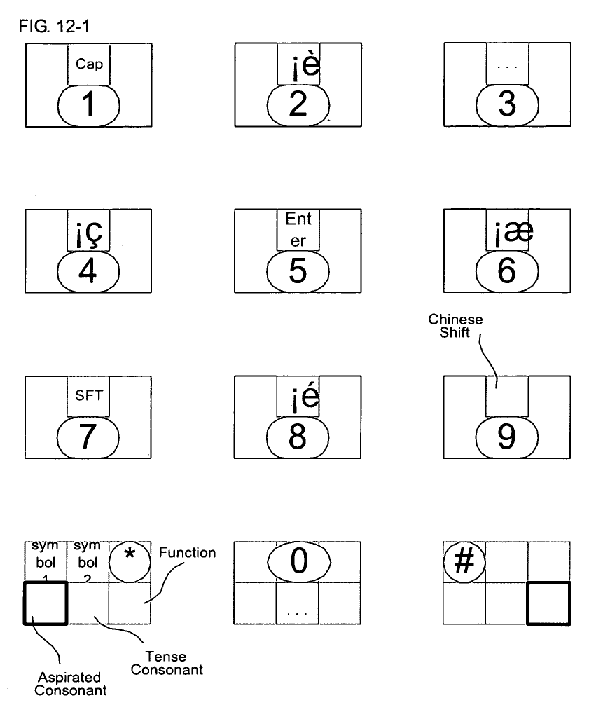

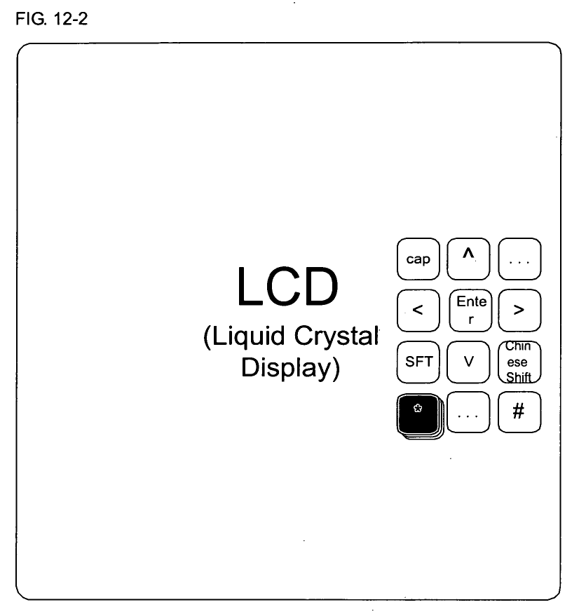

For instance, if the user presses the button [1] twice with a delay time of 0.08 seconds as in FIG. 4-1 or 4-2, the two strokes are first recognized as a vowel, i.e., [symbol] and if with a delay time of 1.1 second, the two strokes are first recognized as two consonants, i.e., [symbol] If the delay time is 0.5 seconds, it is possible to determine whether the user intended to enter one vowel or two consonants, from the structure of the corresponding language showing the way that consonants and vowels appear in the language. Even if the delay time of two storkes is 0.08 or 1.1 seconds, whether to recognize the two strokes as one vowel or two consonants can be determined finally from the structure of the language showing the way that consonants and vowels appear in that language.

Conventionally, the time interval is fixed (for example, as 1 second) so as to recognize successively pressing a button twice within the corresponding time as two successive strokes and successively pressing a button twice at a time longer than the corresponding time as two discrete strokes. There is a difference in the reference time delay value between recognition of two successive strokes (for example, 0.1 second) and recognition of two discrete strokes (for example, 1 second).

Typically, RSM is preferable to PWSM in the prior documents in the aspect of convenience of entry. Therefore, this method having the advantages of RSM (i.e., simplicity of input rules and convenience) uses the structure of a specific language where consonants and vowels appear alternately, to avoid ambiguity and to simplify the implementation of an algorithm in such a manner that SSDT is different from DSDT and the user is allowed to designate SSDT and DSDT.

1.3 Chain-Type Control Processing Method

According to the prior document, ACPM is substantially similar to SCPM and the latter is more general. That is, the prior documents describe, in an example of the Korean alphabet, the relationship among [symbol] as the relationship among a representative character and its affixed characters, i.e., [symbol] +{aspirated consonant} and [symbol] +{tense consonant}. But, the same results are achieved in the present invention by way of the relationship between a representative character and its succession characters as [symbol] (representative character), [symbol] (2nd) and [symbol] (3rd).

For the Japanese language of FIG. 2-1, an example of the entry using SCPM may be described as follows. With the relationship among a representative character and its succession characters such as [symbol] (representative character), [symbol] (2nd), [symbol] (3rd), [symbol] (4th) and [symbol] (5th), [symbol] is selected with one stroke of the button [1] [symbol] and the 2nd to 5th controls are assigned to a control button (for example, [*]) and repeatedly selected according to the number of times of pressing the control button to enter the succession characters by combining the representative character and its succession controls. Expediently, selection of the control is transcribed in braces. When a control is set to be selected after the input of a basic character, entries are given as [symbol] =[1], [symbol] = [symbol] +{2nd}=[1]+[*], [symbol] = [symbol] +{3rd}=[1]+[*]+[*], [symbol] = [symbol] +{4th}=[1]+[*]+[*], and [symbol] = [symbol] +}5th}[1]+[*]+[*]+[*]+[*].

Again, the relationship is established among a representative character and its succession characters such as z,11 (representative character), [symbol] (2nd), [symbol] (3rd), [symbol] (4th) and [symbol] (5th). Instead of assigning the succession control to the control button and applying RSM, the “succession” or “next” control is selected by one stroke of a specific control button (for example, [*]). A second succession character (for example, [symbol] ) is input with a combination of a representative character and “next control”, and a third succession character (for example, [symbol] ) is input with the previous character (the second succession character) as a second representative character and “next control”. That is, [symbol] = [symbol] +{next}=1]+[*]+[*]. Likewise, a fourth succession character [symbol] is input with a combination of the previous character (the third succession character) as a third representative character and “next control”. That is, [symbol] = [symbol] +{next}=[1]+[*]+[*]+[*]. The fifth succession character is also input in the similar way.

This result is the same as that obtained when succession control (2nd, 3rd, 4th, 5th, . . . ) is assigned to the control button as selected by RSM and the entry is given by a combination of a representative character and the succession control. It is seen that entry of the first representative character [symbol] without ambiguity results in successful entry of the second succession character [symbol] without any ambiguity, et cetera. That is, [symbol] = [symbol] +{next}=[1]+[*]+[*], which makes it possible to enter without ambiguity. Thus the subsequence character [symbol] can also be input without ambiguity because [symbol] is combined with the “next control”.

Expediently, such a method is called “Chain-type Succession Control Processing Method (Chain-type SCPM)” in which with the “next” control but the succession controls assigned to the control button, the succession character is entered by a combination of the previous character regarded as a new representative character and the “next” control. The prior documents describe that the user has only to recognize a specific button as a succession control button even if the succession control is not marked on the succession control button. The chain-type SCPM is advantageous in that the representation of “next control” on the control button is simplified. The present invention uses the ”succession control processing method (SCPM)” in combination with the “chain-type SCPM”, because the former has the same result as the latter as described in the prior document.

1.4 Jump Control Processing Method (JCPM)

In ACPM, a affixed character ë comprising “..” and “e” can be entered by a combination of .. and e. Alternatively, e is designated as a basic character and its succession characters related to the basic character in regard to shape and priority are assigned as succession characters, such that the affixed character ë can be entered by a combination of the basic character and the adjunctive priority (for example, e (basic character), é (2nd), ê (3rd), . . . ). Also, an affixed or succession character can be entered without ambiguity by the repeated press of the control button to which controls that become meaning only in combination with an character (i.e., a specific numeral button) are assigned.

For Roman alphabet, use is made of 11 affixed characters in the French language including There are five types of the affix used in the affixed characters, such as /, ˆ, `, ..., and s. If the affix control is selected in the order of /, ˆ, `, ..., and s, the entry has to be given as â=a+[*]+[*]. However, affix “/” cannot be attached to character “a” because there are only two combinations for character “a” with affix “`” or “ˆ” in the French language. Thus affix “/” is skipped (i.e., jumped) and affix “ˆ” can be selected to given an entry as â=a+[*]. Expediently, this system is called “Jump Control Processing Method (JCPM)”. That is, the JCPM designates the adjunctive priority of a succession character as a (basic character), à (2nd) and â (3rd) to enter a succession (or affixed) character in the same manner as control processing method.

Likewise, in Japanese, a long sound exists in the character [symbol] among the characters on the rows of Z,13 and a voiced sound is present in the characters on the rows of [symbol] the semi-voiced sound being present in the characters on the [symbol] row. As a result, the character [symbol] has two affixed characters, i.e., a long sound and a voiced sound, and characters on the row have two affixed characters, i.e., a voiced sound and an semi-voiced sound. Thus only one stroke of an affix control button can be given in entering the affixed characters of the other characters other than the six that have two affixed characters. For example, when the control button is set to [*] and a control is set to be selected after the input of a basic character, entries are given as [symbol] = [symbol] +[*] and [symbol] = [symbol] +[*]. For the six characters each having two affixed characters, the affixed characters are entered with the control selected in the order of use frequency of the affixed characters. For example, when the control button is set to [*] and a control is set to be selected after the input of a basic character, entries are given as [symbol] = [symbol] +[*], [symbol] = [symbol] +[*]+[*]. [symbol] = [symbol] +[*] and [symbol] = [symbol] +[*]+[*]. That is, the control is selected in such a manner that the control incapable of being combined with the basic character has no effect. For instance, [*] in the entry given as [symbol] = [symbol] +[*] is not a long sound control but a voiced sound control, because the basic character [symbol] has no long sound and must be combined with the voiced sound control.

A strict selection of control is advantageous in entering characters not used in practice. It is possible to enter, for example, an imaginary character of the French language comprising b and affix “..”, and one of the Japanese character comprising [symbol] and a voiced sound point.

Even though the control is selected by the repeat selection method (RSM), it is possible to enter the other succession characters without ambiguity only if a representative character marked on a keypad can be input without ambiguity via control processing (for example, when there is only 1 representative character on 1 button, or using a character input method without any ambiguity such as the part-whole selection method (PWSM) even when characters are located on each button). The reason for this lies in that the ambiguity is eliminated via control processing because the control, not alone but in combination with another character, can represent a specific character.

1.5 Input of Numerals and English Alphabet by Control Processing Method

The prior documents describe that mother language, numerals and then English alphabet are arranged “in the order of proximity to a BLE” and selected in the same manner by BRSM. Likewise, numerals and English alphabet (excepting Roman alphabet) as well as mother language can be input by SCPM.

Numerals or English alphabet may be assigned subsequent to the mother language succession characters. Japanese characters, for example, are assigned in the order of [symbol] (representative character), [symbol] (2nd), [symbol] (3rd), [symbol] (4th), [symbol] (5th), 1 (6th), . (7th), q (8th), z(9th), and so forth. If control buttons for numerals or English alphabet are available, a control button for [symbol] (representative character), [symbol] (2nd), [symbol] (3rd), [symbol] (4th) and [symbol] (5th) is assigned to a certain button (for example, [*]) and a control button for numerals or English alphabet is assigned to a second button (for example, [#]), so that numerals and English alphabet are input as [symbol] (representative character), 1 (2nd), . (3rd), q (4th) and z (5th). For example, entries are given as [symbol] 1= [symbol] +[#]=[1]+[#],= [symbol] +[#]+[#]=[1]+[#]+[#] and q= [symbol] +[#]+[#]+[#]=[1]+[#]+* #]+[#]. If available, control buttons for numerals and English alphabet are separately provided.

This may be applicable to the entry of other languages and various symbols that will be described later.

1.6 Pronunciation-Based Grouping of English Alphabet Characters

The prior documents construct a keypad for each language in such a manner that characters are grouped by similar pronunciation and assigned to each numeral button in consideration of using CPM and the use purpose for memorization of codes. As for English, a widely used method groups three or four characters in a dictionary order and assigns the character groups to each numeral button. Likewise, it is also possible to group characters in consideration of the similarity of pronunciation and assign the character groups to each numeral button. For example, the consonants of English alphabet fall into nine groups according to the similarity of pronunciation as follows:

Alternatively, the consonants of English alphabet fall into eight groups as follows:

Besides the above two examples, other variations are possible. Five vowels are properly set in the groups of two consonants. This guarantees convenience in applying Short-cut Input Method (SIM) using simple codes, which will be described later. For non-English languages, the above-constructed character groups can be assigned to each button in consideration of the similarity of pronunciation between the mother language and English. For Korean, for example, a group of G, K and Q is assigned to a button for character [symbol] which is similar in pronunciation to G, K and Q. As for Japanese, a group of G, K and Q is assigned to a button for character [symbol] which is similar in pronunciation to G, K and Q. Therefore, English alphabet can be grouped considering the grouping pattern of every mother language.

2. Language-Based Supplementary Explanation

Hereinafter, a supplementary explanation and improvements will be given as to the content of the prior documents by language as follows. It is apparent that although not specifically described, the content of the prior documents related to a certain language is also applicable to other languages.

2.1 English

As described in the prior documents that succession characters are input on a full keypad using CPM, it is also possible to enter English alphabet, other than representative characters, marked on the keypad. The succession controls, i.e., 2^{nd} and 3^{rd} controls are assigned to the same control button (for example, button [#]) or to different buttons (for example, buttons [*] and [#]). It is assumed that English alphabet, for example, A, B and C are assigned to a common control button. If the representative character is A, the succession characters B and C are independently entered via succession control processing. Otherwise, if the representative character is B, the succession characters A and C are independently entered via SCPM. The representative character and the adjunctive priority of the succession characters are defined in consideration of the use frequency as described in the prior documents.

For example, when A is the representative character in a group of A, B and C, and control after input representative character applies with 2^{nd} and 3^{rd} controls assigned to a button [*], entries are given as B=A+{2^{nd}}=[2]+[*] and C=A+{3^{rd}}=[2]+[*]+[*]. If B is the representative character and control after input representative character applies, with 2nd and 3rd controls assigned to buttons [*] and [#], respectively, entries are given as A=B+{2^{nd}}=[2]+[*] and C=B+{3^{rd}}=[2]+[#]. FIG. 1-2 shows an exemplary arrangement of a keypad designed to easily discriminate the characters, in which the middle character in each group of characters is designated as the representative character and the succession characters are each disposed on the right and left sides of the representative character. For example, D=E+{2^{nd}}=[3]+[*].

Expediently, such a method of entering the representative character with one stroke of the corresponding button and the other characters via control processing is called “Control Processing Method Except Representative Character (CPMERC)”.

In the case where four characters of P, Q, R and S are assigned to a button [7], four characters of W, X, Y and Z being assigned to a button [9], as pointed out in the example of the prior document concerning Korean, PWSM may be adapted in such a manner that one of the four characters can be assigned to a lattice element that forms Vertical Adjacent Combination (VAC). Reference is made to FIG. 1-3.

2.2 Japanese

The prior document described that the Japanese characters are grouped with reference to the Japanese 50-sound table and subjected to the succession control processing using the characters on the [symbol] column, i.e., [symbol] as representative characters and the others as the succession characters. The adjunctive priority of the succession characters is determined with reference to the Japanese 50-sound table presented in the following table in the almost same manner as the approach 3 of the prior document. This makes the user much familiar to the grouping method due to simplicity of the adjunctive priority. [symbol] may be regarded as belonging to a representative character as described in the prior document. Alternatively, characters of the 50-sound table (for example, [symbol] [symbol] or [symbol] ) or [symbol] is regarded as belonging to the blank on the row of [symbol] .

| Method 3 of Prior Document | | | | | Simple Use of 50-Sound Table | | | | |
|---|---|---|---|---|---|---|---|---|---|
| Base Lattice | | | | | Base Lattice | | | | |
| Element | 2nd | 3rd | 4th | 5th | Element | 2nd | 3rd | 4th | 5th |
| 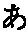 | 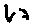 | 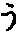 | 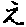 | 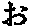 | 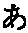 | 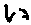 | 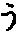 | 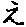 | 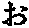 |
| 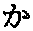 | 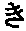 | 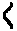 | 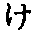 | 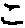 | 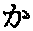 | 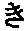 | 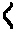 | 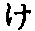 | 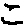 |
| 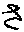 | 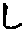 | 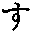 | 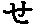 | 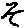 | 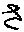 | 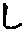 | 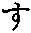 | 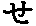 | 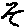 |
| 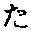 | 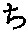 | 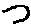 | 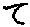 | 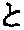 | 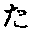 | 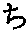 | 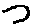 | 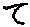 | 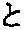 |
| 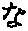 | 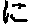 | 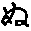 | 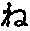 | 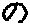 | 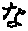 | 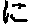 | 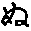 | 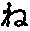 | 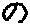 |
| 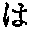 | 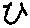 | 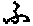 | 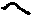 | 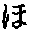 | 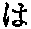 | 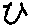 | 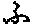 | 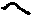 | 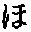 |
| 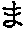 | 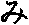 | 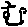 | 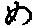 | 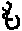 | 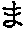 | 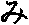 | 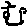 | 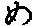 | 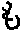 |
| 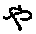 | 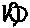 | 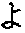 | | | 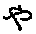 | | 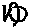 | | 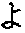 |
| 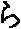 | 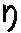 | 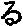 | 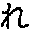 | 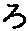 | 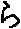 | 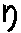 | 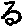 | 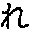 | 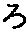 |
| 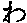 | 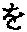 | 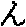 | | | 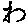 | | | | 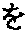 |

Although the prior document describes that characters on the first column are expediently designated as representative characters, the representative characters can be characters on any column or any character belonging to each group. characters on each row may be assigned to each button based on a row of buttons on the keypad (i.e., [1], [2], [3], [4], . . . ) as described in the prior document, or based on the column of buttons (i.e., [3], [6], [9], [2], [5], . . . ). Alternatively, assignment of the characters to each button may be achieved arbitrarily not based neither row nor column.

The prior document describes in the example of Japanese that when [symbol] is arranged at the position of the base lattice element of the button [0], with 2nd and 3rd controls and 4th and 5th controls assigned to the buttons [*] and [#], respectively, [symbol] is assigned to a numeral button but the button [0] in order to use the button [0] as a control button for entering a long/voiced/semi-voiced sound. Instead, [symbol] is arranged at the position of the base lattice element of the button [0], with control buttons for a long/voiced/semi-voiced sound being additionally arranged in the Order of Proximity to a BLE (OPBLE). Then RSM may be adapted to control selection, because there is no case where [symbol] does not consecutively appear in a word. Reference is made to FIG. 2-1. Such a method of selecting an character, not appearing in succession in a word, with one stroke of the corresponding button and other controls with two, three or more strokes of the button may be applicable to all other languages. This feature is also used in the method using the vowel element of Korean that will be described later.

2.3 Arabic

There are 28 consonants in the Arabian language. According to the prior document, the consonants of Arabic representing numerals are grouped and assigned to each button on the keypad, and the character representing the smallest numeral is designated as a representative character and arranged at the position of the base lattice element, the other characters being assigned to the buttons on the keypad in the Order of Proximity to a BLE (OPBLE). The prior document provides a method for entering characters of the Roman, Korean, Hindi and Arabic languages by way of control processing. It also provides a method for entering characters of Arabic in which rarely used vowels are regarded as a affix and subjected to the affix control processing.

Now, a description will be given as to a method for control processing (i.e., succession control processing) the consonants of Arabic. The table below shows an exemplary arrangement of the consonants of Arabic to each button.

| Button | [1] | [2] | [3] | [4] | [5] | [6] | [7] | [8] | [9] | [0] | |
|---|---|---|---|---|---|---|---|---|---|---|---|
| Meaning | 1 | 2 | 3 | 4 | 5 | 6 | 7 | 8 | 9 | 1000 | |
| Base Lattice Element | 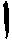 | 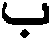 | 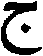 | 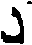 | 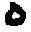 | 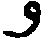 | 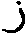 | 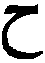 | 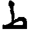 | 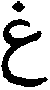 | 1-Unit Character |
| Meaning | 10 | 20 | 30 | 40 | 50 | 60 | 70 | 80 | 90 | | |
| 2^{nd} | 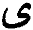 | 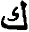 | 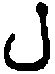 | 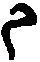 | 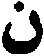 | 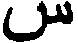 | 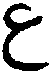 | 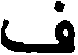 | 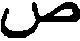 | | 10-Unit Character |
| Meaning | 100 | 200 | 300 | 400 | 500 | 600 | 700 | 800 | 900 | | |
| 3^{rd} | 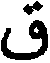 | 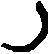 | 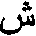 | 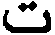 | 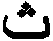 | 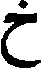 | 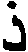 | 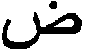 | 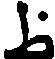 | | 100-Unit Character |
| Meaning | 1000 | | | | | | | | | | |
| 4th | 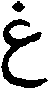 | | | | | | | | | | 1000-Unit Character |
| | Group 1 | Group 2 | Group 3 | Group 4 | Group 5 | Group 6 | Group 7 | Group 8 | Group 9 | Group 10 | |
| | character | character | character | character | character | character | character | character | character | character | |

Among the characters representing 1, 10 and 100 assigned to the button [1], the character representing 1 is designated as the representative character and the others representing 10 or 100 are subjected to the succession control processing. Any button may be designated as a control button, as described in the prior document. If the succession control button is assigned to the button [*], with 2^{nd} and 3^{rd} controls arranged, consonants are entered with two strokes on the average. It is unnecessary to select characters marked on the button by PWSM, because only one character is assigned to each button. The arrangement of characters is notional and hence characters may not be allocated to the keypad as described later.

According to the prior document, succession control may be separated as another button as in the case of Japanese. For example, when the 3^{rd} control is assigned to the button [#], the average number of input strokes is about 1.7 (=(1+2+2)/3) and 28 consonants can be entered without ambiguity as described in the prior document.

The present invention designates an character representing the smallest numeral as a representative character of each group and selects an character representing the smaller numeral among the succession characters of the other units, irrelevant to the use frequency. A control can be selected after of before the input of a representative character.

If succession controls are all assigned to the button [*], with the 1-unit character designated as a representative character, and the control is selected before the entry of the representative character, entries of the 10-unit characters are given as [symbol] =[*]+ [symbol] and [symbol] =[*]+[*]+ [symbol] . The same procedures are performed for the other characters. In this case, the button [#] may be used for the vowel control processing.

If control before input representative character applies with only one character representing 1000 being assigned to the button [0], the entry of [symbol] is given as [symbol] =[0]. The character representing 1000 may be processed as those belonging to the first group, in which case the entry is given as [symbol] =[*]+[*]+[*]+ [symbol] .

Alternatively, since the character representing 100 has such a form in which an upper point is added to the character representing 70, i.e., [symbol] the upper point control can be selected prior to various vowel controls in the control processing. That is, if control before input character is applied to the upper point control, the entry is given as [symbol] ={upper point control}+ [symbol] . Another character comprising an upper point can also be entered using the ACPM and another input method simultaneously. In this case, it becomes easy to use the button [0] as a control button for another use purpose (for example, vowel control button).

If the 3^{rd} control (i.e., 100-unit control) is separately assigned to the button [#], the entry of the character representing 200 is given as [symbol] =[#]+ [symbol] . Alternatively, the entry of [symbol] is given as [symbol] =[*]+[*]+ [symbol] as in the case of Japanese according to the prior document. If the character representing 1000 belongs to the first group of characters and control before input character applies, the entry is given as [symbol] =[*]+[*]+[*]+ [symbol] or [symbol] =[#]+[#]+ [symbol] . That is, the 2^{nd}, 3^{rd} and 4^{th} controls are assigned to the button [*], the 3^{rd} and 4^{th} controls being assigned to the button [#]. Considering that the Arabians writes from left to right, it is also possible to assign the 2^{nd}, 3^{rd} and 4^{th} controls to the button [#] and the 3^{rd} and 4^{th} controls to the button [*].

This means that the frequently used characters, i.e., consonants of Arabic can be entered with about 1.7 strokes on the average without ambiguity. Advantageously, characters (for example, 1-unit characters, i.e., representative characters) not marked on the keypad can be readily selected, because the Arabians know the numerical meanings of their mother language. That is, the present invention is applicable to a keypad marking only numerals in entering almost characters (consonants of Arabic) necessary in the daily life, only if the user has the knowledge of the regulations concerning the unit character designated as a given representative character or assigned to a given control button, the sequent order of the succession controls, if assigned to a single control button, or whether the control is set to be selected before representative characters.

It is possible to perform a control processing of vowels, as described in the prior document. When using both the button [#] and the button [*] for consonant control processing, the character representing 1000 is not assigned to the button [0] but the button [1] to designate the button [0] as a vowel control button and input vowels as affix (i.e., vowel control or affix control) by way of RSM, as described in the case of Japanese according to the prior document. This method selects the vowel control (vowel as affix) based on the number of times of pressing the button in the order of use frequency. If using only one button [*] as a succession control button for consonants, the control button for vowels may be the button [#], or both the button [#] and the button [0].

Although the characters representing 1 to 9 (1-unit characters) are designated as the representative characters of each group in the examples of FIGS. 3-1 and 3-2, characters having the highest use frequency in each group may be the representative characters. To avoid confusion, the representative characters can be any unit characters among 1-unit characters (characters representing 1 to 9), 10-unit characters (characters representing 10 to 90), and 100-unit characters (characters representing 100 to 900). In the example of FIG. 3-3, each 10-unit character designated as a representative character is positioned in the center of each group, and the other characters (100-unit character and 1-unit character) assigned on the left and right sides to the 10-unit character are entered by control processing using the control buttons arranged on the left and right sides.

Likewise, the characters selected by the succession control may be each unit character based on the use frequency. For example, if 100-unit characters having the highest use frequency are designated as the representative characters and 1-unit characters is second to the 100-unit characters in the use frequency, it is possible to enter the 100-unit characters with a combination of the 2^{nd} control (i.e., 1-unit control) and the representative characters, and the 10-unit characters with a combination of the 3^{rd} control (i.e., 10-unit control) and the representative characters.

As the prior document describes that the succession characters can be entered by CPM, it is possible to enter consonants by SCPM and vowels by ACPM on the keypad of the prior document. If the button [0] is designated as the affix control button for vowels in the 3*4 keypad, the control buttons for entry of consonants may be both the button [*] and the button [#].

2.4 Korean

2.4.1 Use of Different Controls

FIGS. 4-1, 4-2 and 4-3 show an entry method in which pairs of a basic consonant and a basic vowel in Korean are assigned to the individual buttons and in which each basic consonant and basic vowel marked on the keypad is entered by repeat selection processing. In FIG. 4-1, aspirated consonants, tense consonants, and extended vowels are entered via control processing. In FIG. 4-2, aspirated consonants and tense consonants are entered via control processing. In FIG. 4-3, aspirated consonants, tense consonants, basic vowels, and extended vowels are entered via control processing.

2.4.2 Programming

FIG. 4-4 is no more than a flow chart for realization of the invention, and more efficient programming is possible. For example, in the case of considering final consonant in FIG. 4-4, more efficient programming is possible by checking whether the consonants can form double final consonants.

The example of Korean suggested in the prior art may be applicable to other languages having a similar feature (i.e., a structure having consonants and vowels appearing alternately). For other languages, the feature of consonant and vowel appearance of the corresponding languages may be taken into consideration.

For example, a Hindi entry system using basic consonants and basic vowels can be realized in the same manner as Korean, in consideration of the features of Hindi. The establishment of the Hindi entry system is simpler than that of the Korean entry system because the rules of consonant and vowel appearance in Hindi are simpler than that in Korean.

2.5 Hindi

According to the prior document of the applicant, the consonants of Hindi are divided into 9 groups, which are assigned to buttons [1] to [9], and the vowels assigned to the button [0] are selected with one stroke of the button [0]. For consistency, in the present invention, consonants are divided into 10 groups so as to select the representative consonants with one stroke of the corresponding button and 10 vowels as two strokes of the button. A vowel _(ri) not allocated to the keypad and rarely used can be processed by CPM. Grouping of the consonants into 10 groups is achieved in consideration of the similarity of pronunciation as described in the prior document. An example of 10 groups of consonants is given as follows.

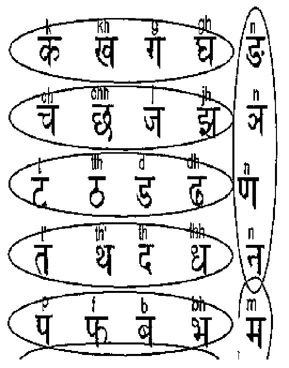

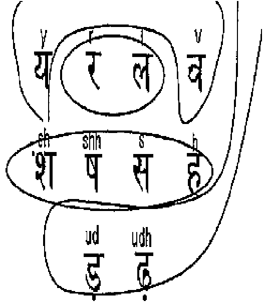

When the first vowel of Hindi, [symbol] is located between two consonants, it is omitted. That is, consonants appear in succession. It is very easy in this case to display “consonant+consonant” when “consonant+_(a)+consonant” is input. Of course, the entry may also be given as “consonant+consonant”, in which case the same representative consonant is input consecutively and the two consonants are erroneously recognized as one vowel. Both (automatic omission of the vowel _(a) or omission by the user) can be allowed.

2.6 Myanmar Language

There are 33 consonants in the Myanmar language. An example of 9 groups of the consonants is given as follows. Alternatively, the consonants may be divided into 10 groups in the similar manner.

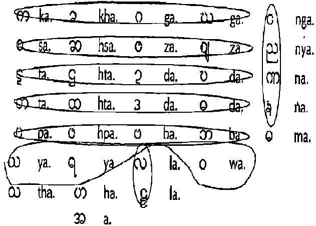

3. Multi-Dimensional Cross Control Processing Method

FIG. 2-2 shows an example in which the characters in the [symbol] column are designated as representative characters and are assigned to the individual buttons in the dictionary order according to the above table. While fourth and fifth controls can be additionally assigned to the control buttons for second and third controls in the prior document of the applicant, only the second and third controls are assigned to the control buttons in order to minimize the number of strokes and to make the best use of the control buttons in this example.

The method for entering succession characters in FIG. 2-2 is the same as described in the prior document of the applicant. For example, when a control is set to be selected after the input of a basic character, the entry is given as [symbol] Next, a method for entering affixed characters (in other words, transformational characters) of each character, i.e., long sound, voiced sound and semi-voiced sound, is presented. In FIG. 2-2, buttons available as control buttons (buttons [*] and [#]) are each used as a succession control button. So there is no control button for affixed characters. But in the case where the basic character of a target character is a succession character, the succession control button not used as a succession control button after the input of the succession character can be used as an affixed character control button (expediently, called “opposite control button”).

For example, entries are given as [symbol] = [symbol] +“opposite control button”= [symbol] +[*]+[#] and [symbol] = [symbol] +“opposite control button”= [symbol] +[#]+[#]+[*]. It can be understood that the opposite control button not used as a succession control button for entering 21 [symbol] is used as control button for an affixed character in the control processing method, considering [symbol] to be the affixed character of a basic character [symbol] The Jump Control Processing Method(JCPM) as suggested in the prior document of the applicant can also be applied to this case. From a standpoint of the chain-type control processing method, one stroke of the opposite control button selects “next control” for entry of the affixed character [symbol] of a previously input character

[symbol]

As there are two affixed characters of a character on the row of [symbol] i.e., voiced sound and semi-voiced sound, one stroke of the opposite control button is set for the long sound and two strokes of the opposite control button for the semi-voiced sound. Namely, entries are given as [symbol] = [symbol] +“opposite control button”= [symbol] +[*]+[*]+[#], [symbol] “two strokes of opposite control button”= [symbol] +[*]+[*]+[#]+[#].

The same method is inapplicable to the case where the basic character of a target character is a representative character. In this case, the affixed character of the representative character is additionally assigned to one of the succession control buttons to enter the target character.

For example, button [*] is used to enter the affixed character (long sound, voiced sound or semi-voiced sound) of a representative character, the entry is given as [symbol] = [symbol] +[*]+[*]+[*]. Namely, the affixed character (long sound, voiced sound or semi-voiced sound) of a representative character is considered as the fourth succession character that can be entered using button [*]. This can be summarized as follows.

| | Using | | Using | | | | | | | | | |
|---|---|---|---|---|---|---|---|---|---|---|---|---|
| Representative | Button [*] | | Button [#] | | Using Either of Button [*] or [#] (e.g., Button [*]) | | | | | | | |
| Character | 2^{nd} | 3^{rd} | 4^{th} | 5^{th} | 4^{th} | 5^{th} | 6^{th} | 7^{th} | | . . . | . . . | |
| 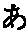 | 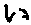 | 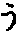 | 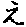 | 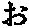 | 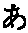 | 1 | English 1 . | English 2 Q | English 3 Z | Symbol 1 | . . . | |
| | 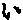 | 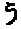 | 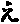 | 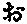 | | | | | | | | Using Opposite Control Button |
| 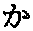 | 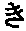 | 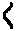 | 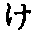 | 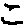 | 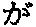 | 2 | English 1 A | English 2 B | English 3 C | Symbol 1 | . . . | |
| | 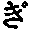 | 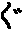 | 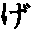 | 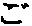 | | | | | | | | Using Opposite Control Button |
| . . . | | | | | | | | | | | | |
| 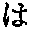 | 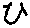 | 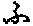 | 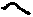 | 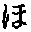 | 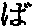 | 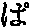 | 6 | English 1 M | English 2 N | English 3 O | . . . | |
| | 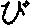 | 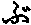 | 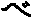 | 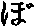 | | | | | | | | Using Opposite Control Button |
| | 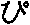 | 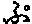 | 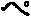 | 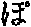 | | | | | | | | Using Opposite Control Button |
| . . . | | | | | | | | | | | | |
| 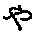 | 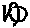 | | 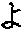 | | 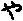 | | | | | | | |
| | 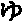 | | 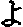 | | | | | | | | | Using Opposite Control Button |
| . . . | | | | | | | | | | | | |

Such a method of using the opposite control button to extend the use of the control button for entry of more characters or the like is called “Cross Control Processing Method (CCPM)”, “Zigzag Control Processing Method (ZCCP)” or “Multi-dimensional Cross Control Processing (MCCP)”. MCCP is applicable for the case that there are three control buttons or more than three control buttons.

It is apparent that the blanks other than those of the first column in the above table can also be used to enter other characters or various symbols. In the above example, only one opposite control button was used. Namely, as the entry of [symbol] given as [symbol] “two strokes of opposite control button”= [symbol] +[*]+[*]+[#]+[#], one opposite control button (button [#]) is applied for button [*] used as the succession control button by repeatedly selecting the opposite control button. Expediently, this method is called “Two-dimensional Cross Control Processing Method (2CCPM)” or “Two-staged Cross Control Processing”.

That is, the case of using one control button for entry of one character is called “One-dimensional Cross Control Processing (1CCP)”. This means that the control button is used in the “one-dimensional” manner. Contrarily, two different control buttons are used for entry of one character in the Two-dimensional (Cross) Control Processing Method. For example, considering [symbol] as the affixed character of [symbol] the entry is given as [symbol] = [symbol] +“opposite control button”=

[symbol]

Though the opposite control button is defined as a control button for entry of the first and second succession characters of the representative character, i.e., [symbol] the opposite control button (button [*]) in this case is used as an affixed character control button for entry of [symbol] that is the affixed character of [symbol] . It can be understood that two control buttons are used in the “two-dimensional” manner for entry of one character in comparison to using one control button in the one-dimensional manner.

The entry may also be given as [symbol] one stroke of opposite control button”+“one stroke of opposite control button for previous control button”= [symbol] If it is impossible to enter an affixed character by repeatedly using a control button (e.g., button [#]) used last for entry of [symbol] the opposite control button for the previous opposite control button can be used again to enter another affixed character or succession character. Expediently, this method is called “Three-dimensional Cross Control Processing (3CCP)” or “Three-staged Cross Control Processing”. This means that the number of entries available related to the characters on the keypad or other characters is infinitely expandable using the Multi-dimensional Cross Control Processing Method. Moreover, the succession or affixed character related to the previously input character can be simply entered via control processing method.

The above-description is illustrated in the form of graph in FIG. 2-3 that exemplifies the row of [symbol] having two affixed characters (voiced sound and semi-voiced sound). In FIG. 2-3, the light-colored symbol “...” marked in a circle means that an additional character or symbol, if necessary, can be entered by the Multi-dimensional Control Processing Method in a like manner to entering another character or symbol in the blank of the above table. In FIG. 2-3, buttons [*] and [#] are each used in the orthogonal direction.

In the prior document of the applicant, the second to fifth controls that are not the representative characters among the characters in the 50-character table are assigned to the button [*] and the button [*] is used as a control button for entry of affixed characters such as long sound, voiced sound and semi-voiced sound. This means that the two-dimensional control processing was also applied in the prior document of the applicant. Namely, two control buttons are used for the entry given as [symbol] = [symbol] +{affix}= [symbol] +[*]+[#]. In the prior document of the applicant, the control button is used only as a succession control (2^{nd}, 3^{rd}, 4^{th} or 5^{th}) button or an affixed character (long sound, voiced sound or semi-voiced sound) control button. Contrarily, in the two-dimensional control processing of the present invention, a succession control button is also used as an affixed character control button after the entry of a succession character. The reuse of a major control button (succession control button in the above example) as an affixed character control button is called “Two-dimensional Reuse Control Processing (2RCP)” or “Two-dimensional Multi-use Control Processing (2MCP)” in contrast to the Two-dimensional Control Processing of the prior document.

The method of the prior document is simple and consistent but needs a relatively larger number of strokes. To understand the difference between the prior document and the present invention, the use of a control button only as a succession control (2^{nd}, 3^{rd}, 4^{th} or 5^{th}) button or an affixed character (long sound, voiced sound or semi-voiced sound) control button in the prior document is illustrated in the graph of FIG. 2-4. In FIGS. 2-3 and 2-4, the marked portion in light color can be extendedly applied.

In the above example, a control is set to be selected after the input of a basic character in the Cross Control Processing Method. But a control can also be set to be selected before the input of a basic character in the cross control processing in a like manner to setting the control selected after or before basic character is applicable in the control processing method of the prior document. For example, the entry is given as [symbol] =“opposite control button”+ [symbol] =[#]+[*]+ [symbol] . But it is more convenient to set the control selected after basic character in the Cross Control Processing.

The same is applied to any other language including Japanese. For example, when using buttons [*] and [#] for entry of a succession character in Arabic by CPMERC, the multi-dimensional cross control processing is applied to enter affix type vowels. For Thai, the multi-dimensional cross processing is applied to enter tone symbols in the case of using buttons [*] and [#] for entries of succession consonants and succession vowels.

4. Method for Using Vowel Elements in Korean

4.1 Applying CPM for Aspirated Consonant and Tense Consonant

Use can be made of the vowel elements (e.g., [symbol] , [symbol] and .) of Korean. Reference will be given to FIG. 4-5. The present invention assigns 9 out of 10 basic consonants to each of numeral buttons [1] to [9], the vowel elements of Korean such as [symbol] to the buttons [*] and [#] at the bottom of the keypad, and the vowel element “.” to the button [0]. Although various assignment methods are possible, expediently, the present invention exemplifies the assignment and arrangement method shown in FIG. 4-5. Of course, the basic consonant and the vowel elements are arranged at the position of the base lattice element, and there is no need of using PWSM in selecting the arranged basic consonants and vowel elements.

In applying CPM for aspirated consonant and tense consonant, “aspirated consonant control” and “tense consonant control” are each assigned to a button designated for [symbol] and arranged to one of the other lattice element closest to the base lattice element. That is, the aspirated consonant control and the tense consonant control are selected with two strokes of the control button. Alternatively, aspirated consonant (or tense consonant) control may be additionally arranged to the tense consonant (or aspirated consonant) control button and selected with three strokes of the control button. As described in the prior document, [symbol] has no aspirated consonant so that [symbol] is regarded as aspirated consonant and tense consonant. There is no need of marking the aspirated consonant or tense consonant control on the buttons and the user has only to memorize the entry rules for aspirated consonant or tense consonant control.

If the selection state of aspirated consonant control is represented by “{aspirated consonant}” and control before input character is applied to the example of FIG. 4-5, the entry is given as [symbol] =[*]+[*]+[1]. Likewise, [symbol] =[#]+[#]+[1]. If the tense consonant control is selected with three strokes of the aspirated consonant control button, the entry is given as [symbol] =[*]+[*]+[*]+[1+].

There is no ambiguity in the present invention which the aspirated consonant and tense consonant controls share the same button with vowel elements of [symbol] and [symbol] and RSM is applied. The reason for this lies in that the vowel [symbol] rarely appears twice in succession in a word as is the marked characteristic of Korean so that two strokes of the button [*] for selection of the aspirated consonant control is not recognized as selection of two vowels [symbol] and [symbol] in succession. The same applies to the case of the vowel [symbol] In a word [symbol] (in the example, [8]+[0]+[0]+[#]+[#]+[0]+[*]+[#]), the vowel “┐” appears twice subsequent to the vowel element “.”, and thus “[#]+[#]” is not recognized as selection of the tense consonant control but a vowel. Because the vowel element “.” cannot terminate the word of this example, the selection of [#] subsequent to the vowel element “.” is recognized as a vowel. There is no ambiguity even if the aspirated consonant and tense consonant controls are assigned to a button designated for [symbol] since the vowel [symbol] rarely appears in succession.

Nine of ten basic consonants are assigned to nine buttons [1] to [9]. The other one is not assigned to the button and expediently called “the consonant out of 9 buttons (COO9)”. The consonant out of 9 buttons can be regarded as the affixed or succession character of one of the ten basic consonants in consideration of similarity in pronunciation or shape, and control processed. For example, if control before input character applies while [symbol] is not allocated to the button but regarded as the affixed character (aspirated consonant or tense consonant) of [symbol] the entry is given as [symbol] =[*]+[*]+ [symbol] or [symbol] =[*]+[*]+[*]+ [symbol] or [symbol] =[#]+[#]+ [symbol] . Regarding [symbol] as the affixed character (aspirated consonant or tense consonant) of [symbol] in consideration of pronunciation and shape in FIG. 4-5, the entry is given as [symbol] =[*]+[*]+ [symbol] or [symbol] =[*]+[*]+[*]+ [symbol] or [symbol] =[#]+[#]+ [symbol] .

In this case, the character control processed (i.e., [symbol] in FIG. 4-5) is preferably one of the characters destitute of aspirated consonant or tense consonant (e.g., [symbol] for more convenience in inputting characters. Of course, the basic character control processed [symbol] is preferably one of the characters destitute of aspirated consonant nor tense consonant to make the entry of character more convenient. Here, [symbol] is given as an example of control processing because it is an character of the lowest use frequency among those destitute of aspirated consonant nor tense consonant. Another reason for the selection of [symbol] as an example of control processing is similarity of pronunciation and shape as the relation between another normal sound and aspirated consonant.

Here, 10 basic consonants (normal sounds) are preferably allocated to 10 numeral buttons in order to use Korean for memorization of telephone numbers and various codes. For this purpose, [symbol] is additionally assigned to a button designated for “.” (i.e., button [0] in FIG. 4-5) and arranged to the lattice for selecting [symbol] with three strokes of the corresponding button. It is necessary to select [symbol] with three strokes of the corresponding button in order to eliminate ambiguity in RSM, because “.” appears twice in succession very frequently. In this case, although [symbol] is not arranged at the third lattice physically close to the base lattice, the user has only to know that [symbol] can be selected with three strokes of the corresponding button. This means that three strokes of button [0] selects [symbol] and that all basic consonants can be arranged to the respective numeral buttons for use purpose in memorization.

To make characters more distinguishable in FIG. 4-5, consonants are marked in blue, vowels or vowel elements in red, and numerals in black. [symbol] marked in blue on the button [0] indicates that [symbol] is assigned to the button [0] because [symbol] is largely shaped like

[symbol]

That is, the consonant out of 9 buttons is regarded as the affixed character of a specific basic consonant and input by CPM, or entered with three strokes of a button designated for “.”.

4.2 Basic Consonant Combination Processing of Tense Consonant, and Hiding/Non-Hiding Repeat Selection Processing of Tense Consonant and Aspirated Consonant

It is possible to process a tense consonant by way of a combination of basic consonants in a method using the vowel elements of Korean. Because one basic consonant is assigned to each numeral button in the method using vowel elements, ambiguity may occur (first ambiguity, the ambiguity between full codes) such as

[symbol]

Such ambiguity can be avoided with an “index” as described in the following embodiment. If entering an aspirated consonant by way of a combination of basic consonants, CPM is used only for entry of the aspirated consonant to simplify the rules of entry. The aspirated consonant control can be assigned to a proper lattice element as described in the prior document. For example, the aspirated consonant control is removed in FIG. 4-1 or 4-2.

It is described above that basic consonant, aspirated consonant and tense consonant can be entered in sequence [symbol] according to the number of times of pressing the corresponding button (for example, [symbol] =[1], [symbol] =[1]+[1], and [symbol] =[1]+[1]+1]). This case may also have a first ambiguity as described in the prior document. Specific examples of the case that causes ambiguity will not be described here. It may be possible to mark basic consonants alone, or all of basic consonants, aspirated consonants and tense consonants on the buttons. This allows the succession characters (for example, [symbol] and [symbol] to be selected by RSM.

Expediently, a method for marking only the representative character and selecting its succession characters by RSM is referred to as “Hiding Repeat Selection Processing Method (HRSPM)”. The adjunctive priority of aspirated consonant and tense consonant can be given in the order of basic consonant, tense consonant and aspirated consonant. For example, assignment to the lattice elements is defined as [symbol] (1st: position of the base lattice element). [symbol] (2nd), and [symbol] (3rd). That is, [symbol] =[1], [symbol] =[1 ]+[1], and [symbol] =[1]+[1]+[1]. This is processing (or hiding repeat selection processing) tense consonants by the combination of basic consonants and selecting aspirated consonants by the hiding repeating selection processing.

Although this method of the present invention differs in the adjunctive priority of the succession characters from the hiding repeat selection method described in the prior document, it makes it possible to enter a tense consonant with two strokes of a corresponding numeral button (combination of basic consonants), thereby making the entry more natural from a viewpoint of the user.

In this case, [symbol] is entered with three strokes of the button [0], which entirely enhances consistency in the method employed because the relation between [symbol] is similar to that between normal sound (basic consonant) and aspirated consonant in shape and pronunciation and an aspirated consonant can also be entered with three strokes of a corresponding numeral button.

It is of course possible to enter an aspirated consonant with three (or two) strokes of a button designate for the basic consonant, or by CPM, likewise as [symbol] is entered with three strokes of the button [0], or by CPM in which [symbol] is regarded as the affixed character of [symbol] When the user enters an aspirated consonant by CPM, the system discriminates the aspirated consonant without ambiguity (ambiguity between full codes, i.e., first ambiguity). But, ambiguity may occur while entering an aspirated consonant with three strokes of the button arranged for the corresponding basic consonant. The same applies to the case of a tense consonant.

That is, the user may enter an aspirated consonant by CPM or the hiding repeat selection method on the same keypad. The same applies to the case of a tense consonant. For example, if the aspirated consonant control is selected with two strokes of the button [*] and aspirated consonant and tense consonant are selected with two and three strokes of a button for corresponding basic consonants, respectively, the entry of [symbol] is given as [symbol] =[1]+[*]+[*]+[#]+[0]+[1]+[1]+[1]+[#]”. That is, the first [symbol] is entered by CPM and the second [symbol] is by RSM. Likewise, the entry of [symbol] is given as [symbol] =[1]+[#]+[#]+[#]+[0]+[1]+[1]+[#]”.

The sequent order of selecting aspirated consonants and tense consonants may be defined as is convenient for the user in entering aspirated consonants and tense consonants by the non-hiding repeat selection method or the hiding repeat selection method.

4.3 Using Four Vowel Elements in Korean

Expediently, the case of FIG. 4-5 is called “10-consonant 3-vowel method” or simply “3-vowel method”. This can also be expressed as FIG. 4-6. The same entry method as in FIG. 4-5 is used in FIG. 4-6. In FIG. 4-6, a vowel element “: (if necessary, used as a horizontal or vertical stroke but expediently marked as a horizontal stroke “:” in this case)” used to enter a Korean vowel [symbol] and a vowel element “.” are grouped in the same group and are assigned to the same button. The vowel elements “.” and “:” are selected with one stroke and two strokes of the button, respectively, using the Repeat Selection Method, and the vowel element “:” is not specified on the button. Namely, the case of FIG. 4-5 also uses four vowel elements [symbol] as in FIG. 4-6. Expediently, this method is called “Dot-like Vowel Element Repeat Selection 4-vowel Method (DVERS4M)”.

In FIG. 4-7, the vowel elements “:” and “.” are grouped in different groups. The four vowel elements [symbol] are each assigned to a different button. This method is expediently called “10-consonant 4-vowel method” or “4-vowel method”. The 4-vowel method is very similar to the 3-vowel method and will be described in a simple way. It is apparent that some features of the 3-vowel method are applied to the 4-vowel method. The terms can also be used in the same manner as in the 3-vowel method.

In the 4-vowel method, the consonants other than two basic consonants destitute of an aspirated or tense sound among 10 basic consonants are assigned to eight buttons. The four vowel elements, the aspirated consonant control, the tense consonant control and the two consonants not assigned to the eight buttons (expediently, referred to as “8-button excluded consonants” or “the consonants out of 8 button” or “10-8 consonants” or simply “-8 consonants”) are grouped in groups of two. The vowel elements are entered with one stroke of the corresponding button, and the control or excluded consonants assigned together are entered with two strokes of the corresponding button (that is, by the Repeat Selection Method).

The vowel element “.” is assigned to the button [0], which is similar in shape to the vowel element “.”, and a mark is given in the numeral “0” for simple arrangement on the button (otherwise, no mark is given in the numeral because the user can readily recognize it). The vowel element “:” is assigned to the button [8], which is similar in shape to the vowel element “:”, and a mark is given in the numeral “8” (otherwise, no mark is given in the numeral because the user can readily recognize it) to explicitly assign only one character to one button. In FIG. 4-5, the vowel element “.” is marked in the numeral “0” of button [0] so as to express [symbol] explicitly. If the vowels [symbol] are assigned to buttons [*] and [#], respectively, as shown in FIG. 4-7, the neighboring buttons are selected in entering various vowels in Korean to shorten the moving distance of finger.

In the 4-vowel method, the Repeat Selection Method can be used to enter aspirated consonants or tense consonants as in the 3-vowel method. This is called “aspirated/tense consonant repeat selection 4-vowel method”. As in the case of the 3-vowel method, the Repeat Selection Method can be also used with Control Processing Method. This is expediently called “Aspirated/tense Consonant Control Processing & Repeat Selection 4-vowel Method”.

In the standpoint of the repeat selection method, the keypad of FIG. 4-7 can be expressed as FIG. 4-8. The difference between FIGS. 4-5 and 4-7 is apparent when compared with FIGS. 4-6 and 4-8. The vowel element “:” is selected with one stroke of button [8] in FIG. 4-8, while it is selected with two strokes of button “0” in FIG. 4-6.

Vowel elements “.” and “:” can be assigned to the buttons [*] and [#], respectively, but it is impossible to assign only one character on each button explicitly as shown in FIG. 4-7.

Referring to FIG. 4-7, entries are given as [symbol] =:+ [symbol] =[8]+[#], [symbol] = [symbol] +:=[#]+[8], and [symbol] = [symbol] +:=[*]+[8]. To enter a 8-button excluded consonant by the repeat selection method, entries are given as [symbol] =[8]+[8], and [symbol] =[8]+[8]. If the vowel element “:” can selected with two strokes of the button for the vowel element “.”, [symbol] is entered with three strokes of the button for “.” as in the case of the 3-vowel method.

For example, the dot-like vowel element “..” between vowels [symbol] in [symbol] or [symbol] is entered with the vowel element “:”. Though the system may temporarily recognize it as the entry of [symbol] it can recognize it as [symbol] Correctly because the vowel [symbol] cannot appear after [symbol] In the “10-consonant Dot-like Vowel Element Repeat Selection 3-vowel Method”, two inputs of vowel element “.” or one input of vowel element “:” are available in entering the dot-like vowel element “..” between vowels [symbol] in

[symbol]

The 3-vowel method and the 4-vowel method are considered as a Korean entry method optimized to “Korean Restricted Repeat Selection Method (KRRSM)” among “Language Restricted Repeat Selection Methods (LRRSM)” using the rules of Korean consonant and vowel appearance (i.e., word production rule and character association rule).

4.4 Complete Control Processing

In FIG. 4-5, ambiguity may occur between [symbol] or among [symbol] [symbol] and [symbol] (because the full code values are the same), even though aspirated consonants and tense consonants are entered using control processing. Such ambiguity also appears between [symbol] in FIG. 4-7.

The two 8-button excluded consonants can be entered by control processing in like manner that [symbol] is considered as the affixed character of [symbol] and entered by control processing (e.g., [symbol] = [symbol] +{aspirated consonant}= [symbol] +[*]+[*]) in the 3-vowel method. Expediently, this is called “complete control processing”. Furthermore, the excluded consonant can be entered by the combination of a button for the excluded consonant (e.g., [symbol] and a control assigned for [symbol] For example, the entry is given as [symbol] =.+{aspirated consonant}=[0]+[*]+[*]”. The 8-button excluded consonants in the 4-vowel method are also entered in the same manner. Expediently, this is called “Complete Control Processing Using Excluded Consonant Button”.

5. Method for Overcoming Ambiguity Through Index

In RSM, several words are represented by same code to cause ambiguity. As previously described in the prior document, such ambiguity occurs between [symbol] in the example of FIG. 4-1. Generally, entry is done word by word. For example, the word [symbol] exists but the word [symbol] doesn't. Both the words have the same code in FIG. 4-1. In connection to this, a client terminal or a server prepares an index for those words that may cause ambiguity in relation to a specific keypad and a specific character input method. If the user enters [symbol] which is not distinguishable from the other even in the presence of a time delay, the system may recognize [symbol] as a desired word (hereinafter, referred to as “target word”) because [symbol] is registered as a correct word in the index. This applies only to the case where ambiguity occurs between the words not distinguishable by the system. If possible, the system (on the side of the client or server) distinguishes the words by the help of a time delay value, which is previously set by the system or the user. That is, when the user enters [symbol] with pauses (by means of time delay, space, or selection of the left move button or another special button) intentionally, the system outputs [symbol] as the target word even though the output word is a grammatically incorrect word.

To prepare the index, the system may register only correct words (e.g., [symbol] or incorrect words (e.g., [symbol] ) as ambiguous words. Alternatively, the system may register both correct words and incorrect words, provided that it has information for deciding whether a certain word in the index is correct or incorrect.

This applies to all cases using RSM on the keypad. For example, the same applies to the case where ambiguity occurs between [symbol] in the input method by the Samsung Electronic Co., Ltd. in Korea. It also applied to the case where pairs of consonant and vowel are arranged to each button as shown in FIG. 4-1 to select a consonant with one stroke of the corresponding button, an aspirated consonant with two strokes, a tense consonant with three strokes and a vowel with one stroke, and a syllable confirm button is selected syllable (letter) by syllable (letter). Even when the system outputs [symbol] temporarily in response to the entry of [symbol] by the user, it may correct the misspelled word as [symbol] with reference to the index just as the moment the word is ended (for example, by entry of space).

When the index for a word exists in both the client terminal and the server, the system first looks up a correct word in the index of the client terminal and, if failed, finally in the index of the server.

As well understood, it is reasonable that the system can distinguish a word from another one by the help of a word-discriminating factor, which is given, for example, between spaces, the head of a word and a space, a space and the tail of a word, and a space and a mode transition. Decision on a correct word with reference to the index is achieved word by word. So, the system refers to the index to decide a correct word the moment the user enters a word-discriminating factor.

This applies to all cases where ambiguity occurs in RSM. Ambiguity may occur, for example, between [symbol] where the final and initial consonants of a word belong to the same button in the input method by Samsung Electronics. Co., Ltd. in Korea. Here, the system does not recognize syllable (letter) by syllable (letter) in entering characters with codes assigned by characters, so that it naturally outputs [symbol] in response to the entry of [symbol] from the keypad. If it is possible in this case to determine which one of the two words should be the target word even in the presence of a time delay, the system (terminal or server) determines the target word with reference to the index. Discrimination of the target word with reference to the index irrespective of the time delay may be more efficient in this case, because the system will decide the target word as [symbol] in all cases even though the initial consonant [symbol] is selected subsequent to the final consonant

[symbol]

It is apparent that this is not limited to Korean and may be applied to all languages using RSM. For example, when the user enters [2]-[2]-[2] in entering characters of English or other languages in the English mode to cause ambiguity between “AB” and “BA”, the system may recognize “AB”, which is registered in the index as a correct word, and provide it as the target word. If ambiguous words entered are all registered as correct words in the index, the system first provides the word of the highest use frequency to the user and enables the user to finally determine the target word.

If the system recognizes all words corresponding to an ambiguous input word as correct with reference to the index, it allows the user to select the target word by the help of a proper (visual or auditory) method.

In order to allow the user to determine the target word, the system lists the plural words recognized as correct in the order of use frequency (or priority) on a display window and urges the user to select the target word by up-and-down scroll or numeral buttons corresponding to the displayed order of the words. Alternatively, the system displays only one word of the highest use frequency on the display window and, if the word is not the target word, causes the user to select a control (expediently, referred to as “next word control”) for displaying the next word of the secondly highest use frequency. If the next word is also not the target word, the system enables the user to continue searching for the target word in the same way. After searching the target word, the user is allowed to decide the target word by selecting another button (i.e., any button not designated for selection of the next word control, such as selection of another characters, space, or mode transition).

Here, both the PWSM and the RSM (base/simple) are applicable to selection of the next word control. If the next word control is arranged at the position of the base lattice element of a specific button, it can be selected with one stroke of that specific button.

6. Simple Code Application Method and SIM/CIM

6.1 Production of Character-Associated Simple Code

Entry of characters is indispensable in access to the information system with a data communication terminal. There are some cases where such characters are coded into numerals. A miniaturized data communication terminal usually has an interface in the form of a normal keypad. Here, the term “code” as used herein refers to any types of code, the examples of which are numerous including telephone number, stock index (listed company) code, city code, quarter code, subway station code, bank code, etc. Coding of various names has an advantage in the sense of simplification of entry.

The data communication terminal as used herein includes any type of data communication terminals such as PC, mobile communication equipment, smart phone, PDA, bi-directional text transceiver, ATM (Automated Teller Machine), or the like, as well as non-communication terminals such as electronic diary. The information system as used herein includes any type of systems accessible visually via GUI or only aurally accessible, such as ARS. The system also includes a server system, and in a broad sense, a client software of the terminal in communication with the server system.

Alphabet allocated to the keypad may be used for memorization of various codes. There are many approaches for this purpose, including simple naming, initial naming or full naming. Now, a description will be given as follows.

Simple naming is to designate a numeral associated with a given word or phrase as a code. For example, a Korean company name, [symbol] has a simple code “1799” associated with [symbol] as shown in FIG. 4-2. In this case, characters [symbol] associated with the simple code “1799” are marked in bold, so that the user can notice the simple code of a specific word with ease. Furthermore, the simple code can be extracted from a word or phrase. The simple code of [symbol] for example, is specifically not limited to “1799”, because the code consists of numerals associated with any character belonging to a given word in the simple naming. For example, as the simple code of [symbol] is set as a value associated with [symbol] that of [symbol] may become “1729” associated with [symbol] or “1949” associated with [symbol] or “13294293” associated with all characters constituting [symbol] Expediently, designation of a code associated with all characters forming a given word or phrase is referred to as “Fully Associated Simple Naming (FASN)”, and designation of a code associated with part of characters forming a given word or phrase is referred to as “Partially Associated Simple Naming (PASN)”. In either case, simple naming (i.e., simple code) is associated with characters constituting a given word or phrase. The same applies to other languages as well as Korean. For example, “captain” may have a simple code of “2786” associated with consonants “CPTN” as a partially associated simple code, which is expediently referred to as “Consonant-Associated Simple Code”.

The consonant-associated simple code of a word “escape” that starts with a vowel is “727” corresponding to “SCP”, which is the same as the consonant-associated simple code of “scape”. Thus a simple code associating the first vowel with consonants can be considered in order to minimize overlapping of the defined simple code and the corresponding word and or phrase and to improve convenience in use while using the shortened simple code. Expediently, this is referred to as “First Vowel+Consonant-based Simple Code (1VCSC)”. Like the other simple codes, the first vowel+consonant-based simple code is advantageous in that the simple code can be mechanically generated for a specific word.

A phrase as well as a word can be coded by simple naming. From a phrase [symbol] in the example of the prior document, letters (syllables) full of meaning are used to extract a simple code “8314” mapped to [symbol] For English, “data tonight” in the example of the prior document may have a simple code “3886” associated with characters having a phonetic value, such as d, t, t and n.

Initial naming is a special case of the partially associated simple naming. For Korean, initial naming designates a numeral mapped to the initial consonant of a syllable (letter) as a code. Expediently, this method is referred to as “Syllable-Based Initial Naming (SBIN)”. For example, the syllable-based initial code of [symbol] extracted by the syllable-based initial naming is “1799” associated with the initial consonant of each syllable (letter). The syllable-based initial naming also applies to other languages as well as Korean. For example, an English word “entertainment” has an syllable-based initial code “3886” associated with e, t, t and m according to the syllable-based initial naming. The syllable-based initial naming is more useful for Korean in which one syllable constitutes one letter. It is also applicable to other languages such as Chinese and Japanese in which one syllable is formed by one character, as well as Korean. For Chinese, the syllable-based initial code of [symbol] (Beijing: the fourth tone symbol is attatched to the first “e” and the second tone symbol is to the last “i”) is “25” associated with b and j with reference to FIG. 1-1, or “14” with reference to FIGS. 10-1 to 10-4.

Likewise, the initial naming is also applicable to a phrase. For example, a phrase [symbol] in the example of the prior document may have an initial code “81” associated with the initial characters of each word, [symbol] An English phrase “dance with the wolf” has an word-based initial code “3979” associated with d, w, t and w according to the word-based initial naming. The word-based initial naming is more useful for every language when the code is assigned to the entire phrase.

Expediently, both a simple code (i.e., fully associated simple code and partially associated simple code) and an initial code (i.e., syllable-based initial code and word-based initial code) are called “simple code (in a broad sense)” or “short-cut code”. Especially, each of fully associated simple code, consonant-associated simple code, syllable-based initial code and word-based initial code follow regulations in their production and thus are generally used in practice. In addition, simple codes generated by others according to the regulations may also be readily used.

Full naming is an input value of a given word or phrase to be coded according to a specific character input method and thus variable depending on the used character input method. A numeral value corresponding to a given word or phrase is coded character by character. For example, [symbol] in the prior document has a full code “7745888944” according to PWSM (disclosed in the prior document) as illustrated in FIG. 4-2. The full code of [symbol] according to BRSM (disclosed in the prior document) becomes “7448884”. If using another keypad different from that of FIG. 4-2 or another character input method, a specific full code value may be given according to the keypad or the character input method.

6.2 Conventional Chinese Character Entry Method

A general entry method for Chinese characters involves entering English characters corresponding to the pronunciation of the Chinese, using an “English-to-Chinese transition key” to display convertible Chinese characters and selecting the corresponding Chinese characters, as in the case of entering Chinese characters in the Korean mode. Namely, when the user enters Chinese sounds compatible with Roman characters, the system searches the corresponding Chinese character and provides it for the user. Refer to FIG. 5-1. The full codes in Chinese can be defined on the basis of English pronunciation of the Chinese character.

6.3 Unique Simple Code

If the client terminal is in charge of decoding the simple code (i.e., when the client terminal has a specific word or phrase and its simple code value), the word or phrase corresponding to the input simple code is transferred to the server. In the case where the server requests the simple code according to the feature of the application while the client terminal is enable to decode the simple code, the client terminal sends the simple code itself (i.e, displays the numeral) to the server, which then decodes the simple code. Thus the simple code is decoded in either the client terminal or the server.

With a simple code for multiple words or phrases, there can be many words or phrases corresponding to the same simple code. Such ambiguity between the simple codes in CIM is expediently called “second ambiguity”. Although the system may add a serial number to the simple code to store a unique code value in this case, the second ambiguity occurs because the user normally uses the simple code associated with a specific word or phrase. Of course, the system has to recommend such words or phrases based on the priority for use to the user. With the same simple code for different words or phrases, the system adds a serial number to the simple code according to the priority based on the use frequency of the words or phrases and utilizes the serial number as priority in recommendation of words or phrases to the user. Here, the system does not necessarily add a serial number to the simple code and may have separate information about the priority.

For example, when the simple codes of [symbol] and [symbol] are both “9196” as a syllable-based initial code, the system adds a serial number to the simple code according to the use frequency of each word and uses the serial number as priority for recommendation of words to the user. If [symbol] has the higher use frequency, the system gives the priority to that word and defines a new simple code “91961” for [symbol] and “91962” for [symbol] Likewise, if [symbol] (xiansheng: vowel “a” is the first tone) and [symbol] (xuesheng: the first “e” is the second tone) have the same syllable-based initial code of “97”, a serial number can be attached to each word according to the use frequency of the word to be used for prioritizing the word. For example, when [symbol] (xiansheng) is used more frequently than [symbol] the syllable-based initial codes are “971” for [symbol] and “972” for [symbol] Such a simple code with a serial number is expediently called “unique simple code” and a overlapped simple code having no serial number is called “simple code”, both of which are just referred to as “simple code”.

In the example of [symbol] when the user enters “97” alone, the system offers [symbol] to the user for selection. Upon the user entering “971”, the system recognizes “971” as

[symbol]

Highlighting “x” and “s” used as the basis of the syllable-based initial code may have a better visual effect on the user. One of the highlighting methods is capitalizing as [symbol] The system may extract the simple code “97” from the partially capitalized word.

6.4. Use of Simple Code

The following is the example of simple codes (for example, syllable-based initial codes) assigned to various city names, which are useful in the railway information system, or the like:

[symbol]

Because [symbol] have the same syllable-based initial code, the system adds a serial number to the simple code as [symbol] =782”. If the user sends only “78” to the system, then the system properly performs feedback (e.g., provides a list of [symbol] or informs of the list in a voice) so that the user can select either [symbol] Upon the user entering “781” initially, the system recognizes the simple code as

[symbol]

If the server requests the word [symbol] instead of the simple code “78”, the client terminal interprets the simple code “78” as [symbol] and sends it to the server. In the case where the server requests the simple code according to the feature of the application while the client terminal is enable to decode the simple code, the client terminal has only to send the simple code itself to the server.

In another example for assigning simple codes (fully associated simple code, syllable-based initial code, consonant-associated simple code, and first vowel+consonant-associated simple code) for a city name, [symbol] has a syllable-based simple code of “25” associated with “b” and “j”, a fully associated simple code of “2345464”, and a consonant-associated simple code of “2564” associated with “b”, “j”, “n” and “g” with reference to FIG. 1-1.

The simple codes of stock index (listed company) codes are given as follows, which are useful in various stock information system, or the like:

[symbol]

=3098, [symbol] =39397, [symbol] =83643, . . .

For example, [symbol] used as a base for the syllable-based initial code of [symbol] are marked in bold to provide a more powerful visual effect to the user.

The simple codes of bank codes are given as follows, which are useful in the ATM and various financial information systems:

[symbol]

(bank)=14, [symbol] (bank)=82, . . .

It is apparent that a predefined simple code can be used for entry of a word or phrase in such a manner that the user enters the predefined simple code and then the client (terminal) provides the user with the decoded simple code. Such a method is called “Short-cut Input Method (SIM)”, which will be described later together with “Concurrent Input Method (CIM)”.

6.5. Automatic Alteration of Priority Based on Selection Frequency

Initially, [symbol] takes first priority over [symbol] If a specific user tends to choose [symbol] very frequently, it is possible to give priority to [symbol] Over [symbol] . For this purpose, use can be made of, if not specifically limited to, a method that involves exchanging serial numbers to alter the priority. Alternatively, the system may change separate information about the priority.

The system or the user may (re)designate criteria used in deciding whether the use frequency of [symbol] s remarkably high. For example, when the user chooses [symbol] in at least eight cases out of ten, the existing priority is automatically altered. The system may request the user to confirm the alteration of the priority according to given options.

The same is applied to the other languages. For example, [symbol] can replace [symbol] and [symbol] respectively, in the above case.

6.6 Automatic Designation of Simple Code and Marking Simple-Code-Associated Characters in Bold

Not only fully associated simple code but also consonant-associated simple code, syllable-based initial code and word-based initial code follow regulations in their production. Hence, the user enters a specific word or phrase to designate a simple code for the word or phrase while the production regulations of simple codes are defined, and then the corresponding simple code is automatically extracted and stored in the system. Here, characters associated with the simple code are marked in bold to increase convenience for use. In regard to English, the characters associated with the simple code may be embossed as capital letters.

The prior document discloses the “SIM” and the “short-cut/full CIM”. The simple code for short-cut input may be defined in the system and then altered by the user. The user may further designate a simple code for another word or phrase.

Designation of a simple code for a new word or phrase may follow defined regulations for production of simple codes, such as fully associated simple code, partially associated simple code, consonant-associated simple code, syllable-based initial code, or word-based initial code, as disclosed in the prior document. To produce a simple code for “dance with the wolf” from a word-based initial code, for example, the user has to enter “dance with the wolf” and then “3983” as a word-based initial code in the simple code create mode. Likewise, in order to produce a simple code for [symbol] from a syllable-based initial code, the user has to enter [symbol] and then “9196” in the simple code create mode.

It is however possible to designate a simple code for a specific word or phrase automatically without taking the trouble to enter a desired code type, if the user make the system memorize the desired type of the simple code. For example, when the user sets a desired type of the simple code as the syllable-based initial code in the system and simply enters [symbol] the system designates the simple code for [symbol] as “9196” in an automatic manner. Likewise, when the user sets the system to use syllable-based initial codes and enters [symbol] the system automatically designates “97” as the simple code of [symbol] (xiansheng).

It has been described that characters of English associated with the simple code can be capitalized and marked in bold. In regard to this, when the user designates the use of capitals in the simple code in advance and enters “DaTe ToNight”, the system automatically determines the simple code as “3886” corresponding to the capitals “DTTN”. Otherwise, if the user enters “ToNight ShoW”, the system automatically determines the simple code as “8679” corresponding to the capitals TNSW”.

6.7 SIM and CIM Using Simple Code for Word or Phrase

As the user enters a simple code (unless specified otherwise, the simple code includes the initial code, which is the special case of the simple code), the system (client system or server system) can recognize the simple code as its corresponding word or phrase. It is thus apparent that when the system recognizes a specific simple code as a corresponding word or phrase and displays the word or phrase, the user can utilize the displayed word or phrase in entering a new word.

In the character input method used in other countries, a character input system is realized in such a manner that the terminal (client system) stores the index having “fully associated simple codes” assigned word by word and displays corresponding words of a given code input from the user according to the priority order by words, thus allowing the user to determine the target word. For more information, reference to the Internet sites, http://www.tegic.com and http://www.zicorp.com is recommended. Hereinafter, such a method will be referred to as “fully associated SIM” or “foreign method”. Expediently the method is also called “T9 Like Input Method (T9LIM)”, because the representative input system using the approach is “T9” supplied by Tegic Co. FIG. 5-2 shows an input example of the T9 system. As shown in FIG. 5-2, when the user enters “622...” for “meet”, the system provides “off” for the user. Otherwise, when the user enters “6228”, the system displays “meet”.

A comparison between the methods by Tegic Co. and Zi Corp. and the method for entering characters from a keypad according to the prior document of the applicant reveals that the character input method of the applicant assigns unique codes to each character and thereby allows the entry of a target character or a target word (phrase) with a full code, while the above-mentioned foreign method assigns fully associated simple codes to each word and allows the entry of a target word with the simple code.

The foreign method has the following drawbacks: (1) it allows exclusively the entry of predefined words, because the code is assigned to each word; (2) when different words share the same code, it is difficult to enter words less frequency used, because the user takes the trouble to select and confirm the target word with a toggle button or a move button; (3) words other than the target one may appear temporarily during inputting of the word; and (4) a large storage capacity and much cost are required to implement the system.

It is possible to assign a simple code (i.e., partially associated simple code or fully associated simple code) to a commonly used word or phrase and use the simple code in entering the target word or phrase. Of course, the commonly used word or phrase and the simple code of the commonly used word or phrase can be predefined in the system and provided to the user, or arbitrarily designated by the user. Alternatively, the user should be allowed to arbitrarily alter the simple code predefined in the system. It is advantageous to allow the user to designate the simple code, because the user is ready to get the knowledge of the simple code value for a specific commonly used word or phrase.

Expediently, in the present invention, a method for entering a target word or phrase using a simple code (including partially associated simple code, fully associated simple code and initial code) is called “short-cut input method (SIM)”, while a method for entering a target character using a full code is called “full input method (FIM)”. As will be described later, a combination of SIM and FIM can also be used. Expediently, such a method is referred to as “short-cut/full Concurrent Input Method (short-cut CIM)” or just “Concurrent Input Method (CIM)” for short.

Ambiguity occurs due to repeated selection in FIM, even though unique codes are assigned to each character and used to enter a target character. Expediently, such ambiguity is called “first ambiguity” or “character ambiguity”. On the contrary, ambiguity occurs between different words sharing the same simple code in a method such as the foreign method (i.e., SIM) in which codes are assigned to every word and used to enter a target word. Expediently, such ambiguity is called “second ambiguity” or “word (phrase) ambiguity”. The term “ambiguity” as used herein refers to the first ambiguity.

There are two scenarios: one is that the system first interprets a specific input value as a simple code (i.e., the first step of using SIM, or applying the short-cut input mode as the basic input mode), and without any simple code corresponding to the input value, the systemthen recognizes it as a full code (i.e., the second step of using FIM); and the other is that the system first checks whether a specific input value forms a full code (i.e., the first step of using FIM, or applying the full input mode as the basic input mode), and if the input value does not form a full code, the system then recognizes the input value as a simple code (i.e., the second step of using SIM). First interpretation of an input value as a simple code is applying the “short-cut input mode” as the basic input mode, while first interpretation of an input value as a full code is applying the “full input mode” as the basic input mode. Preferably, those who mostly input a commonly used word or phrase first apply SIM (i.e., applying the short-cut input mode as the basic input mode), and those who mostly do not input a commonly used word or phrase first apply FIM (i.e., applying the full input mode as the basic input mode).

In the full input mode designated as the basic input mode, the system first interprets an input value as a full code and erroneously recognizes an input simple code as an undesired word. For example, when BRSM is applied as FIM in FIG. 4-2, the simple code of a word [symbol] is designated as “877” (using a syllable-based initial code) and the system first interprets the input simple code “877” as a full code, thereby recognizing [symbol] This applies to the words such as [symbol] in which the initial consonants of the second and third syllable (letter) correspond to the same button. On the other hand, in the short-cut input mode designated as the basic input mode, the system first interprets an input value as a simple code and erroneously recognizes an input full code as an undesired word. Such ambiguity between simple code and full code in CIM will be referred to as “third ambiguity”.

The third ambiguity can be overcome by using a toggle button or using a move button for the selection of the target word just like the conventional ones. Another alternative method is that the input mode is switched between full input mode and short-cut input mode in the unit of word before input values causing the third ambiguity are entered. This is similar to the method described in the prior document of the applicant in which [symbol] control (i.e., Hiragana/Katakana transition control) is provided to enable entry of a Katakana word in the Hiragana mode or entry of a Hiragana word in the Katakana mode. For example, in the full input mode designated as a basic input mode, the system initially recognizes an input value after selection of the “short-cut/full” control as a simple code and provides to the user a target word corresponding to the input value with reference to the index. Likewise, in the short-cut input mode designated as a basic input mode, the system initially recognizes an input value after selection of the “short-cut/full” control as a full code. The “short-cut/full” control can be selected before or after entry of the target word, but for the case of this control, it may be more convenient for the control to be selected before target word.

In CIM, the system may determine whether the input value is a full code or a simple code. Such a determination can be made in the unit of word as the index is referred in order to eliminate the first ambiguity as described above, or such a determination can be made in the course of entering the input value as described later.

While applying CIM in the full input mode designated as a basic input mode, the system checks input by input (i.e., value by value) whether every input code value forms a full code, determines the input value as a simple code at the time when the input code value is not considered to form a full code, and sends the user a word or phrase corresponding to the simple code with reference to the index, thereby enhancing the efficiency of CIM. Likewise, when applying CIM in the short-cut input mode designated as a basic input mode, the system checks whether every input code value is identical to the input value listed in the index, and recognizes the input code value as a predetermined full code of FIM at the time when there is no word matching the input value. This means that the third ambiguity can be eliminated at the beginning of the entry by using the regulations of FIM. The same applies to the case of using a character input method not disclosed as FIM in the prior document. Now, a description will be given as to FIM (base repeat selection method and part-whole selection method) disclosed in the prior document by way of the following examples.

For Korean, for example, the second and third input values of all syllables by the full code should be constant in using BRSM, which is illustrated in FIG. 4-2. If such a regulation is infringed, the input values are regarded as simple codes. When tense consonants can be processed through a combination of basic consonants, the associated criterion applies to all cases where BRSM is used.

In all languages, when PWSM is used as FIM, two input values correspond to one character and one input value is limited with respect to the other. In the case of English, for example, it is assumed that only a Horizontal Straight Combination (HSC) is used for English as shown in FIG. 1-1, not applying PWSM to input numerals. If the buttons [1], [2] and [3] on the first row are used as the first input value (first button) corresponding to one character, the second input value may correspond to the button [1], [2] or [3] on the first row. Likewise, when selecting the button [4], [5] or [6] on the second row after [2]+[1], the next value to form a full code is one of the buttons [4], [5] and [6] on the second row. When the input value violates this rule, the system regards the input value as a simple code and recommends a word corresponding to the simple code to the user. For example, when the user enters “4357” as the simple code of “help” in the CIM where PWSM is used as FIM and FIM is performed in the basic input mode, the system recognizes that the input value does not form a full code the moment the second input value “3” is entered. Then the system considers the input value as the simple code.

When using PWSM in FIG. 4-2, the next button in response to the input of the first button [1] for a full code is no more than button [1] or [2]. If this rule is infringed, the system regards the input value as a simple code rather than a full code and recommends a target word corresponding to the input value to the user with reference to the index. If four characters P, Q, R and S are assigned to button [7] as shown in FIG. 1-3, one of the four characters can be allocated to the lattice element that forms Vertical Adjacent Combination (VAC) in PWSM. When the button [7] is selected in order to form a full code for one character in this case, the next input button may be button [7], [8] or [9] on the third row, or button [4]. If this rule is infringed, the input value can be regarded as a simple code. The same applies to all languages if using PWSM as disclosed in the prior document.

For example, when the user enters “25” in the case where PWSM is used as FIM performed in the basic input mode and the simple code of [symbol] (Beijing) is stored as a syllable-based initial code “25” in the simple code index of FIG. 1-1, the system recognizes that the input value “25” does not form the full code (because the button on the position of Horizontal Straight Combination is one of buttons [1], [2] and [3]) the moment the user selects button [5] after the stroke of button [2] (from the start of the word). Then the system provides [symbol] corresponding to the input value “25” for the user with reference to the simple code index. For Chinese, the system provides Chinese characters (i.e., [symbol] as a word corresponding to the simple code “25” for the user (because the Chinese characters [symbol] form a target word). For languages using phonetic characters other than Chinese, the system provides “Beijing” corresponding to the simple code “25” for the user. If there are multiple words or phrases that correspond to the simple code “25”, the words or phrases are listed to the user for selection or the user can select a desired word or phrase by repeatedly stroking a specific button (in toggling manner). Refer to FIG. 5-4.

Accordingly, the Concurrent Input Method (CIM) of FIG. 5-4 is registering simple codes of frequently used words such as [symbol] in the simple code index and using Full Input Method(FIM) and Short-cut Input Method (SIM) simultaneously without transition of FIM mode and SIM mode, thereby reducing the number of strokes in entering the registered words with simple codes.

FIG. 4-5 shows that one basic consonant is assigned to each button. Thus when syllable-based initial codes generally used in Korean are utilized as simple codes, the third ambiguity is avoidable in using both SIM and FIM. That is, when the user inputs syllable-based initial codes in using CIM, the input values from the second input (when inputting aspirated consonants and tense consonants by CPM) hardly form a full code. Thus the system refers to the index of simple codes and recommends proper words in the order of priority to the user. The similar principle can be applied to the input of a full code in CIM.

As described above, it is the core of the present invention that it is possible to determine during the input of characters whether the input value is a simple code or a full code in using CIM. The same principle applies to the case where the system uses the FIM of the prior document and the present invention, or other FIM. For example, a character input method uses a combination of a first button for each character and a second button corresponding to the sequent order of the character of the first button. Namely, the entry is given as “P=[7]+[1]” in FIG. 1-1. Because the second button is one of buttons [1], [2] and [3] in FIG. 1-1, the system considers the input value as a simple code, the moment the input value infringes this rule. Particularly, the FIM of the applicant is advantageous, as described in the above example, in that whether the input values form a full code in FIM can be checked during the input.

Furthermore, the interpretation of a simple code or full code may be achieved in the client terminal or the server, as described in the prior document of the applicant. In looking up the target word in the index in order to overcome the first ambiguity (character ambiguity) in the prior document, a scenario that the system refers to the index of the client in the first stage and then the index of the server in the second stage applies to the interpretation of simple codes or full codes. Alternatively, the system may refer to the index of the server in the first stage and then the index of the client in the second stage. Furthermore, when the system interprets the input value as a simple code with reference to the index of the client in the first stage and then the index of server in the second stage but fails to find a simple code for the input value, it recognizes the input value as a full code in such a manner that it refers to the index of the client at the first stage or otherwise the index of the server at the second stage. Alternatively, the system interprets an input value as a simple code in the first stage with reference to the indexes of both the client and the server and then allows the user to select the target word. Any similar variations are possible in regard to the interpretation method (simple code or full code) and the interpretation site (client or server). That is, there are various combinations of the interpretation method (simple code or full code) and the interpretation site (client or server). Namely, with reference to FIG. 5-5, any combination of (A), (B), (C) and (D) is available for the input value, for example (A)-(B)-(C)-(D) or (A)-(C)-(B)-(D), and so on.

A concurrent use of SIM and FIM has advantages as follows: (1) in using FIM, the user is allowed to input almost all words including those nonexistent in the dictionary as well as predefined words; (2) the user can designate simple codes for the use of SIM on commonly used words or phrases as he/she desires (either partially associated simple codes or fully associated simple codes); (3) the user can designate partially associated simple codes to dramatically reduce the stroke count of the input; and word-based initial codes are assigned for phrases as well as words. On the contrary, the methods of foreign countries refer to the index for all input words word by word and thus have to use fully associated simple codes in order to minimize the probability that the same code is assigned to different words.

In addition, the system has an “index” containing specific words or phrases commonly used and code values for the words or phrases, which index requires a much lesser capacity of memory than that in the methods of foreign countries. Such an index may be the same as an “index” in the system that contains ambiguous words that are correct or incorrect in order to eliminate ambiguity.

Consonants have the sound values of a specific word in every language and a method for extracting consonants into an abbreviation has been widely used. For an example of English, the military term “captain” is abbreviated as “CPT” that comprises consonants having the sound values of “captain”, “sergeant” “SGT”, “staff sergeant” “SSG”, “sergeant first class” “SFC”. Although “captain” and “private” have two syllables, the consonants extracted as the abbreviation are considered as those that represent the respectively syllables. Accordingly, the simple code of “captain” is “278” associated with “CPT”.

The present invention in which the system is allowed to designate partially associated simple codes for commonly used words or phrases based on the syllable and apply SIM is very significant in a sense as well as the fact less labor is required in inputting characters. A syllable is phonetically defined as “psychological noumenon”. It is the consonant that has a sound value in the syllable. It is impossible to analogize “captain” out of the vowel extract “AAI”. But, “captain” can be easily analogized from the consonant extract “CPTN” or “CPT”. It is reported that any English sentence can be analogized from the constituent consonants without a vowel in each word. That is, the use of partially associated simple codes in association with each consonant constituting a syllable makes the user to apply SIM naturally and provides more convenience in use.

In particular, the simple codes can be used on the basis of abbreviations, because abbreviations are widely used in the English-speaking world and, for example, the listed company name is usually designated as an abbreviation.

The user is allowed to designate the type of simple code (i.e., partially associated simple code or fully associated simple code) for a specific word or phrase, which is advantageous in that it is easy to memorize the code values of commonly used words or phrases. Furthermore, if the user needs to use only a part of commonly used words or phrases, simple codes (e.g, 1, 2, 3, etc.) rather than the codes associated with the characters of the word or phrase are assigned to each word or phrase.

6.8 Grouping of Simple Code/Corresponding Word or Phrase, and Designation of Searching Range

There are many cases where much overlap occurs in designating simple codes for a plurality of words or phrases. The ambiguity between simple codes (i.e., the second ambiguity) can be reduced by grouping the word or phrases corresponding to the simple codes and searching simple codes only for a specific group of words or phrases. A word or phrase does not necessarily belong to only one group and may be included in a plurality of groups.

For example, the word or phrases after simple naming are divided into categories of listed company name, city name, commonly used word (or phrase), etc., and the group of commonly used words (or phrases) are subdivided into categories of society, politics, etc. Although this embodiment provides a two-staged tree-type grouping, the grouping may be of a tree type with three, four or more stages. Refer to FIG. 5-6. If the user (or system) limits the searching range of the simple code to the group of listed company names, the system searches named words or phrases corresponding to a specific input simple code within the category of the listed company name, thus reducing the second ambiguity. Likewise, when the user limits the searching range to the group of commonly used words or phrases, the system searches named words or phrases within the category of commonly used words or phrases and all its subgroups. If the user limits the searching range to the category of society in the group of commonly used words or phrases, the system searches named words or phrases within the category of society and its all subgroups.

Tree-type groups in FIG. 5-6 are considered to be folders in the Window explorer. The search range can be reset by the system in an automatic manner. For example, when the user selects a specific city in the hierarchy structure of administrative districts stored as the sub groups of city name, the search range for the next input value is the name of the lower administrative district unit of the specific city. For example, when the user selects [symbol] as a city, the next selection range is [symbol] as wards in Seoul city. When the user selects [symbol] the next selection range is [symbol] in Yangcheon-gu.

6.9 Use of Switching Server

Interpretation of simple codes may be performed at the client terminal or the server. Alternatively, there may be used a switching server which is wholly charged with interpreting simple codes (including full codes under in some cases) to provide words or phrases corresponding to the simple codes to the client terminal or another server. Reference is made to FIG. 6-1. In the figure, the client terminal first decodes a simple code, and if it cannot interpret a word or phrase corresponding to the input simple code, the switching server interprets the word or phrase corresponding to the input simple code in the second stage. Upon failure, each server can interpret the word or phrase corresponding to the input simple code in the third stage. The third simple code-decoding server (expediently, called “third server”) is a server equipped with an application using the input simple code or its corresponding words or phrases.

With the switching server, the user inputs simple codes even when the third server requests a word or phrase other than the simple codes. Even though the third server does not store simple codes and words or phrases corresponding to the simple codes, the switching server interprets the simple codes input by the user to send the corresponding words or phrases to the third server.

When a simple code is input, the system looks up the words or phrases corresponding to the simple code in the index and feeds back the words or phrases to the client terminal or each server, input by input (i.e., value by value) or in the unit of words (i.e., word by word).

6.10 Division of Word Unit

The term “word unit” as used herein refers to the length of a word ranging from head to tail of the word. The word unit can be determined by a combination of all factors that discriminate between words, such as the head of a word, space, mode transition, enter, etc. For example, the entry of a word is identified through the head of a word˜the tail of a word, space˜space, space˜mode transition, and the like. The feedback in units of words can be performed through the programming languages that currently support the network environment.

6.11 Download of Simple Code and Corresponding Word or Phrase

It is also possible for the client to download the simple codes and the words or phrases corresponding to the simple codes from the server without directly storing the simple codes and their corresponding words or phrases.

Download may be achieved in the unit of words or phrases, or in the unit of the above-mentioned word or phrase groups (i.e, groups of the tree structure). If selecting a group, the client can download the subgroups as well as the selected group. During download, the client terminal may maintain the tree structure of the word or phrase group as set by the server, or assign the words or phrases belonging to the corresponding group and its subgroups to one group designated by the user. A switching server whose main function is decoding simple code can be in charge of this operation.

7. Input of Symbols

As described in the prior document, characters are arranged in the order of mother language, numerals and English alphabet, which are allocated “in the Order of Proximity to a BLE (OPBLE)”, and mother language and numerals are selected in the order of proximity to a BLE in BRSM. Likewise, numerals and English alphabet as well as mother languages assigned to a specific button can be entered using SCPM.

Furthermore, the present invention provides a method for efficiently entering various symbols not marked on the keypad (i.e., using the hiding control processing method), while such symbols are to be marked on the keypad in the prior document.

That is, the present invention assigns “symbol control” to the proper one of the lattice elements, which are allocated to controls in the invention of the prior document, and inputs a symbol by compounding the symbol control and a button (i.e., another button other than the control button) which is associated with specific symbol. Here, the button which is associated with dot “.”, for example, is button [5], because [symbol] is associated with the first syllable

[symbol]

For example, as described in the prior document, the symbol control may be arranged at the position of a lattice element that can be selected with two consecutive strokes of button [*] in the example of Korean (FIG. 4-2). That is, the relation between a representative character and its succession characters is given as [symbol] (the representative character), [symbol] (2nd), symbol (3rd), . . . For example, the entry of “.” is given as [symbol] ={symbol}+ [symbol] =[*]+[*]+[5] when the control is set to be selected before representative character, or [symbol] = [symbol] +{symbol}=[5+[*]+[*] when the control is set to be selected after representative character. If the symbol control is arranged at the position of a lattice element that can be selected with three successive strokes of button [*], one selection of button [*] is added to the above example.

With only one symbol control, it is possible to input no more than 10 symbols even though symbols are assigned to each of 10 numeral buttons. For example, assignment of symbols to each button may be given as follows:

Button [1]: symbol “?” ( [symbol] is associated with “?” in shape);

Button [2]: symbol “!” ( [symbol] is associated with the first syllable [symbol] (which means “exclamation mark” in Korean)”;

Button [3]: symbol “$” [symbol] is associated with the first syllable [symbol] of

(which means “dollar” in Korean”);

Button [4]: . . .

Button [5]: symbol “.” [symbol] is associated with the first syllable [symbol] of [symbol] (which means “dot” in Korean”);

Button [6]: symbol “*” [symbol] is associated with the first syllable [symbol] (which means “asterisk” in Korean);

Button [7]: symbol “,” [symbol] is associated with the first syllable [symbol] (which means “comma” in Korean);

Button [8]: symbol “″” ( [symbol] is associated with the first syllable [symbol] (which means “quotation” in Korean);

Button [9]: symbol “˜” (vowel “—” is associated with “˜” in shape); and

Button [0]: symbol “@” (numeral “0” is associated with “@” in shape).

As described above, it is possible to input various symbols by compounding a symbol control and buttons that remind of the symbols. The symbols are assigned to each button in consideration of the relation between the name in the mother language or the shape of the symbol and the character on the button, or between the name in English or the shape of the symbol and the English alphabet on the button, or between the name or shape of the symbol and that of the numeral on the button. Such considerations are not specifically limited to those mentioned above and can be operationally reset by the user according to the user's liking.

Thus those symbols that are used frequently can be treated as if they are succession characters belonging to the numeral buttons readily reminding of the respective symbols. In the above example, the question mark “?” (the Korean name is [symbol] is associated with button [1] designated for [symbol] in consideration of similarity of shape, because the dot “.” (the Korean name is [symbol] more prevailing than the question mark has [symbol] as the initial consonant of the first syllable

[symbol]

Likewise, assignment of symbols to each button may be associated with English name/shape or Numeral name/shape. The following example applies in combination with mother languages.

Button [1]: symbol “?” (character “q” is associated with the first character of “Question mark”);

Button [2]: symbol “,” (“c” is associated with the first character of “Comma”);

Button [3]: symbol “.” (“d” is associated with the first character of “Dot”);

Button [4]: symbol “!” (“i” is associated with “!” in shape);

Button [5]: ...

Button [6]: ...

Button [7]: symbol “/” (“s” is associated with the first character of “Slash”);

Button [8]: symbol “:” (numeral “8” is associated with “:” in shape);

Button [9]: symbol “!” (“x” is associated with the pronunciation of “eXclamation mark”); and

Button [0]: symbol “@” (numeral “0” is associated with “@” in shape).

Assignment of symbols mainly using English is advantageous in that such assignment is applicable to the non-English-speaking world in which mother languages in combination with English ones are marked on the keypad. Using the similarity of shape between colon “:” and numeral “8” is generally acceptable irrespective of the language. Likewise, if not applied to the above example, the similarity of shape between comma “,” and numeral “9” may also be considered in assigning of “,” to button [9].

Symbol control may be allocated to a proper button. For English, unless another control is allocated to button [*] in FIG. 1-1, the symbol control may be selected with one stroke of button [*] (i.e., the symbol control is arranged at the position of the base lattice element of button [*]). For mother languages in Europe that include affixed characters with an affix, the symbol control may be arranged at the position of the base lattice element of button [0] or [#]. With the symbol control assigned to button [0], it may be desirable not to assign symbol “@” to button [0].

If control is set to be selected after representative character and the symbol control allocated to button [*], the entry of colon “:” in FIG. 1-1 is given as“:=[8]+{symbol}=[8]+[*]”.

As is apparent from the above example, it is possible to input no more than about ten symbols in the case where each button has the meaning of an associated symbol and the symbol control is allocated to one lattice element of the control button. The button marked with “s” can be designated for any one of symbols such as slash, semi-colon, period, etc., as it is associated with “slash” in the above example. As the button marked with “d” is associated with “dot”, the button of “i” is designated for “exclamation mark” in consideration of similarity of shape.

It is therefore possible to input more symbols by CPM with a plurality of symbol controls (e.g., symbol control 1, symbol control 2, . . . ). For example, the meaning of dot is assigned to the button associated with “d” (or the meaning of

is assigned to the button marked associated with

to deal with comma “,” similar in shape as if it is the succession character of “dot”.

As shown in FIG. 7-2, in which the symbol control is added to FIG. 4-5, when control button is set to [*] and a control is set to be selected after the input of a representative character, entries are given as “dot (.)=[3]+{symbol1}=[3]+[*]+[*]+[*]”, and “comma (,)=[3]+{symbol2}=[3]+[*]+[*]+[*]+[*]”. From a standpoint of the chain-type Succession Control Processing Method (SCPM), the entry is given as comma (,)=dot+{next}=dot+[*]=[3]+[*]+[*]+[*]+[*]. When an aspirated consonant is not input by CPM (i.e., assuming that there is no aspirated consonant control on the control button), “symbol control 1” is selected with two strokes of button [*] (i.e., Jump Control Processing Method is applied). Likewise, colon and semi-colon, which are similar in shape to each other, can be regarded as the succession characters assigned to the same button and input by CPM. The same applies to the other symbols.

Even with two symbol controls, i.e., “symbol control 1” and “symbol control 2”, the system has to assign the meaning of symbols to each button and memorize it, and thus has a limitation in the number of symbols for entry. Hence, the symbols are grouped as, for example, dot and comma, or colon and semi-colon and a plurality of symbol controls are arranged so as to input a large number of symbols.

It is preferable that the user optionally set the symbol grouping. The present invention presents a general example of symbol grouping. First, modifications of dot “.” can be grouped like as, for example, dot “.”, comma “,”, colon “:”, semi-colon “;”, quotation mark “″”, question mark “?”, exclamation mark “!” and so forth. This group comprises dot-shaped symbols, i.e., “zero-staged” symbols. Here, question mark “?” and exclamation mark “!” are both zero- and one-staged and thus included in the zero-staged (dot-shaped) symbol group. The adjunctive priority of the group is determined in consideration of the use frequency as described in the prior document. Preferably, the user may designate such considerations in determination of the priority. It is recommendable that the control is set to be selected after representative character, when a large number of symbols are regarded as the succession characters. A terminal with a display window may display the change of succession symbols when the control button is repeatedly pressed.

The user is allowed to optionally associate the dot-shaped (zero-staged) symbols with specific buttons. For example, dot “.” as a most frequently used and representative symbol of the group is regarded as a succession character belonging to button [3] which includes “d” of “dot”. If control after input representative character applies with the symbol control button designated as button [*] in FIG. 7-1, in which the symbol control is added to FIG. 1-1, entries are given as dot (.)=[3]+[*], comma (,)=[3]+[*]+[*], colon (:)=[3]+[*]+[*]+[*], semi-colon (;)=[3]+[*]+[*]+[*]+[*], and so forth. The dot-shaped symbols may be regarded as the succession characters belonging to the button [0] and associated with the button [0] because they are zero-staged form. Alternatively, they can be regarded as the succession characters belonging to the button [1], considering that dot “.” is the most fundamental form.

Next, line-shaped (i.e., one-staged) symbols are grouped like as, for example, slash “/”, hat mark “ˆ”, question mark “?”, exclamation mark “!”, round bracket 1 “(″”, round bracket 2 “)”, crooked bracket 1 “<”, crooked bracket 2 “>”, square bracket 1 “[”, square bracket 2 “]”, wave mark “˜”, minus “−”, arrow 1 “←”, arrow 2 “→”, and so forth. The adjunctive priority of the group is determined in consideration of the use frequency or the like as described in the prior document, and associated with the succession characters of a specific button, which button may be properly designated. For example, the line-shaped symbols are regarded as the succession characters belonging to button [1], or button [5] that is designated for the character “I”.

Line-associated (i.e., two-staged) symbols are grouped like as, for example, at “@”, ampersand “&”, asterisk “*”, sharp “#”, dollar “$”, won “W+=”, yen “¥”, . . . , heart 1 [symbol] heart 2 “♥”, clover 1 [symbol] empty triangle 1 [symbol] empty triangle 2” [symbol] empty triangle 3 [symbol] . . . , occupied triangle 1 [symbol] . . . , [symbol] [symbol] and so forth. The adjunctive priority of this group is also determined in consideration of the use frequency or the like as described in the prior document, and associated with the succession characters of a specific button by using an adequate method. It is necessary that the symbols of this group should be associated with other buttons than those associated with the zero- and one-staged symbols.

Grouping the symbols into three groups, i.e., zero-, one- and two-staged symbol groups is advantageous in that the user has only to memorize three associated numeral buttons, but requires several strokes of the control button in entering rarely used symbols. To overcome this problem, the three groups are subdivided into subgroups as follows.

First, the two-staged symbols are subdivided into a line-associated symbol group (i.e., *, #, %, ...) and a second symbol group in the form of a simple closed curve (i.e., [symbol] . . . ). In addition, a separate symbol group comprising pictures (i.e., [symbol] . . . ) may be provided, which symbols are also regarded as the succession characters belonging to proper buttons. The symbols of the separate symbol group may be excluded from the previous symbol groups or not. The same applies to the other cases.

Another separate symbol group comprises one- or two-staged symbols that are used in the mathematical relation, for example, +, −, *, /, square root “√”, sigma “Σ”, integral “∫”, or the like. These symbols are also regarded as the succession characters belonging to proper buttons. Further another separate symbol group comprises directional symbols, for example, [symbol] or the like, which symbols are also regarded as the succession characters belonging to proper buttons.

Still further another separate symbol group is reasonably provided, comprising parentheses, for example, (,), [,], {,}, <, >, or the like. The parentheses may also be subdivided into two subgroups, right parenthesis group and left parenthesis group.

With the three symbol groups and their subgroups provided, the characters belonging to the subgroups are optionally included in the three symbol groups, or not. It should be noted that those characters of the subgroups included in the three symbol groups acquire the lower priority.

The above-described symbol grouping applies to FIG. 1-1, in which the symbols of each group are regarded as the succession characters of specific button as follows. For example, zero-staged symbols are regarded as the succession characters of button [0], one-staged symbols as those of button [1], two-staged symbols as those of button [2]. In the two-staged symbol group, symbols in the form of a simple closed curve are regarded as the succession characters of button [8], symbols in the form of a picture as those of button [7], mathematical symbols as those of button [6], directional symbols as those of button [3], parenthesis symbols as those of any one of the rest numeral buttons. The method of associating symbol groups to each button is not limited to the above example and may be optionally set by the user.

After considering all the factors, it is the core of the present embodiment that symbols are divided into three groups (i.e., zero- one- and two-staged symbol groups) or subdivided into ten or less subgroups, and regarded as the succession characters belonging to specific buttons, as a result of which the present invention provides a method for entering almost all symbols. Furthermore, the individual symbol groups are regarded as the succession characters belonging to specific buttons, which are associated with the symbol groups in name, dimension, shape, or the like, so that the “Hiding Succession Control Processing Method (HSCPM)” can be used on the keypad having a simple arrangement of characters without any symbol marked.

The control button for symbol is button [*] or any one of up/down/left move buttons in this application, and the succession control button for numerals and English alphabet may be button [#]. For example, when button [#] is used as a succession control button, additional succession control for numerals and English alphabet is to be arranged to an available lattice element on button [#]. It is also possible in this case to skip the control not associated with the representative character and select the next available control, as described above.

8. Use of Move Button

8.1 Use of Move Button as Control Button

According to the prior document, the control button can be a button on a 4*3 keypad or a separate one, and the 4*3 keypad is short of control buttons in entering the language where a number of characters and its affixed characters exist. The present invention suggests that left/up/down move buttons not frequently used in the character input mode can be used as such control buttons as mentioned in the prior document. That is, the left/up/down move button is used in the character input mode as a control button, which is a separate button arranged out of the 4*3 keypad.

FIG. 8-1 illustrates the arrangement of buttons on a typical folder type mobile terminal. The button [I] indicated by a broken line is an Internet connection button, which may be provided or not according to the type of the terminal. The left move button is a space input button, especially used as a syllable (letter) confirm button for eliminating the first ambiguity in Korean. Up/down/left move buttons are useful as a move button for selection of menus in the menu select mode other than the character input mode. However, the up/down/left move buttons, particularly up/down move buttons, are not so frequently used in the character input mode.

8.2 Arrangement of Move Button Below Keypad

The up/down/left/right buttons are generally positioned above numeral buttons. In order to use these move buttons as a the button for character input in the character input mode, however, it is desirable the move buttons are to be arranged below the 4*3 keypad together with buttons [*] and [#] mainly used as control buttons. This is illustrated in FIGS. 8-2 and 8-3. Expediently, the embodiment of the present invention provides, if not specifically limited to, an arrangement of the move buttons below the 4*3 keypad.

As it is apparent from the figures, the 4*3 keypad and the up/down/left move buttons form a 5*3 keypad. This suggests that the individual buttons can be used as 15 (=3×5) lattice elements in PWSM. Likewise, the up/down/left move buttons have not to be necessarily arranged to form a 5*3 keypad as illustrated in FIG. 8-3.

8.3 Arrangement of Move Button on Left or Right Side

The up/down/left/right move buttons may be allocated to the left or right side to the 4*3 keypad. In this case, the move buttons and the 4*3 keypad form a 4*4 keypad in PWSM. FIG. 8-4 illustrates an arrangement of the up/down/left/right move buttons on the right side to the 4*3 keypad.

Advantageously, such an arrangement enlarges the size of the display on the terminal, following the trend of the terminal having a large-sized liquid crystal display (LCD), and acquires excellent features in combination with the method disclosed in Korean Patent Application Nos. 10-2000-0002081, 10-2000-0005671, 10-2000-0067852 and 10-2001-0002137 filed by the present applicant, in which the side battery is attached to the mobile terminal.

8.4 Use of Move Button as Control Button and Character Input Button

Hereinafter, the use of the move buttons will be described by way of the following examples, which are not limited to the scope of the embodiment of present invention.

8.4.1 Use of Move Button as Symbol Control Button

For Korean, aspirated consonant control and tense consonant control are allocated to buttons [*] and [#], respectively; or aspirated consonant control and tense consonant control are allocated to button [*], with basic vowel control and extended vowel control being allocated to button [#]; or only the extended vowel control is allocated to button [#]. In these cases, if control(s) after input representative character applies with the symbol control(s) allocated to button [*] or [#], entries are given in the sequent order of aspirated consonant, tense consonant and symbol(s) when the control button is repeatedly pressed. The same applies to other languages.

If the symbol control(s) is/are separately allocated to any one of the up/down/left move buttons, the symbol is entered with a combination of the button associated with the corresponding symbol group and the symbol control button designated for the symbol control. FIG. 8-5 shows the use of the down move button as a control button for selection of symbol control. If control after input representative character applies to the zero-staged symbol group, entries are given as: dot=[3]+[v], comma=[3]+[v]+[v], colon=[3]+[v]+[v]+[v], semi-colon=[3]+[v]+[v]+[v]+[v], and so forth.

8.4.2 Use of Move Button as Vowel Element Button for Korean

The prior document has a disadvantage that when using vowel elements [symbol] and “.” for Korean, vowel element “.” is arranged together with [symbol] to make it convenient for the user to input [symbol] To overcome this problem, the present invention allocates the vowel elements on any one of the up/down/left move buttons. If the symbol control is allocated to the down move button, with the vowel element “.” on the up move button, two move buttons are to be used. Alternatively, the up/down/left move buttons are designated for three Korean vowel elements, respectively.

Similar to the case where the symbol control is allocated to the aspirated consonant control button, the Korean vowel element “.” can be arranged at the position of the base lattice element of any one of the up/down/left move buttons, with the symbol controls being assigned in the order of proximity to a BLE. This is illustrated in FIG. 8-6. As the vowel element “.” is not used alone, there is no ambiguity in selecting vowel elements and symbol controls by using RSM. In FIG. 8-6, one stroke of button [v] selects vowel element “.”, two strokes selects symbol control 1, and three strokes selects symbol control 2.

8.4.3 Use of Move Button as Affix Control Button for Japanese

For Japanese, the characters in the 50-character table are mapped to each button and the 2^{nd} and 3^{rd} succession controls are allocated to button [*], the 4^{th} and 5^{th} succession controls allocated to button [#] according to the assignment method 3 of the prior document. In this case, input controls for long sound, voiced sound and semi-voiced sound may be allocated to any button of the up/down/left move buttons, which is illustrated in FIG. 8-7.

8.4.4 Use of Move Button as Affix Control Button For Inputting Vowels in Arabic

For Arabic, controls for affix-type vowels can be distributed to any button(s) of the up/down/left move buttons.

8.4.5 Use of Move Button as Control Button for Thai

For Thai, succession controls for consonant and vowel share one control button as a succession control button. Any one of the up/down/left move buttons may be used as the control button for consonant or vowel. Any one of the up/down/left move buttons may be used as control button for other purpose.

8.4 Use of Move Button as Short-Cut/Full Transition Control Button

The third ambiguity may occur between simple codes and full codes in the Concurrent Input Method (CIM). For elimination of the third ambiguity, “short-cut/full” transition control in the unit of words is used. For example, to input a word by SIM during CIM when FIM is the basic character input mode, the user selects “short-cut/full” transition control and inputs a space (or the right move button) and then a simple code. Of course, the order of space and “short-cut/full” transition control can be changed. The “short-cut/full” transition control in the unit of words is assigned to any one of the up/down/left move buttons. And a control for both “short-cut/full” transition control and space input (with the right move button) is arranged at the position of the base lattice element on any one of the up/down/left move buttons. Reference is made to FIG. 8-8.

It is assumed that English alphabet of FIG. 1-1 are allocated to the numeral buttons of FIG. 8-8. If the fully associated simple code “4357” of the target word “help” is input in the full input mode set as the basic character input mode, the entry is given as “˜full code input+[ˆ]+[4]+[3]+[5]+[7]+[>]+full code input˜”. That is, the “short-cut/full” transition function and the space input function are combined together while the move-related function of the up move button [ˆ] is suppressed. Thus, upon selection of button [ˆ], the system recognizes “[4]+...” as a simple code instead of a full code and recommends the user the words most corresponding to input [4] with reference to the index. After the input of [4]+[3]+[5]+[7], selection of a space button (i.e., [>]) ends the word and ends the “short-cut/full” mode transition, and causes the system to wait for the input of another full code. After the input of the simple code “4357”, selection of button [ˆ] causes the system to recognize the end of the word, determine the word “help” corresponding to the simple code “4357” and wait for the input of another simple code.

The third ambiguity may occur between simple and full codes as described in the prior document when using only the right move button (i.e., the space button) in CIM. To avoid the third ambiguity in this case, the system checks, in response to every input of the button, whether a simple code exists in the index or a full code is formed according to predetermined FIM. The use of a button combining word-based “short-cut/full” mode transition and space input allows the system to determine in advance whether the input value is simple code or full code. This reduces the number of calculations and searching steps to enhance the performance of the system.

8.6 Use of Move Button as Addition/Subtraction/Multiplication/Division Buttons in Calculation Mode

Irrespective of their position, four move buttons are to be used as addition (+), subtraction (−), multiplication (×) and division (/) buttons, which are most frequently used in the calculation mode. If not specifically limited, the symbols for addition, subtraction, multiplication and division may not be marked on the buttons because the calculation function is not so frequently used as the character input function. The individual buttons are to be used as move buttons or control buttons in the character input mode.

Also, operators used in the calculation function can be assigned to the addition, subtraction, multiplication and division buttons and selected by the (hiding) repeat selection method. This makes the use of the fact that operators (binomial operators) frequently used in the calculation mode rarely repeat. For example, 2++1 is nonexistent. 2⁴ is exploded as 2××4, so that the “square” operator is selected with two strokes of the multiplication (×) button. That is, the multiplication button (×) is selected twice as if the square operator (××) exists as the subsequent operator. Likewise, exploding \sqrt{3} as “3//2”, the “root” operation is selected with two strokes of the division (/) button. Because other binomial operators rarely repeat, they are regarded as the subsequent operators adjunctive to a proper addition, subtraction, multiplication or division button to select the subsequent operators by RSM.

Addition, subtraction and division buttons are assigned to three of the up/down/right/left move buttons, a multiplication being assigned to button [*].

9. Activation of Help Function

For more convenience in use, it may be possible to display on a screen (i.e., LCD) functions not marked on the up/down/right/left move buttons in the respective input mode. This function uses part of the LCD and it may be useless to those skilled in the function, but may be very helpful to those who have no knowledge of the function of each operator button. In regard to this, reference is made to FIG. 8-1. FIG. 9-1 illustrates another arrangement of the keypad in which the up/down/right/left move buttons are allocated to the right side to the 4*3 keypad as shown in FIG. 8-4.

Expediently, displaying the functions of buttons (i.e., operators allocated to the buttons or symbol groups associated with each button) according to the preference of the user is referred to as “activation of help function”. Activation of help function may be achieved for the individual modes (e.g., character input mode, calculation mode, etc.), or functions necessary in each mode (e.g., the use purpose of numeral buttons or control buttons associated with a symbol group in the character input mode).

Likewise, the function of control buttons or numeral buttons associated with the symbol group as provided in the prior document are also displayed for the purpose of convenience in use, as the user demands. In regard to this, reference is made to FIG. 9-2, which illustrates an example of the display that numeral buttons associated with each symbol group is simplified into icons on the LCD according to the above-described symbol grouping. Expediently, only the symbol first selected from the symbol group associated with each numeral button is marked on the numeral button in the form of icon.

10. Use of Delete Button

The use of a delete button may be associated with “cancellation of final input” as disclosed in the prior document. For example, when the user intends to enter [symbol] but mistakenly inputs [symbol] with selection of [1]+[*] (in FIG. 4-2), selection of the delete button may cancel the final input [*] and restore [symbol] This is useful in entering succession characters by repeatedly pressing control buttons. Successive strokes of the delete button can delete the previously input characters by way of the known method. For example, one stroke of the cancel button restores an input of [symbol] which becomes [symbol] with another stroke of the cancel button and [symbol] with further another stroke of the cancel button. For Roman alphabet, a stroke of the delete button on an input of “aba..” (where “a..” is an affixed character comprising “..” and “a”) provides “aba”, which becomes “ab” with another stroke of the delete button and “a” with further another stroke of the delete button. That is, previously formed characters are deleted in the unit of characters.

11. Equalization of Numeral Keypad for Keyboard With Keypad for Telephone

The keypad provided in the prior document and the present invention can be used in every application in the form of telephone keypad, such as a numeral keypad for mobile terminals or standard keyboards, a keypad implemented on the screen in software, a door lock, or the like. The keypad of the prior document and the present invention is different from the numeral keypad provided in the standard keyboard in regard to the arrangement of numeral buttons. It is however apparent that the arrangement of the buttons on the keypad according to the prior document and the present invention is applicable to the keypad provided in the keyboard. For example, characters on the button [1] according to the prior document and the present invention are allocated to the button [1] of the numeral keypad provided in the keyboard. Such a keypad arrangement is applicable for the purposes of character input, the use of simple codes, and memorization of various codes.

To reduce confusion and increase the convenience in use, the numeral arrangement of the telephone keypad is usable in the configuration of the numeral keypad for keyboards. That is, like the keypad of the telephone, the numeral keypad of the keyboard has a numeral arrangement in which buttons [1], [2] and [3] are allocated to the first row of the keypad, buttons [4], [5] and [6] on the second row, buttons [7], [8] and [9] on the third row. In addition, the keypad of the keyboard may have buttons [*] and [#] as that of the telephone.

12. Language Restricted Input Method (LRIM)

The Language Restricted Input Method is using consonant and vowel association rules in word production of a specific language to reduce ambiguity in entry of characters, which will be described in detail as follows.

It is apparent that some features mentioned below in regard to a certain language can be applied to other languages without any specified notice. Furthermore, the same is applied to languages not using Roman characters.

12.1 Chinese Restricted RSM on Consonant-Vowel Separated Keypad for Language Using Roman Characters

12.1.1 Construction of Chinese language

Chinese characters generally have two parts, the one of which is 21 initials (shengmu) and the other is 16 finals (yunmu) [symbol] is almost never used). The initials correspond to consonants and the finals correspond to vowels. The notation of Chinese pronunciation is based on the romanization system (pinyin) in China and the commented sound (Bo-po-mo-fo) system in Taiwan. The romanization system is using the letters of the Latin consonants and vowels, i.e., the Roman alphabet, to spell out the sounds of the Chinese characters. Parentheses include Roman characters corresponding to commented sounds as follows.

| | | |
|---|---|---|
| Initial | | [symbol] (b) [symbol] (p) [symbol] (m) [symbol] (f) |
| (shengmu) | | [symbol] (d) [symbol] (t) [symbol] (n) [symbol] (l) |
| | | [symbol] (g) [symbol] (k) [symbol] (h) |
| | | [symbol] (j) [symbol] (q) [symbol] (x) |
| | | [symbol] (zh) [symbol] (ch) [symbol] (sh) [symbol] (r) |
| | | [symbol] (z) [symbol] (c) [symbol] (s) |
| Final | simple final | [symbol] (a) [symbol] (o) [symbol] (e) [symbol] (ê) [symbol] (i) [symbol] (u) [symbol] (ü) |
| (yunmu) | double final | [symbol] (ai) [symbol] (ei) [symbol] (ao) [symbol] (ou) |
| | nasal final | [symbol] (an) [symbol] (en) [symbol] (ang) [symbol] (eng) |
| | retroflex final | [symbol] (er) |

Now, compound finals will be described. An associated final is a combination of an initial vowel (one of three vowels “i”, “u” and “ü”) and another final. The following table presents a list of the compound finals.

| | Simple Final | | | Double Final | | | | Nasal Final | | | |
|---|---|---|---|---|---|---|---|---|---|---|---|
| | a | o | e | ai | ei | ao | ou | an | en | ang | eng |
| i | ◯ | | ◯ | | | ◯ | ◯ | ◯ | ◯ | ◯ | ◯ |
| u | ◯ | ◯ | | ◯ | ◯ | | | ◯ | ◯ | ◯ | ◯ |
| 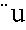 | | | ◯ | | | | | ◯ | ◯ | | ◯ |

In the table, the combination of “i+a” is available but that of “i+o” is impossible.

12.1.2 Romanization of Chinese

As seen from the above table, in the romanization of Chinese characters using Roman character, the 21 initials are represented with a combination of 18 Roman characters and 16 finals are represented with a combination of 7 simple finals or a combination of Roman alphabet vowels and consonants.

Among the simple finals, “ˆe” and “ü” are considered as the affixed characters of “e” and “u”, respectively, and entered by the control processing method. Five basic vowels with four pitches of tone can also be entered by the control processing method. Accordingly, for Chinese characters using Roman character, all the finals can be entered by the use of five Roman alphabet basic vowels. This is entering affixed characters not existing in the English alphabet (i.e., Roman alphabet) via control processing, which was previously stated in regard to the French and German languages. The following table presents an example of determining a relationship between basic character (basic vowel) and succession character(succession vowel) in the case of entering finals in Chinese using the Control Processing Method.

| | basic | succession vowels | | | | |
|---|---|---|---|---|---|---|
| | vowel | 2nd | 3rd | 4th | 5th | 6th |
| Group 1 | 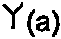 | a̅ | á | \check{a} | à | |
| Group 2 | 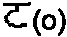 | o̅ | ó | \check{o} | ò | |
| Group 3 | 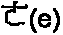 | e̅ | é | \check{e} | è | 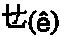 |
| Group 4 | 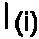 | i̅ | í | \check{i} | ì | |
| Group 5 | 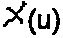 | u̅ | ú | \check{u} | ù | 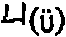 |

In the above example, the characters with the first to fourth pitch of tone are considered as succession characters, and “ˆe” nearly not in use is the lowest in priority. Of course, the priority depends on the frequency of use or other factor. For example, “ü” is not considered as the sixth succession character but as the second succession character and the other succession characters are relegated to the lower priority by one.

For example, when the control button is [*] and a control is set to be selected after the input of a basic character, entries are given as “⁻e=e+[*]”, “´e=e+[*]+[*]”, “^{v}e=e+[*]+[*]+[*]”, “`e=e+[*]+[*]+[*]+[*]”, and “ˆe=e+[*]+[*]+[*]+[*]+[*]”. If PWSM is applied to “e” marked on the keypad in FIG. 1-1, the full code of [symbol] (r′en: second pitch of tone) is “7832**65”. It is apparent that any other input method (e.g., simple repeat selection method) than PWSM can be applied to the entry of “e” on the keypad.

Accordingly, the input method can be simplified by using a single control button. The same is applied to the case of using commented sounds without the Roman alphabet (for example, the same input method can be applied to the keypad of FIG. 1-1 that marks commented sounds corresponding to Roman characters).

12.1.3 Chinese Restricted RSM (CRRSM) on Consonant-Vowel Separated Keypad (CVSK)

All the initials in Chinese characters can be entered with 18 Roman characters, and Roman alphabet consonants are used successively only for zh, ch and sh. “y” or “w” is used in romanization of a Chinese syllable consisting of only finals without an initial. For example, entries are given as [symbol] =yi (first pitch of tone)” and [symbol] =wu (third pitch of tone)”. It is understood that one syllable in Chinese consists of at least “consonant+vowel” in Roman character in romanization (using Roman alphabets).

As mentioned in the prior document of the applicant, it is more convenient to use the syllable-base initial code as a simple code in Chinese in which one character constitutes one syllable. Thus 18 Roman alphabet consonants are preferably assigned to the individual numeral buttons. The present invention suggests that 18 Roman alphabet consonants are sorted in groups of two and assigned to numeral buttons [1] to [9].

bp/dt/gk/zj/cq/sx/mn/lr/hf

The above example shows the grouping of Roman alphabet consonants based on the similarity of pronunciation so that multiple words or phrases similar in pronunciation have the same syllable-based initial code when the words or phrases correspond to the same simple code. The grouping is given by way of example and various modifications are available. Grouping may be based on the dictionary order of Roman characters, the dictionary order of commented sounds corresponding to Roman characters, or other groupings including the similarity of pronunciation. Another advantage of the grouping based on the similarity of pronunciation is reducing ambiguity, because consonants of a similar pronunciation seldom appear in succession in any language using the Roman alphabet. Besides, even though there are multiple words or phrases corresponding to the same simple code (especially syllable-based initial code), they are similar in pronunciation (phonetic value) and such a grouping method minimizes confusion to uses and make the use of simple codes natural.

“zh”, “ch” and “sh” are initials in Chinese characters, and “z” and “h”, “c” and “h” or “s” and “h” are not sorted in the same group. (It is not so important not to be grouped in the same group, because a Chinese syllable generally consists of an initial and a final. But for the input of “w”, ”y” or “v”, it is not desirable that “s”, “h” and “w” is grouped in one group and “w” is input with three strokes of the corresponding button) The nine groups are assigned to nine buttons [1] to [9], as shown in FIG. 10-1, and the individual characters are entered using the repeat selection method. As the feature of Chinese, Roman alphabet consonants seldom appear in succession in entering initials, except for the case of “zh”, “ch” and “sh”. It is therefore possible to enter Roman characters without ambiguity applying the Repeat Selection Method. For example, entries are given as “b=[1]” and “p=[1]+[1]” in FIG. 10-1. Of course, the most frequently used character among those assigned to a same button can be ordered to be selected with one stroke of the corresponding button.

Roman character “v” seldom used in Chinese can be assigned to one of the nine groups. For example, “v” is added to the group including “f” similar in pronunciation to “v” (or not arranged specifically) and entered with three strokes of the corresponding button. “w” and “y” used in [symbol] =yi (first pitch of tone)” or “ [symbol] =wu (third pitch of tone)” can also be sorted in a proper consonant group (or not arranged specifically) and entered by the repeat selection method (e.g., with three strokes of the corresponding button). For example, when “y” is allocated to a group including /l, r/, “l”, “r”, “y” are entered with one stroke, two strokes and three strokes of the corresponding button (button [8] in FIG. 10-1), respectively. When “w” is allocated to a group including /m, n/, “m”, “n”, “w” are entered with one stroke, two strokes and three strokes of the corresponding button (button [7] in FIG. 10-1), respectively.

The method of using the repeated appearance of a Roman alphabet consonant and vowel to remarkably reduce ambiguity in the romanization system using the repeat selection method is called “Chinese Restricted Repeat Selection Method (CRRSM)”. Expediently, this method applied to any language including the Chinese language is called “Language Restricted Repeat Selection Method (LRRSM) and the method specifically applied to the Chinese language is called “Chinese Restricted RSM”. The LRRSM for Korean or Hindi reduces ambiguity on the basis that consonants and vowels appear alternately, as in the case of using the repeat selection method with pairs of basic consonant and basic vowel assigned to the individual buttons. Likewise, in the method of using vowel elements in Korean, the aspirated control is selected by the repeat selection method using the principle that vowel [symbol] does not appear in succession. This is can be called “Korean Restricted RSM”.

Particularly, when the buttons assigned to consonants (expediently, referred to as “consonant buttons”) are separated from the buttons assigned to vowels (expediently, referred to as “vowel buttons”) as in FIGS. 10-1 to 10-4, the use of the repeat selection method can remarkably reduce ambiguity using the feature of each language such that consonants and vowels are combined together. The keypad of FIGS. 10-1 to 10-4 that has a small number (e.g., one, two or three) of consonants or vowels assigned to each button and consonant buttons being separated from vowel buttons is called “Consonant-Vowel Separated Keypad (CVSK).

Roman alphabet consonants and vowels in romanization of Chinese as marked on the keypad of FIG. 10-1 can also be entered without ambiguity by using the repeat selection method. When the user selects one of the consonant buttons (buttons [1] to [9] in FIG. 10-1) in succession to enter an initial, the system recognizes that the second consonant marked on the keypad is entered. This is because there is no case where the same Roman character does not appear in succession in the entry of initials in Chinese. When the button previously stroked twice is assigned to “w”, “y” and “v”, the system readily recognizes that another one stroke of the button (namely, three strokes in total) is for entering “w”, “y” or “v”, as previously described. The system may interpret three strokes of button [7] for entry of “w=777”, because there is no construction of initials like “mmm”, “mn”, or “nm” in Chinese.

As shown in FIG. 10-1, six vowels “a”, “e”, “i”, “o”, “u” and “\ddot{}u” are sorted in three groups of two and assigned to three buttons (e.g., buttons [*], [0] and [#]) of the 4*3 keypad. The individual vowels are then entered without ambiguity using the Repeat Selection Method, which is possible because the same Roman alphabet vowel in Chinese seldom appears twice in succession. For example, there is no case that the romanization of a Chinese character represents “...aa...”.

For double finals “ai” and “ei” and compound finals “ia” and “ie”, “a” and “i”, or “e” and “i” are not to be sorted in the same group. If “a” and “i” are sorted in the same group and assigned to the same button (e.g., button [*]), three strokes of the button (i.e., “***”) may cause ambiguity between “ai” and “ia”. FIG. 10-1 shows an example of grouping in consideration of this case. The vowel grouping and arrangement are not specifically limited to those of FIG. 10-1 and may be variously modified as long as they satisfy the above restriction. The individual vowels can be entered using the Repeat Selection Method in FIG. 10-1. For example, entries are given as “i=[0]”, “o=[0]+[0]”, and “iao=[0]+[*]+[0]+[0]”.

For double finals “ai”, “ei”, and “ou” and compound finals “ia”, “ie”, and “uo”, “a” and “i”, “e” and “i”, and “o” and “u” are not to be sorted in the same group. When “a” and “i” are sorted in the same group and assigned to the same button (e.g., button [*]), three strokes of the button (i.e., “***”) may cause ambiguity between “ai” and “ia”. FIG. 10-1 shows an example of grouping in consideration of this case. The vowel grouping and arrangement are not specifically limited to those of FIG. 10-1 and may be variously modified as long as they satisfy the above restriction. The individual vowels may be entered using the Repeat Selection Method in FIG. 10-1. For example, entries are given as “i=[0]”, “o=[0]+[0]”, and “iao=[0]+[*]+[0]+[0]”.

For example, as long as “a” and “i” are not classified into the same group, and likewise for “e” and “i” as well as “o” and “u”, “a, e, o” are classified into one group (refer to FIG. 10-2 and FIG. 10-4) and “i, u, ü” are classified into another group. Various modifications are also possible. These 2 vowel groups may be individually assigned to particular buttons (e.g., [*] and [#] buttons respectively), and consonants “w, y, v” may be another group and be assigned to another button (e.g., [0] button). When 3 characters are grouped into one vowel group (e.g., “a, e, o”) and the group is assigned to a button, the vowel “o” may be recognized with 3 strokes of the button without ambiguity because “ae”, “ea”, and “aaa” which is recognized by 3 strokes of the corresponding button does not exist in Chinese finals. In this example, “ao” is input by 4 strokes of the button to which the characters are assigned without ambiguity because there is no “oa” in Chinese finals. Refer to FIG. 10-6. In the FIG. 10-6, the character “v” may not be marked on the keypad because “v” is not used for inputting Chinese. Grouping (i.e., sorting) “w, y” into one group and assigning to a button means grouping semi-consonants (i.e., semi-vowels) into one group and assigning to a button.

In the FIGS. 10-2, 10-4, and 10-6, when “a, e, o” are grouped into the same group, only the vowel combination “ao” exists in Chinese Romanization (pinyin). When only “a, o” are grouped into one group and assigned to a button, 3 strokes of the corresponding button are recognized as “ao” without ambiguity. When 3 characters (i.e., “a, o, e”) are assigned to a button and each character is selected according to the presses (i.e., strokes) of the button in the order “a-o-e”, 3 strokes of the button are recognized as both “ao” and “e”, so ambiguity occurs. Thus in the case that 3 or more than 3 characters are assigned to a button and only one combination of 2 characters is possible, the characters are recognized without ambiguity by setting the selection order of the 2 characters which forms a possible combination as I stroke (i.e., one press) and 3 strokes of the corresponding button respectively, not as 1 stroke and 2 strokes respectively. It is also applicable to set the 2 characters which form a possible combination as 2 strokes and 3 strokes respectively, and in this case “ao” is recognized by 5 strokes of the corresponding button without ambiguity. That is, in setting the selection order of assigned characters by strokes of a corresponding button, the selection order of the characters which appear in succession with 1 stroke and 2 strokes of the button should not be set.

In FIGS. 10-1˜10-4, when an initial is input by Romanization of Chinese, the same button is pressed 2˜3 times, and the system recognizes a target character by sensing presses of the button. When a final is input by Romanization of Chinese, in FIGS. 10-1˜10-3, a case in which a button is pressed 3 times is the case in which the [0] button is pressed 3 times for inputting “io” of the Chinese compound final “iou”. The system temporarily recognizes “0” as “i”, and then when a button other than the [0] button is pressed, the system confirms recognition of “0” as “i”. When the [0] button is pressed once more, the system temporarily recognizes “00” as “o”, and then when a button other than the [0] button is pressed, the system confirms recognition of “00” as “o”. When the [0] button is pressed once more, the system confirms recognition of “000” as “io”. Because Chinese is restricted such that there is no case of “oi”, the [*] button is pressed twice at most, thus the system temporarily recognizes “*” as “a”, and confirms recognition of “**” as “e” as shown in FIGS. 10-1 and 10-3. Because the same Roman vowel does not appear in succession in Romanization of Chinese, and the vowels in the same button does not appear in succession.

The character input system may be implemented without ambiguity in Chinese (or with far less ambiguity in a language other than Chinese), because the system recognizes that a certain consonant of consonants of a corresponding consonant button is being input while the consonant button (e.g., [1] button in FIG. 10-1) is being pressed once or more, and then when another consonant button (e.g., [9] button in FIG. 10-1) is pressed, the system recognizes that consonants which are assigned to the first button and the second button are being input in succession. Another reason is that about 2 characters are assigned to each button, rather than 3. According to a prior document of the applicant, when a consonant and a vowel are grouped into one group, 2 characters are assigned to each button, and ambiguity is substantially reduced relative to the case in which 3 characters are assigned to each button. “Successive Stroke Delay Time (SSDT)” and “Discrete Stroke Delay Time (DSDT)” which are proposed by the applicant are effectively applicable when 2 characters are assigned to each button.

FIG. 10-7 excepting the (R) steps explains the general flow of the Repeat Selection Method in a Consonant-Vowel Separated Keypad (CVSK). Input values are assumed to be only consonant buttons or vowel buttons in FIG. 10-7. It is assumed that there is no special purpose or function button (e.g., succession control button for inputting succession characters). FIG. 10-7 is not absolute, but it may be referenced. A detailed flow in which a stroke of a button is interpreted as a first character of the corresponding button is not described precisely, but this process is performed in the step (R0) in FIG. 10-7. Language restriction is considered in the (R) steps, and the (R) steps may intrude in certain processes (i.e., steps). When a first input value is a button among consonant buttons, only 2 characters are assigned to the button, and the characters which are assigned to the button do not appear in succession (e.g., [1] button in FIG. 10-1), so the system confirms recognition of the input values as those of a consonant (e.g., “P” in FIG. 10-1) in step (R1) when the button is pressed twice consecutively. This is similar to the case of eliminating ambiguity (i.e., the case of confirming a target character without ambiguity or with less ambiguity in RSM) in FIG. 4-1 by applying language restriction. The flow of FIG. 10-7 is far simpler than that of FIG. 4-4.

When the same consonant button or other consonant buttons are pressed consecutively and then a vowel button is pressed, the system may confirm target character(s) from the input value and then proceed to the vowel process. The first input value of the vowel process is the last input button in the consonant process. This is the same as the case of transition from the vowel process to the consonant process.

In FIG. 10-7, recognizing characters while applying language restriction (R) is possible with the index of possible combinations (e.g., “ch”, “sh”, “zh”, “iao”, “iou”, “ia”, “ie”, “uai”, “uei”, “ua”, “uo”, “ue”, “ai”, “ao”, “ua”, “uo”, “..ue”, “ou” ...) of consonants and vowels or with the index of non-possible combinations (e.g., “bb”, “aa”, “ee”, “oa”, ...) of consonants and vowels (on the specipic keypad). When ambiguity occurs from the input values, the system recognizes a target character by excluding non-possible combinations. For example, in FIG. 10-2 (to which Chinese restriction is applied), the system stores “ao” in the index of possible combination of vowels, and then when “0000” is input for “ao”, the system recognizes “0000” as “ao”. Another example is that the [0] button is pressed 4 times at most without any mis-inputs in FIG. 10-2 and FIG. 10-4, and the system recognizes “0000” as “ao” by considering this specific keypad. The rest of the processes is performed according to FIG. 10-7.

In FIG. 10-7, the omitted processes are similar to the described processes. The more generalized form of FIG. 10-7 without the omitted processes is FIG. 10-8, which is substantially the same as FIG. 10-7. In FIG. 10-8, (1) means virtual input of a button and “n<-(n+1)” which is marked on the arrow directed to (1) means that a button is pressed once more.

In FIG. 10-1 of the above content, the individual Roman character can be entered with 1.5 stroke of the corresponding button on average. Considering the use frequency in Chinese, the frequently used characters can be entered with one stroke of the corresponding button to minimize the number of strokes for the entry of each character.

12.1.4 Reactivation of Original Function of Functional Button Used as Control Button

For the entry of an affixed character of a Roman alphabet vowel with a superior in FIG. 10-1, a “separate button” out of the 3*4 keypad can be used as a control button. For example, the left cursor button [<] in the Chinese input mode can be used to enter as “⁻e=e+[<]”, “´e=e+[<]+[<]”, “^{v}e=e+[<]+[<]+[<]”, “`e=e+[<]+[<]+[<]+[<]”, and “ˆe=e+[<]+[<]+[<]+[<]+[<]”. Five strokes of the left cursor button in succession cannot select a control associated with “e”, so that the moving function of the button is activated (“e” is already entered). The delete button (expediently, denoted as “[X]”) can be used as a control button for the input of an affixed character as “⁻e=e+[X]”, “´e=e+[X]+[X]”, “^{v}e=e+[X]+[X]+[X]”, “`e=e+[X]+[X]+[X]+[X]”, and “ˆe=e+[X]+[X]+[X]+[X]+[X]”. Five strokes of the delete button in succession may delete the previously input “e”. In this manner, a button of another function can be used as a control button to its original function (e.g., moving function) is reactivated when no control is selected after the selection of the control according to the number of strokes of the control button.

With the moving function of the left cursor button reactivated in the above example, no more than one stroke of the left cursor button [<] activates the left moving function. That is, five strokes of the button [<] after the input of “se” makes the cursor move to the left side by one space from “e”, and another stroke of the button [<] moves the cursor to the left side by one space. The same is applied to every language.

12.1.5 Chinese Restricted RSM in Consonant-Vowel Separated Keypad (Including Entry of Affixed Character on 3*4 Keypad)

Now, a description will be given as to the entry of an affixed character of a Roman alphabet vowel with a superior (e.g., a tone symbol) on the 3*4 keypad.

In the compound final table, the vowels that cannot appear next to “i” are “i” and “u” (in other words, “a”, “e” or “o” appears after “i”). The vowels that cannot appear next to “u” are “u” and “i” (in other words, “a”, “e” or “o” appears after “u”). Thus the vowel arrangement of FIG. 10-2 is available. To affix a tone symbol to the vowel “i”, “a” or “e” on the left side of FIG. 10-2, the button [#] for the vowel “u” on the right side is used as a control button. Likewise, the button [*] on the left side is used as a tone symbol control button to affix a tone symbol to the vowel “o” or “u” on the right side. For example, entries are given as “´o (second pitch of tone)=o+[*]+[*]=[0]+[0]+[0]+[*]+[*]”, “´a (second pitch of tone)=a+[#]+[#]=[0]+[#]+[#]”, and “ˆe=e+[#]+[#]+[#]+[#]+[#]=[0]+[0]+[#]+[#]+[#]+[#]+[#]”. The entry of a double final “ao” is given as “ao=a+o=[0]+[0]+[0]+[0]”. The system readily recognizes this without ambiguity, because the vowel “a” or “e” does not appear next to “a” and there is no case of “oa”. The vowel “\ddot{}u” similar in shape to vowel “u” can be entered with two strokes of the button for “u” (by the Hiding Repeat Selection Method).

This is based on the feature of the Chinese language that the vowel “u” does not appear next to the vowel “a” or “e” and that the vowel “i” does not appear next to the vowel “o”. It is impossible to use the buttons allocated to the vowels as a control button as in FIG. 10-2 using the Roman alphabet vowel coupling rules of the Chinese language under the above-stated restriction that “a” and “i”, or “e” and “i”, or “o” and “u” are not sorted in the same group and that two vowels are assigned to each three buttons. The reason that “i” and “u” are assigned to the button [*] or [#] in FIG. 10-2 is for the user to readily recognize the use of the button as a control button and to take the balance of arrangement into consideration. The average number of strokes for vowels in FIG. 10-2 is about 1.5 as in FIG. 10-1.

In a modified example of FIG. 10-2, some of the three characters assigned to the button [0] can be designated as a “separate button” out of the 4*3 keypad. For example, any one of the up, down or left move button can be used for the allocation of some of the three characters separately.

Romanization is achievable without ambiguity using the Repeat Selection Method in FIGS. 10-1 to 10-4, because the consonant buttons [1] to [9] are separated from the vowel buttons [*], [0] and [#], and the romanization of Chinese characters follows the consonant and vowel appearance rules of the Roman alphabet.

12.2 English Restricted RSM on Consonant-Vowel Separated Keypad

Like the Chinese language, English can be entered with less ambiguity using the repeat selection method on a Consonant-Vowel Separated Keypad (CVSK) shown in FIGS. 10-1 to 10-4. This is because the words of every language using the Roman alphabets consist of consonants and vowels that alternately appear.

For English, the utmost repetition of consonants from the “start of word” can be expressed as “CCCCVCCCC” (e.g., “strengths”), where C represents a consonant and V represents a vowel. At most three consonants can appear at the start of word, which case is restricted to “st˜” or “sp˜” (e.g., spree, spleen, strength, etc.).

As in FIG. 10-1, when the user enters “622˜” to input an English word “student” on the keypad containing about two or three consonants (expediently, supposing that only “ü” is not arranged in FIG. 10-1), the system recognizes “622” entered after the “start of word” as “st” rather than “sdd” (because the case that three consonants appear in succession in an English word is restricted to “st˜” or “sp˜” and the system has to remind such an English word production rule or a character coupling rule). The button for a corresponding vowel is chosen in entering “u” of “stu˜”, so that the system recognizes that the vowel (e.g., “u”) appears after the consonant group (e.g., “st”). Upon the user entering “2” to input “d” after the entry of “stu”, the system recognizes that the consonant appears. Likewise, when the user enters “˜**7722” to input “˜ent” of “student”, the system recognizes that “e” rather than “aa” is entered upon the user's entering “**”, because “a” does not appear in succession in English as previously described in the prior document. Though “7722” may be interpreted as “mmt”, “ndd”, “nt” or “mmdd”, ambiguity caused by the repeat selection method can be remarkably reduced by determining the “Successive Stroke Delay Time” and the “Discrete Stroke Delay Time” differently, as described in the prior document.

On the current standard English keypad (FIG. 11) in which a combination of consonants and vowels is assigned to each button, ambiguity caused by the repeat selection method can be reduced by considering the word production rules (character coupling rules) of a specific language. It is however difficult to apply the language restricted input method (especially, using the repeat selection method as the Full Input Method) in the case that a combination of consonants and vowels is assigned to a single button. For example, when the user enters “student” using the repeat selection method in FIG. 1-1, “stu˜” is “777888˜” and the system cannot judge whether “888” next to “777” recognized as “s” is “ut (i.e., sut)”, “tu (i.e., stu)”, or “v (i.e., sv)” (of course, the system can consider that “888” is not “ttt”, because “ttt” cannot appear next to “s” in the English restricted input method). Likewise, when the user enters “333” to input “˜de˜”, ambiguity occurs between “de” and “ed” and the system can consider “888777” entered before “˜de˜” as “sut”, “stu” or “sv”. So in three cases, the system may consider “333” as “˜de˜” or “˜ed˜”.

As such, ambiguity occurs in the repeat selection method used as the full input method even when using the language restricted input method, since the system cannot clearly determine whether the input value is to enter a consonant or a vowel, in the use of the consonant and vowel appearance rules (i.e., word production rule and character coupling rule) in the language restricted input method. In case where consonants are assigned separately from vowels as in FIGS. 10-1 to 10-4, the system recognizes the stroke of the button allocated to a vowel as the input of the vowel and the stroke of the button allocated to a consonant as the input of the consonant in the repeat selection method, thereby remarkably reducing ambiguity.

At least two vowels appear in succession often in English using Roman alphabets (for example, “ai” in “captain”). In actual words, there are relatively many cases where the same vowel (basic vowels “a”, “e”, “i”, “o” and “u”) appears in succession as “oo” or “ee” of “food” or “teen”. But “uu” (e.g., “vacuum”) rarely appears. The applicant have never found out a word like “...aa...” or “...ii...” or in the English dictionary. Accordingly, ambiguity can be avoided in many cases by assigning five English basic vowels to button [*], [0] or [#] to select “a” with one stroke and one of “e”, “o” and “u” with two strokes. For example, when the vowels “a” and “o” are assigned to the button [*] in the repeat selection method, the system considers two strokes of the button [*] as the entry of vowel “o” rather than two vowels “aa”. Likewise, when “i” and “u” are assigned to the button [0] in the repeat selection method, the system considers two strokes of the button [0] as the entry of vowel “u” rather than two vowels “ii”. Even though it is not absolute that there is no case of “aa” or “ii” in actual words, ambiguity is nearly eliminated by determining the “Successive Stroke Delay Time” and the “Discrete Stroke Delay Time” differently as described in the prior document. The other vowel “e” is assigned to the button [#] and selected with one stroke of the button.

To utilize one of the buttons [*], [0] and [#] as a button for a special use, the user has only to assign the vowel “e” to a certain button for the vowel. For example, “i”, “e” or “u” can be assigned to the button [0]. The vowel “u” is selected with three strokes of button [0], because it is the least frequently used vowel in English. Finally, ambiguity hardly occurs between the vowels “i” and “e” (with one stroke and two strokes, respectively) when “i”, “e” and “u” are assigned to the button [0] and the vowel “i” does not appear in succession (i.e., “...ii...”) in English. But ambiguity occurs among “u”, “ie” and “ei” when the vowel “u” is entered with three strokes of the button [0]. This case rarely occurs because of the low use frequency of the vowel “u”.

Thus ambiguity can be remarkably reduced using the consonant-vowel separated keypad. Moreover, almost no ambiguity occurs in entering vowels with a button allocated to multiple vowels by selecting the vowel not appearing in succession in English words existing in the dictionary with one stroke of the button.

The same is applied to the keypad in which about two or three consonants are assigned to each button, as in the case where the vowel not appearing in succession is selected with one stroke of a corresponding button and the least frequently used vowel is entered with three strokes of the button.

Though the above description exemplified English using Roman characters, the same is applied to the other languages using Roman characters.

12.3 Indonesian Restricted RSM on Consonant-Vowel Separated Keypad

Indonesian also used Roman characters (English characters) in the notation of words. Indonesian syllables are constructed as follows (where C represents a consonant and V represents a vowel).

V: be-a (tariff)

VC: am-bil (catch)

CV : go-sok (rub)

CVC: pon-dol (hut)

CCV : tra-di-si (tradition)

CCVC: con-trak (contract)

CVCC: teks-tur (textile)

CCCV: kon-struk-si (construction)

CCCVC : strip-tis (striptease)

As can be seen from the above words, the words containing three or more consonants are foreign words originated from English words. Thus it is assumed that three or more consonants do not appear in succession in the start of the word, excepting the words such as “st˜” or “sp˜” in Indonesian. The Indonesian restricted repeat selection method can be applied using the word production rule (character coupling rule).

“q” and “x” are used for scientific symbols such as physics or mathematics and are rarely used for character input. So “q” and “x” may not be arranged in a specific button group and can be entered with three strokes of a corresponding button. Similar to the Chinese language, the sounds of the Indonesian language can be spelled out with a combination of two or more Roman characters, including “ny”, “sy”, “kh” and “ng”.

Groups of consonants which are not separated into syllables are “bl”, “br”, “dr”, “dw”, “dy”, “fl”, “fr”, “gl”, “kr”, “ks”, “kw”, “pl”, “ps”, “rps”, “rs”, “sk”, “skr”, “sl”, “sp”, “spr”, “sr”, “str”, “sw”, etc. In particular, “skr˜”, “spr˜”, “str˜” appear at the beginning of words, and they are used as criteria for recognizing whether input values are full code or simple code in the Language Restricted CIM, which will be described later. (Even though the applicant does not know whether “rps” appears at the beginning of a word or not, if it may be at the beginning of a word, it may be a criterion for judging whether input values are full code or simple code.)

Any method for grouping 19 consonants other than “q” and “x” among 21 English alphabet consonants into nine groups is applied. But the grouping has to take the feature of the Indonesian language into consideration. For example, the grouping may be given as follows:

BP/DT/GK/CJ/MN/LR/SZ/FV/HWY

“q” and “x” can be arranged in proper groups. For example, “q” is included in “GK” group and “x” is included in “SZ” group.

Five vowels “a”, “i”, “u”, “e”, and “o” are used in the notation of Indonesian vowels. There are three double vowels “ai”, “au” and “oi”, among which “oi” is rarely used. It is therefore preferable that “a” and “i”, or “a” and “u” are not arranged in the same group in sorting the five vowels into two or three groups. For example, the grouping is done as ae/uo/i. As in the case of English, the vowels not appearing in succession (or less frequently used in succession) are preferably selected with one stroke of the corresponding button in the individual group.

12.4 Japanese Restricted RSM on Consonant-Vowel Separated Keypad

It is a widely used Japanese input method that enters the sounds of the Japanese language using Roman characters and converting them into Japanese. Thus Roman characters on the consonant-vowel separated keypad as shown in FIGS. 10-1 to 10-4 can be used to input the sounds of the Japanese language and to convert them to Japanese. [symbol] are transcribed as a, i, u, e, and o, respectively. [symbol] are transcribed as na, ni, nu, ne, and no, respectively. The other characters can be transcribed in a combination of Roman alphabet consonants and vowels.

In Japanese, it is when a Soku-on sound or a You-on sound (marked in small letter) is used that Roman alphabet consonants appear twice in succession. Supposing that a combination of [symbol] rarely appears in succession in words containing Roman alphabet vowels in succession, such a successive appearance of at most two or three Roman alphabet vowels is very rare. Accordingly, the five Roman alphabet vowels “a”, “i”, “u”, “e” and “o” are sorted in three groups as in FIGS. 10-1 to 10-4 and assigned to three buttons. In this case, the entry of vowels by the repeat selection method rarely cause ambiguity. For Japanese, the input of “a” corresponds to [symbol] and the input of “na” corresponds to [symbol] (the same is applied to the other Japanese characters). So the system provides [symbol] the moment it recognizes the input value of “na” entered by the user.

There are 14 Roman alphabet consonants that are used for romanization of Japanese characters in the 50-character table, including k, s, t, n, h, m, y, r, w, g, z, d, b, and p. For You-on sounds, a combination of two Roman alphabet consonants (e.g., “cha” or “sha”), a combination of “y” (e.g., “kya”), or “j” is used for the notation. Roman alphabet consonants appear two or more times in succession in the case of ch, sh, ky, ny, hy, my, ry, gy, py or py, and using Soku-on sounds. When using Soku-on sounds, there are cases where the same alphabet among k, s, t, and p appears in succession (e.g., “ippai”). Thus the 16 Roman alphabet consonants (14 consonants+c and j) are indispensable in the entry of Japanese characters. The Consonant-Vowel Separated Keypad can be constructed to make the entry of those consonants easier. The other five Roman alphabet consonants f, l, q, v, and x are also needed for the entry of English, but the 16 Roman alphabet consonants are mainly grouped. For example, the grouping may be achieved as follows:

BP/DT/GK/CJ/H/MN/R/SZ/YW/ => in nine groups
BP/DT/GK/CJ/H/MN/Y/SZ/RW/ => in nine groups
BP/DT/GK/CJ/HR/MN/SZ/YW/ => in eight groups

The five Roman alphabet consonants necessary for the entry of English can be properly added to the individual groups as in the case of Chinese. In the example of grouping the Roman alphabet consonants in eight groups, the other 4 buttons on the 3*4 keypad are used as a vowel button and, if using only three vowel buttons, the other one button is used for the consonants necessary for the entry of English.

12.5 Intentional Cancellation of Language Restriction

LRRSM is applied at the expense of the advantage of FIM that enables the entry of all words irrespective of the existence of the words in the dictionary. It is therefore preferable that the user is allowed to determine to use language restriction or not. But even in the “language restricted input mode” that enables the language restricted input method, the user who intends to enter a word not present in the dictionary and infringing the word production rules (character coupling rules) has to input a specific function (for example, space, left move or word ending) after the input of a basic character to intentionally confirm the target character and enter the next character. This makes it possible to enter all possible combinations of character. For example, when the user enters “622˜” in the English restricted input mode” in FIG. 10-1, the system recognizes the input value as “st˜” rather than “sdd˜”. To enter “sdd˜”, the user has only to enter “62”, a space or left move function, and then “2”, or to enter “62”, a certain means for activating “word end function (e.g., a control to end the word)”, and then “2”. If the word end function is activated after the input of “62”, the system considers the next input of “2” as “d” because “2” is the first input after the “start of word”. Such an intentional input of the word end function to overcome language restriction in a specific Language Restricted Input Mode is called “intentional cancellation of language restriction” The example of “sdd˜” is the “intentional cancellation of English restriction”.

Likewise, to enter “ui” that is a combination of consonants present in English rather than in the romanization system of Chinese in the Chinese Restricted Input Mode (applying the Chinese Restricted RSM) in FIG. 10-2, the user has only to enter “u”, a means for ending the word (as mentioned above) and then “i”. Otherwise, when the user selects the button allocated for “i” after the input of “u” in the Chinese restricted input mode (using the Chinese restricted RSM) in FIG. 10-2, the affixed character of “u” is entered as described in the prior document (e.g., if the system is set to consider a character with a tone symbol added to “u” or a character (i.e., “\ddot{}u”) with “..” added to the top of “u” as the affixed character of “u”) (because the button for “i” entered after the input of vowel “u” or “o” is used as a control button in the Chinese Restricted RSM). Thus the user can enter any word not present in the romanization system of Chinese (e.g., all combinations of alphabet such as English words) in the Chinese restricted input mode. In other words, the user who mainly uses the Chinese language can enter all the combinations of characters not present in Chinese in the Chinese restricted input mode (e.g., the mode using Chinese Restricted RSM) without a change of the mode. This corresponds to the “intentional cancellation of Chinese restriction”.

The same is applied to the entry of a consonant or a vowel as a single character in the method using three vowel elements in Korean. For example, to enter consonant [symbol] and vowel [symbol] as a single character in FIG. 4-5, the user has to select button [1] in the “start of word” state, a means for the word end function, and then button [*] in the “start of word” state again. Successive strokes of buttons [1] and [*] provides [symbol] In the standard keyboard (i.e., standard English and Korean keyboard), a stroke of the right cursor button activates the word end function instead of entering a space. The same is applied to the present invention if the right cursor button is added.

12.6 Delay Time For Cancellation of Language Restriction

The “Successive Stroke Delay Time” and the “Discrete Stroke Delay Time” are applied in the case where three or more characters are assigned to one button. For example, when the successive stroke delay time is set to 0.1 second in the standard English keypad of FIG. 1-1, the system considers two successive strokes of button [2] within 0.1 second as “B”.

Likewise, the system recognizes the entry of “C” when button [2] is selected three times in succession (i.e., [2]+[2]+[2]) and the delay time interval between the first and second input values (i.e., the first and second strokes of button [2]) is less than the predetermined time (e.g., 0.1 second), the delay time interval between the second and third input values being less than the predetermined time (e.g., 0.1 second) (i.e., [2]+less than 0.1 second+[2]+less than 0.1 second+[2]). The system can be set to recognize the entry of “C” when button [2] is selected three times in succession (i.e., [2]+[2]+[2]) and the total delay time is less than double the successive stroke delay time (e.g., 0.2 second).

For English, if “\ddot{}u” is not present in FIG. 10-1 and the rule that vowel “a” or “i” does not appear in succession in English words is strictly applied, the user can enter an abbreviated word such as “NII” in the English restricted repeat selection mode through “intentional cancellation of English restriction” by activating the word end function. But the entry of “NI” can be confirmed without activating the word end function at the end of a predetermined time after the input of “NI”. The predetermined time may be the same as the “discrete stroke delay time” as mentioned in the prior document and is preferably longer than the “discrete stroke delay time”. For example, the input of “NI” is confirmed without activation of the word end function at the end of 2 seconds after the input of “NI” and the system returns to the “start of word” state. This delay time is called “Delay Time for Temporary Cancellation of Language Restriction (DTTCLR)” and is preferably set by the user. Evidently, the same is applied to every language.

The delay times can be summarized as follows:

Successive Stroke Delay Time (SSDT)≦Discrete Stroke Delay Time (DSDT)≦Delay Time for Temporary Cancellation of Language Restriction (DTTCLR)

The three delay times may be set to be the same. Preferably, the discrete stroke delay time is longer than the successive stroke delay time and the delay time for temporary cancellation of language restriction is longer than the discrete stroke delay time.

12.7 Portuguese Resctricted RSM in CVSK

In Portuguese, “k”, “w”, and “y” are used in abbreviations or foreign languages, but they may be needed for inputting text. Some compound consonants in Portuguese are as follows.

bl, cl, dl, fl, gl, pl, tl
br, cr, dr, fr, gr, pr, tr, vr

Additional compound consonants are “gn”, “mn”, “pn”, “ps”, “pt”, “tm”, “ch”, “lh”, “nh”, “rr”, and “ss”. Thus, when configuring CVSK for the Portuguese Restricted Input Method, it is preferable that the characters which appear consecutively are not grouped into a group. For example, FIG. 10-* are referenced. Even though “m” and “n” are grouped into one group in FIG. 10-*, this may be modified. The examples of keypads in FIG. 10-* may be applied to other languages as well as Chinese because the characters are grouped on the basis of similarity of pronunciation (i.e., voiced sound character and unvoiced sound character which have simliar pronunciation are grouped into one group—e.g., /b p/, /d t/, /g k/, ...), and it is rare that the characters which have similar pronunciation appear consecutively in most languages.

There are 5 basic vowels “a”, “e”, “i”, “o”, and “u” in Portuguese. “a”, “e”, and “o” are strong vowels and “i” and “e” are weak vowels. There are 6 cases of combination of 2 successive different vowels (i.e., “ai”, “au”, “ei”, “eu”, “oi”, and “ou”) in which the combination consists of “a strong vowel+a weak vowel” and 1 case (i.e., “ui”) in which the combination consists of “a weak vowel+a weak vowel”. Therefore the strong vowel group and the weak vowel group are classified separately (e.g., the keypad in which “..+u” is eleminated from FIG. 10-6). Every other classification into several groups is available as long as the strong vowel group and the weak vowel group are classified separately. For example, vowels are grouped as “/a/, /e o/, and /u i/”.

12.8 Spanish Resctricted RSM in CVSK

There is a “˜+n” character (the character with ‘˜’ affixed on the head of ‘n’) in Spanish. The affixed character “˜+n” does not exist in English. “k” and “w” are used only for foreign language in Spanish, but they are needed for inputting text. Some compound consonants in Spanish are as follows.

bl, cl, dl, fl, gl, pl
br, cr, dr, fr, gr, pr, tr

Thus, for the configuration of CVSK for the Spanish Restricted Input Method, it is preferable that “l” and “r” is not grouped in the same group and the consonants which appears consecutively is not grouped in the same group. The classification of consonants in FIG. 10-1˜FIG. 10-4 and FIG. 10-6 are referenced.

There are 5 basic vowels “a”, “e”, “i”, “o”, and “u” in Spanish. “a”, “e”, and “o” are strong vowels and “i” and “e” are weak vowels. There are 6 cases of combination of 2 successive different vowels which consist of “strong vowel+weak vowel”, 6 cases which consist of “a weak vowel+a strong vowel”, and 2 cases (i.e., “iu” and “ui”) which consist of “a weak vowel+a weak vowel”. Triple vowels consist of “a weak vowel+a strong vowel+a weak vowel”. Therefore the strong vowel group and the weak vowel group are classified separately (e.g., the keypad in which “..+u” is eleminated from FIG. 10-6). Ambiguity occurs during the entry of a compound vowel which consists of “weak vowel+weak vowel”. In the case of “iu” and “ui”, ambiguity may be overcome by using Successive Stroke Delay Time (SSDT), Discrete Stroke Delay Time (DSDT), Intentional Cancelation of Language Restriction, and other methods which the applicant proposes. They are also applicable when the same consonant appears consecutively, the same vowel appears consecutively, and for other cases in which ambiguity occurs.

12.9 Italian Resctricted RSM in CVSK

In Italian, “j”, “k”, “w”, “x”, and “y” are used only for old Italian and foreign languages. They are also needed for the entry of English. The consonants excepting these 5 consonants are regarded as main consonants and they are classified into groups, and these 5 consonants are additionally and properly classified into groups.

Double vowels in Italian are “ia”, “io”, “ie”, “iu”, “ai”, “ei”, “oi”, “ui”, “uo”, “ou”, “eu”, etc. Excepting “iu” and “ui”, these double vowels are the combination of a strong vowel (i.e., a vowel from “a”, “e”, and “o”) and a weak vowels (i.e., a vowel from “u” and “i”). Triple vowels are also structured as a combination of “a weak vowel+a strong vowel+a weak vowel”. Thus, classifying vowels into one group of strong vowels and another group of weak vowels is possible, for example, /a e o/ and /u i/. Ambiguity occurs in the case of “ui” and “iu”.

12.10 German Restricted RSM in CVSK

Compound consonants in German are “ch”, “chs”, “ck”, “ds”, “dt”, “ng”, “nk”, “pf”, “ph”, “sch”, “sp”, “st”, “th”, “ts”, “tz”, “tsch”, etc. To make sure consonants which appear consecutively are not classified into the same group, the grouping in FIG. 10-* is referenced. “sch˜” is a case in which 3 consonants appear at the beginning of a word in German, and it may be used for the criteria in “Language Restricted CIM”. “tsch” may also appear on the beginning of a word, but it is rare.

In German, there are 5 short sound vowels, and there are vowels with “..” affixed on the “a”, “o”, and “u”. Double vowels are “au”, “ei”, “ai”, “eu”, “..+au”, “ie”, etc. Entry of vowels with the combination of short sound vowels (i.e., basic vowels) results in ambiguity between “ie” and “ei”. Thus, separation of “i” and “e” is needed. For example, it is possible to classify short sound vowels into /a e o/ and /i u/, and various modifications are also possible.

When the same consonant appears consecutively and the same vowel appears consecutively, ambiguity may be avoided by the methods that the applicant proposes.

12.11 Vietnamese Resctricted Input Method

12.11.1 Vietnamese Resctricted Input Method in CVSK

In Vietnamese, the main structure of a Syllable is “Vowel”, “Consonant+Vowel”, “Vowel+Consonant”, or “Consonant+Vowel+Consonant”. Especially, words in Vietnamese are basically structured of one syllable, even though the number of multi-syllable words is increasing. A large number of one syllable word means that it is easy to implement the text input system based on CVSK.

There are 5 basic vowels in Vietnamese, “a”, “e”, “i (or ‘y’)”, “o”, “u”, and 6 affixed vowels, “v+a (‘v’ is affixed on the vowel ‘a’. In the following, ‘x+vowel’ means that ‘x’ is affixed on the vowel)”, “ˆ+a”, “ˆ+o”, “,+o”, “,+u”. “y” is the character of long pronunciation of “i”. CVSK may be configured using 5 basic vowels, and affixed vowels may be input by CPM. CVSK may be configured using some basic vowels and some affixed vowels, or using all 11 vowels.

There are various double consonants and triple consonants in Vietnamese. Thus it is not easy to classify the 5 basic vowels into 2˜3 groups as shown in FIG. 10-*, so as not to have ambiguity when RSM is applied. There are 6 kinds of sound tones, and 5 kinds of sound tone symbols are affixed on a vowel or beneath a vowel. The same vowel does not appear consecutively in Vietnamese, and this is very useful property for the entry of vowels. Thus, 5 basic vowels are classified into 5 groups, affixed vowels are entered (i.e., inputted) by Hiding RSM, and a sound tone symbol is affixed on/beneath a vowel (i.e., a basic vowel/an affixed vowel) by CPM. Here, “y” is regarded as an affixed character of “i”. In other words, vowels are classified into 5 groups, such as /‘a’, ‘v+a’, ‘ˆ+a’/, /‘o’, ‘ˆ+o’, ‘,+o’/, /‘u’, ‘,+u’/, /‘i’, ‘y’/, and /‘e’, ‘ˆ+e’/. Modification into 4 groups by adding 2 groups together which have a few affixed vowels is also possible. For example, it is possible to classify vowels into 4 groups, such as /‘a’, ‘v+a’, ‘ˆ+a’/, /‘o’, ‘ˆ+o’, ‘,+o’/, /‘u’, ‘,+u’/, /‘i’, ‘y’/, and /‘e’, ‘ˆ+e’/. When the vowels are classified into the 5 groups, the vowels are entered without ambiguity by applying RSM. A certain character in each group may be designated as a Representative Character (i.e., a Representative Vowel) and the rest of the characters may not be marked on the keypad. It is natural for the basic characters (i.e., short sound vowels) to be designated as the Representative Characters. In the example of classifing vowels into 4 groups, both “i” and “e” are marked on the keypad. The selection order of characters according to strokes (i.e., presses) of a button is determined by considering use frequency or other factors.

There are “-+d (‘-’ is crossed in the center of ‘d’)” in Vietnamese consonants, and “f” and “z” are not used. “-+d” is regarded as an affixed character of “d”, and it is entered by (Hiding/Non-hiding) RSM or CPM. According to some school books, “f”, “w”, and “z” are not used in Vietnamese. According to some other school books, “w” and “j” are semi-consonant in Vietnamese. Thus, it is considered that “f” and “z” are not used in Vietnamese and “w” is used but only infrequently even though “w” is used. In this embodiment, it is considered that “w” is not used in Vietnamese, but it may be included into a proper group if it is needed.

Compound consonants (including double consonants and triple consonants) in Vietnamese are “ch”, “gh”, “gi”, “kh”, “ng”, “ngh”, “nh”, “ph”, “qu”, “th”, “tr”, etc. “gi” and “qu” among them are the combination of a consonant and a vowel in structure, and they are not considered here. The fact that words in Vietnamese are mainly constructed with single syllables means that it is rare for syllables constructed as “C+V+C” to appear consecutively, thus consonants do not appear consecutively except in the case of compound consonants described above. Consequently, when compound consonants described above are classified into several groups and RSM is applied, if the consonants which construct a compound consonant are not grouped into same group, ambiguity is removed just like in the case of Chinese.

For example, consonants may be classified into 8 groups, such as /b p/, /d t/, /g k/, /c q/, /s x/, /m n/, /l r/, /h v j/, or they may be classified into 6 groups, like /b p v/, /d t/, /g k q/, /s x c/, /m n j/, /h l r/. It is also possible to classify consonants into specific groups. Each of the consonants “f” and “z” which are not used in Vietnamese may be added into a certain group.

When consonants are classified into 8 groups and vowels are classified into 4 groups, all characters in Vietnamese are accommodated in a 3*4 keypad. When consonants are classified into 6 groups and vowels are classified into 5 groups, all consonants and vowels are accommodated in 11 buttons and the rest of the buttons are used as control buttons for affixing sound tone symbols to vowels. When consonants are classified into 6 groups and vowels are classified into 4 groups, all consonants and vowels are accommodated in 10 numeral buttons, which makes it possible to form the simple code with only numerals. The rest of the buttons in 3*4 keypad are used as control buttons.

RSM may be applied using pairs of a consonant and a vowel. Refer to the case of Korean. When 10 pairs of a consonant and a vowel are grouped, the rest of the consonants and vowels may be input by CPM.

12.12 Russian Restricted Input Method in CVSK

The prior document of the applicant, PCT/KR02/00247, is referenced for CVSK for Russian.

There are 33 characters in the Russian alphabet. Among them, there are 10 vowels, 20 consonants, 1 semi-vowel (i.e., semi-consonant), and 2 sign characters (i.e., hard consonant sign and soft consonant sign).

The 33 Russian characters (capital and small) by dictionary order are as follows.

A [symbol] B [symbol] [symbol] E [symbol] [symbol] [symbol] [symbol] [symbol] [symbol] [symbol] M H O [symbol] P C T [symbol] ΦX

[symbol]

[symbol]

[symbol]

[symbol]

[symbol]

[symbol]

[symbol]

[symbol]

[symbol]

a [symbol] [symbol] [symbol] [symbol] e [symbol] [symbol] [symbol] [symbol] [symbol] [symbol] [symbol] [symbol] o [symbol] p c [symbol] y [symbol] x

[symbol]

[symbol]

[symbol]

[symbol]

[symbol]

[symbol]

[symbol]

[symbol]

[symbol]

[symbol]

20 Russian consonants are classified as voiced consonants and unvoiced consonants in the following. Roman characters in parentheses represent pronunciation.

| | | | |
|---|---|---|---|
| Unvoiced Consonants | 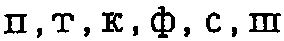 | 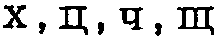 | |
| | (p), (t), (k), (f), (s), (sh) | (x), (ts), (tsh), (shsh) | |
| Voiced Consonants | 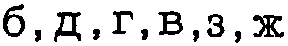 | | 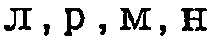 |
| | (b), (d), (g), (v), (z), (zh) | | (l), (r), (m), (n) |

Russian Vowels are classified as hard vowels and soft vowels.

| | |
|---|---|
| Hard Vowels | 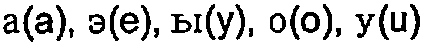 |
| Soft Vowels | 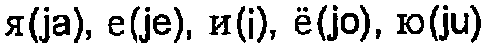 |

In classifying Russian consonants into proper groups, pairs of a voiced consonant and an unvoiced consonant which have similar phonetic values may be classified into the same group. For example, /(b) [symbol] (p)/,/ [symbol] (d) [symbol] (t)/, and so on. The consonants which do not have a relationship of a voiced consonant and an unvoiced consonant may be classified into proper groups, like examples in the prior document of the applicant. Some examples are as follows, and various modifications are possible.

Examples of classification into 10 groups

Example 1: [symbol] [symbol] / [symbol] T/ [symbol] [symbol] /BΦ/ [symbol] C/ [symbol] [symbol] / [symbol] P/MH/X [symbol] /

[symbol]

[symbol]

Example 2: [symbol] B/ [symbol] [symbol] / [symbol] T/ [symbol] [symbol] / [symbol] P/MH/ [symbol] Φ/C X/ [symbol] [symbol] /

[symbol]

[symbol]

Example of classification into 9 groups: (b) [symbol] (p)/ [symbol] (d) [symbol] (t)/ [symbol] (g) [symbol] (k)/ [symbol] (v) [symbol] (f) x/ [symbol] (z) c (s)/ [symbol] (zh) [symbol] (sh)/ [symbol] (ts) [symbol] (tsh) [symbol] (shsh)/ [symbol] (l) p (r)/ [symbol] (m) [symbol] (n)

Example of classification into 8 groups: (b) [symbol] (p)/ [symbol] (d) [symbol] (t)/ [symbol] (g) [symbol] (k)/ [symbol] (v) [symbol] (f) x(x)/ [symbol] (z) c(s) [symbol] (zh)/ [symbol] (sh) [symbol] (ts) [symbol] (tsh) [symbol] (shsh)/ [symbol] (l) p (r)/ [symbol] (m) [symbol] (n)

Example of classification into 7 groups:

In the above examples, each of semi-consonant “ [symbol] ”, hard consonant sign “ [symbol] ”, and soft consonant sign “ [symbol] ” may be addtionally included into a proper group. In the assignment of these groups to each button, some of the characters (e.g., [symbol] , [symbol] , [symbol] and other characters) may not be marked on the keypad to make the keypad simple.

10 Russian vowels may be classified into 5 groups using the pairs of a hard vowel and a soft vowel. There are 10 vowel characters and 11 pronunciations of vowels but there are 5 basic phonemes of vowel, (a), (e), (i), (o), and (u). Among them, (e) and (o) only appear in an accented syllable. Thus, phonemes of vowels (e) and (o) may be regarded as strong vowels. Phonemes of vowels without an accent are the other 3. Thus, 5 vowels from 10 Russian vowels may be regarded as basic vowels, strong vowels may be classified into one group, and the other 3 basic vowels may be classified into another group or other groups. Because it is expected that consecutive appearence (e.g., strong vowel after strong vowel) of the same type of vowels is unusual and rare. For example, classification into 2 groups such as

or 3 groups such

is possible. For the entry of the vowels which have a pair relationship with basic vowels, RSM may be applied by regarding them as being classified into groups with each corresponding basic vowel, or CPM may be applied by regarding them as succession characters of each corresponding basic vowel.

CVSK may be configured properly (e.g., “5 groups of vowels and 7 groups of consonants”, or “3 groups of vowels and 9 groups of consonants”) using groups of consonants and groups of vowels. Several consonants appear consecutively (e.g., CCCVC...) in Russian just like the case of English, but it is uncommon, and the typical structure of Russian syllables is the structure of alternative appearance (e.g., CV, CVCV, CVCVCV, ...) of consonants and vowels. This means that Russian words may be input without ambiguity (or with less ambiguity) in most cases by RSM in the CVSK.

12.13 Hindi Resctricted Input Method in CVSK

The prior document of the applicant, PCT/KR00/00601, shows the example of classifing Hindi consonants into 9 groups on the grounds of similarity of pronunciation, and this invention shows an example of 10 groups. The “group consonants” in Hindi which have a strong relationship of similarity of pronunciation may be classified into the same group. For example, the “group consonants” which have the pronunciations (k), (kh), (g), and (gh) in the above figure may be classified into the same group. This is also applicable for the other “group consonants” which have similar pronunciations. From among 35 Hindi consonants, 33 consonants excepting _(ud) and _(udh) which have “.” at the button of the characters may be grouped into 9 groups or 8 groups. _(ud) and _(udh) may be regarded as affixed characters of _(d) and _(dh) respectively, and they may be classified into the group to which each of the corresponding basic consonants belongs.

Hindi vowels are as follows, and they are described in the prior document of the applicant.

Basic forms:

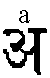

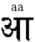

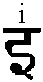

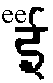

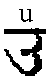

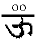

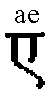

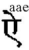

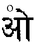

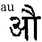

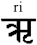

Simplified forms:
None

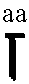

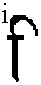

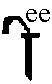

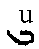

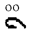

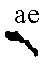

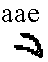

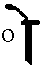

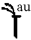

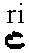

Hereinafter, expediently, the Hindi vowels are written as parenthesized English alphabet characters which represent pronunciation of a Hindi character with or without a left-sided underscore (on the underscore, it is regarded that there is a Hindi character which corresponds to its pronunciaion). Expediently, _(aa) is written as _(a-), _(ee) is written as _(i-), _(oo) is written as (o-), _(ae) is written as (e), and _(aae) is written as (ai).

The vowel _(ri) may be regarded as a consonant according to some Hindi schoolbooks. 10 vowels excepting the vowel _(ri) may be classified into 5 groups by pairs of Hindi vowels in above figure.

Single vowels in Hindi are separated into short sound vowels and long sound vowels. Short sound vowels are _(a), _(i), _(u), and long sound vowels are _(a-), _(i-), _(u-) in Hindi. The remaining 4 vowels are compound vowels which may be presented by the combination of single vowels. That is, _(e)=(a)+(i) or (a)+(i-), _(ai)=(a)+(e), _(o)=(a)+(u) or (a)+(u-), and _(au)=(a)+(o). Thus, basic vowels (a), (i), (u) may be classified into 3 groups, assigned to 3 buttons, and then the each of 3 basic vowels may be selected by 1 stroke of corresponding button and each of the 3 long sound vowels which corresponds to each of basic vowels may be selected by 2 strokes of the corresponding button, and the remaining 4 compound vowels may be input by the combination of basic vowels. The approach of input of compound vowels is similar to the that of Korean, for example,

[symbol]

For example, when _(a), _(i), and _(u) are assigned to the button [*], [0], and [#] respectively, the entries are given as “_(a-)=**”, “e=*0 and *00”. When “**” buttons are pressed during the input of “**0”, the system temporarily recognizes “**” as _(a-), but when “0” is pressed succesively, the system recognizes “**0” as “(a)+(e)=_(ai)”. Similarly, when “**” buttons are pressed during input of “**#”, the system temporarily recognizes “**” as _(a-), but when “#” is pressed succesively, the system recognizes “**#” as “(a)+(o)=_(au)”.

This approach may be realized completely when the 10 Hindi vowels do not appear successively in a word. When the Hindi vowels appear successively, ambiguity may occur. For example, when “**0” is input, the system maynot distinguish between “**0=_(a)+_(i)” and “**0=_(ai)”. But even though Hindi words exist that include successive vowels, it is not common, so when input values may represent a compound vowel just like the case of “**0=_(ai)”, the “Hindi Restriction” in which the input values are recognized at first as a compound vowel is applicable. For implementation, the system may store the cases of a compound vowel which is composed of basic vowels, and the system recognizes a vowel by sensing strokes of vowel buttons. The system recognizes input values as a predefined compound vowel, when a vowel combination (e.g., “_(a)” and “_(i)” in this embodyment) which is regarded as an impossible vowel combination is recognized by the system.

In this example, if a user intends to input long sound vowel _(a-) and short sound vowel _(i), “Intentional Cancellation of Language Restriction (ICLR)” or “Delay Time for Cancellation of Language Restriction (DTCLR)” is useful. In the above example, “**” is pressed, Hindi restriction is temporarily cancelled by passage of a predefined time or by intentional activation of a word end function, and then “0” is pressed.

It is assumed that _(a) does not appear consecutively in a Hindi word because there exists _(a-). Even though _(a) rarely appears consecutively in a word, the “Hindi Restricted Input Method” in which “**” is recognized as “_(a-)” may be applied. For the successive input of “_(a)”, ICLR or DTCLR” may be useful. For example, “*” is pressed, “word end” function is activated, and then “*” is pressed again.

RSM may be applied on the CVSK of Hindi for input of Hindi vowels on the assumption that vowels of the 10 Hindi vowels (or 11 Hindi vowels including the vowel “_(ri)”) do not appear or rarely appear successively in a word.

For example, it is expected that same vowel from among 3 short sound vowels does not appear consecutively in a Hindi word, because 3 long sound vowels which correspond to 3 short sound vowels respectively already exist. Thus, when vowels are classified into 3 groups and the 3 groups assigned to 3 buttons, 3 short sound vowels may be classified into 3 groups, each vowel of 3 long sound vowels may be classified into 3 groups and each group may be added to each corresponding group respectively, and the remaining 4 vowels (or the remaining 5 vowels including “_(ri)”) may be also classifed into 3 groups properly and then each group may be added to each of the prior 3 groups of short sound vowels respectively. A short sound vowel, a long sound vowel, and (a) compound vowel(s) which are grouped into a group are set to be selected in a predefined order. When the selection order is set to be “short sound vowel-long sound vowel-(a) compound vowel(s)”, the input method of (i.e., operation of a button for inputting) short sound vowel and long sound vowel is the same as the above method, and only the operation of buttons for inputting a compound vowel is different from the method described above. It is natural to input a short sound vowel and a long sound vowel with one stroke and two strokes of the corresponding button, respectively. The compound vowels are input by repeated strokes of the corresponding button.

Classification of vowels into groups, number of vowel groups, and selection order of vowels in each group is arbitrary. Even when a group of vowels is assigned to a button, it is not necessary to mark all vowels on the button. When Hindi vowels appear successively, ICLR or LRCDT may be applied.

A consonant and a vowel alternately appear in most Hindi syllable structures, but sometimes consonants appear successively. When a consonant appears after a consonant which ends with a vertical line, the vertical line is ommitted and the first consonant is combined with the second consonant and the 2 consonants forms a combined consonant. When a consonant appears after a consonant which ends without a vertical line, a symbol such as “\” is attatched beneath the first consonant and the 2 consonants form a combined consonant. In addition to these rules, there are some more rules and there are also irregular cases. When input of consecutive consonants is recoginzed (temporarily or with confirmation), it is easy to output a proper combined consonant because it is implemented in a commercial Hindi word processor.

English characters are usually marked on a keypad and are used for the input of English even in countries in which English is not the mother tongue. Hindi and English are official languages in India, thus it is natural to use a simple code and character input in which Hindi consonants and English consonants which have similar pronunciations may be grouped into the same group and assigned to the same button. The following is only an example, and various modificatioins are possible.

| | |
|---|---|
| | Eng |
| Hindi Consonant | Consonant |

| | | | | | | |
|---|---|---|---|---|---|---|
| 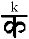 | 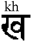 | 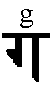 | 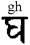 | | | G K |
| 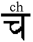 | 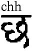 | 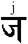 | 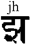 | | | C J |
| 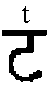 | 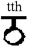 | 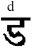 | 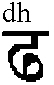 | 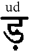 | 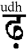 | D T |
| 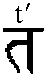 | 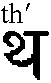 | 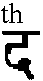 | 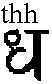 | | | H |
| 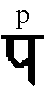 | 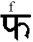 | 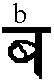 | 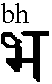 | | | B P |
| 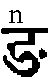 | 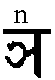 | 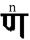 | 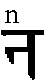 | 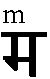 | | M N |
| 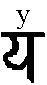 | 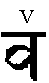 | | | | | Y V |
| 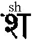 | 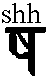 | 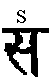 | | | | S Z |
| 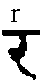 | 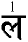 | | | | | R L |

In the above example, it is relatively easy to determine Hindi characters corresponding to “g”, and “k”, and to configure CVSK for English in India. In the above example, the English consonants such as “z” and “w” may be grouped in a proper group additionally or separately, just like the case of Chinese. To simplify a keypad, not all characters of a group but only some characters of a group may be marked on the keypad (applying Hiding Control Processing Method). For example, when the first group in the above table is assigned to a button, only _(k) and _(g) or one of _(k) and (g) need be marked on the keypad. The selection order of assigned characters may be defined arbitrarily. The vowel _(ri) may be assigned to the button to which / R L / is assigned.

12.14 Language Restricted Input Method in Semi-Consonant Separated CVSK

Semi-consonants (i.e., semi-vowels) are not common in each language. Usually “w”, “y”, and “j” are semi-consonants in English. In other language, “j” is excluded from semi-consonants and “v” is included in semi-consonants. Generally “w” and “y” seem to be common semi-consonants in most languages.

Classifying semi-consonants into a separate group is substantially the same as classifying characters on the similarity of pronunciation, because semi-consonants have similar phonetic values and properties like vowels.

There are some English characters (e.g., in Spanish, “k” and “w” which are used only for foreign language) which are not used in a specific language, and there are some characters (e.g., affixed characters or additional characters in the applicant's document) which are not used in English. Probably, the English characters that are not used in a specific language are needed to input English, because English is universal. Thus, when the number of English characters which are not used in a specific language is not large, the characters may be grouped with semi-consonants and assigned to a button. Refer to 10-6 in Chinese.

The English characters that are not used in a specific language may be grouped in a group and assigned to a button.

12.15 Language Restricted Input Method in Incomplete CVSK

This invention shows that it is possible to remove or minimize ambiguity by configuring CVSK optimized in a specific language and applying RSM. CVSK also makes the algorithm of the system simplified. It is obvious that various modifications are possible. Thus, even though some consonants and vowels are grouped into the same group and assigned to the same button, it is only a modification of Language Restricted Input Method in CVSK. Expediently, the keypad is called “Incomplete CVSK” and the button on which consonants and vowels are assigned is called “Consonant-Vowel Mixed Button (CVMB)”.

For example, the vowel “i” and the semi-consonant “y” may be grouped into the same group and assigned to a button, and the vowel and the consonant (in this example, semi-consonant) may be selected by a pre-defined order. The remaining buttons are separated into consonant buttons and vowel buttons. When “iy” and “yi” do not exist in Chinese, it is possible to input romanization (pinyin) of Chinese without ambiguity. In this example, it is assumend that “y” is selected by pressing the CVMB once and “i” is selected by pressing the CVMB twice. When this CVMB is pressed after a consonant button is pressed, a consonant of the previous consonant button is confirmed, thus the system also confirmins recognition of the input of the CVMB as “i” while not temporarily recognizing it as “y”. Because the consonant “y” maynot appear after a consonant in Chinese, this Language Restriction is applicable.

For another example, the vowel “i” and consonant “j” may be grouped into a group, or vowel “i” and consonant “k” may be grouped into a group, and (Language Restricted) RSM may be applied. When “...ik...” or “...ki...” exists in romanizatoin (pinyin) of Chinese, ambiguity occurs. Assignment of (a) consonant(s) and (a) vowel(s) to a button without any special reason makes the algorithm of the system complex and lowers efficiency of the system. It is not better than applying Language Restricted RSM in a complete CVSK. But, for a special reason (e.g., to assign (a) consonant(s) to all of 10 numeral buttons), some buttons may be CVMB (Refer to the case of Korean).

Modification of FIG. 10-7 is possible. Refer to FIG. 10-9. It is applicable when there are one more CVMB and 2 or more consonants, and 2 or more vowels are assigned in the CVMB. Applying language restriction in Incomplete CVSK is a little more complex than applying language restriction in CVSK (Refer to the above example of “i”. and “y”), and a detailed flowchart of a specific language may be more complex than FIG. 10-9 in order to present a combination rule of consonants and vowels in a specific language. FIG. 10-9 is a modification of FIG. 10-7, and generalities of an incomplete CVSK are presented in brief.

12.16 Applying Non-Hiding Control Processing Method

In the CVSK, a button (in or out of a 3*4 keypad) may be designated as a control button, and a representative character may be selected by pressing a corresponding button once and the rest of the characters may be input by CPM. For example, in FIG. 10-6, “w”, “y”, and “v” which are assigned to the [0] button may be reassigned to other consonant buttons, and then the entries may be given as “p=b+0=10” (when control is set to be selected after a representative character) by using the [0] button as a control button. This is already explained in the prior document of the applicant.

13. Concurrent Input Method Based on Length of Input Value

The length of the short-cut code stored in the simple code index may be less than a predetermined number. In specific cases, the user or the system may designate the type of the short-cut code (e.g., type 1 (city name), type 2 (bank name), ...; and type 1 and type 2 are grouped in three-like structure according to the prior document). If the type of the short-cut code is designated as type 1 (city name) and the length of the short-cut code is less than 3, the system considers the input value as a full code the moment the length of the input value exceeds 3 in the CIM applying SIM as basic input mode. Contrarily, the system considers the input value as a simple code (or short-cut code) when the user enters three input values and activates the word end function (e.g., space) in the FIM-based CIM (CIM applying FIM as basic input mode).

This is particularly useful in the case where the length of the short-cut code of a specific type (city name— [symbol] , company name— [symbol] , . . . ) is less than a predetermined value as in Chinese (In Korean or Chinese, nouns of a specific type usually comprise less than a predetermined number of syllables and the use of the syllable-based initial code as the short-cut code is natural. For example, most of Korean bank names consist of two syllables and the length of the syllable-based initial code for bank name is 2).

This is useful for the case where it is not necessary to determine at the beginning of the input whether the input value is a short-cut code or a full code, i.e., the case where the system can determine the input value as a simple code or a full code according to whether or not the length of the input value is greater than a predetermined value. Namely, the system has only to check on whether or not the length of the input value is greater than a predetermined length, without referring to the short-code index whenever an input value is entered. This simplifies the realization of the system and enhances the system performance.

14. Language Restricted Concurrent Input Method (CIM)

In the Language Restricted Concurrent Input Method, the system considers the input value as a simple code the moment the input value infringes the “word production rules” of a specific language (i.e., infringes language restriction) in the FIM-based CIM (CIM applying FIM as basic input mode). If it is judged that there is no concurring value with the input value in the simple code index, the system considers the input value as a full code again.

14.1 Language Restricted Concurrent Input Method (CIM) Using LRRSM as FIM

14.1.1 Chinese

In particular, the syllable-based initial code of Chinese in FIGS. 10-1 to 10-4 has a numeral value of consonant buttons [1] to [9] (vowel “a”, “o” or “e” are used alone sometimes to have a meaning of no more than an interjection and are actually rare, while vowels “i”, “u” or “\ddot{}u” prefixed with “i”, “w” or “y”, respectively, are used alone). For a full code using the repeat selection method, one of buttons [*], [0] and [#] must be selected to enter a vowel as for the second or third input value in the examples of FIGS. 10-1 to 10-4. This provides a useful feature that determines whether or not the input value forms a full code at the beginning of the input, in the case of using the “Concurrent Input Method” as described in the example of Korean according to the prior document of the applicant.

For example, when the user enters “693...=shk...” in the concurrent input method (e.g., FIM-based CIM) using the full input mode as a basic input mode, the system recognizes that the input value does not form a full code (because consonant “k” cannot appear next to “sh”), and considers the input value as a simple code, the moment the third value [3] is entered. When the user enters “112...=pd...”, the system recognizes that the input value does not form a full code (because the input “11” is not considered as “bb” but as “p” in Chinese and the Roman alphabet consonant “d” or “t” appearing next to “p” does not form a Chinese syllable), and considers the input value as a simple code, the moment the third value [2] is entered. Likewise, when the user enters “7771...=wb...”, the system considers the input value as a simple code the moment the fourth input value [1] is entered. In most cases, the system can determine whether the input value is a full code or a simple code, upon the user's entering the second or third input value.

If the user enters “14...=bj...”, the system determines that the input value does not form effective Chinese syllables (because a combination of Roman alphabet consonants such as “bj” is not present among the finals in Chinese), and considers the input value as a simple code, the moment the second input value [4] is entered. Namely, the system can provide a word of “Beijing” or [symbol] corresponding to the simple code “14” for the user. Without a simple code of “14” or “14...” in the simple code index, the system considers the input value as a full code and provides “bj” for the user.

This is the same as the case of Korean using vowel elements (in FIG. 4-5). The full input method of FIG. 4-5 is not considered as the Korean restricted RSM. When the user enters “12” not forming effective Korean syllables in the FIM-based concurrent input method, the system considers the input value as a simple code and provides a word or a phrase corresponding to the simple code with reference to the simple code index. But when it is determined that there is no simple code corresponding to “12” in the simple code index, the system considers the input value as a full code and provides

for the user.

For further understanding, it is seen that the simple codes are sorted in alphabetical order in the simple code index of FIGS. 5-4 and 10-5. But the arrangement of the simple codes stored in the system does not matter, and if necessary in searching the simple code index, the system may sort the simple codes and checks whether or not the input value is present in the simple code index.

In the Concurrent Input Method using the Short-cut Input Method as a basic input mode (SIM-based CIM), (supposing that the simple code index to be searched contains only syllable-based initial codes consisting of [1] to [9] in FIG. 10-1), the system considers the input value as a full code without searching the simple code index the moment the second value [*] of the input value “1*...” is entered. This is the same as in the case of Korean in FIG. 5-4.

14.1.2 English and Others

The system considers the input value as a simple code the moment it recognizes the fourth consonant of a word starting with “st˜” or “sp˜” and that it recognizes the third consonant of a word not starting with “st˜” or “sp˜”.

For example, when the user enters “467=gms...” using the simple repeat selection method on the keypad of FIG. 1-1, the system considers the input value as a simple code the moment the third input value [7] is entered, because the input value infringes the word production rules. If the simple code index contains the fully associated simple code “4678255” for “install”, the system provides the word “install” corresponding to the simple code. If there is no simple code corresponding to “467...” in the simple code index in the searching range, the system considers the input value as a full code again.

When the English restricted RSM is applied as FIM on the consonant-vowel separated keypad, as described above, the system can determine whether or not the input value infringes the English word production rules (e.g., there is no English word that contains three consonants from the beginning without starting with “st˜” or “sp˜”), thereby making the use of the concurrent input method more efficiently.

14.2 Language Restricted Concurrent Input Method using CPMERC as FIM

When the user enters the first character of each button in FIG. 1-1 as a representative character with one stroke of the corresponding button and the other characters using control processing (i.e., when the user applies CPMERC), the language restricted concurrent input method can be applied to consider the input value as a simple code considering that the input value infringes the above-mentioned word production rules in English.

For example, when the user enters the first character in FIG. 1-1 as a representative character and the other characters using control processing, the system considers the input value as a simple code as the input value infringes the word production rules in English the moment the third input value [7] of “467...” for “gms...” is entered.

Likewise, the same is applied to languages other than English. The details are similar to case of the Language Restricted Concurrent Input Method (LRCIM) using RSM as FIM.

14.3 Overcoming Third Ambiguity in Language Restricted Concurrent Input Method

When the user enters the fully associated simple code “72673” of “scope”, the system recognizes the simple code as a full code at the first stage and considers the input value as “72673=pampd” that does not infringe the word production rules in English. So the system first considers the input value as a full code and secondly interprets it as a simple code to cause “third ambiguity” in which the input value is also interpreted as “scope” corresponding to the simple code.

In this case, the system first provides “pampd” for the user. But when the user intends to enter “scope”, one stroke of a specific button may choose “scope”. If the word input ends after the input of “72673” (e.g., space is entered), the system provides the user with a list of “pampd” and “scope” and causes the user to choose either of “pampd” or “scope”. Here, “pampd” results from the first interpretation of the input value and “scope” results from the second interpretation of the input value as a simple code.

The same is applied to the concurrent input method using CPMERC as FIM. Not only in the FIM-based CIM, but also in the SIM-based CIM, even though the input value is present in the simple code index at the point of “end of word” after entry of input value, if the input value considered as a full code does not infringe the language restriction (e.g., if the third ambiguity occurs), the system may cause the user to chose the target word or phrase (by repeatedly pressing a specific button or selecting from a given list).

The same is applied to languages (especially, the Japanese language using CPMERC) other than English.

15. Extraction and Interpretation of Simple Code from Text (Character String) Infringing Language Restriction

A client or a server can interpret an input value (full code or simple code). FIGS. 11-1 and 11-2 show the interpretation of an input value by the client or the server, respectively. Namely, the simple conception of “system” means either the client system or the server system. When the input value is a simple code and the client system interprets the input value to send a word or a phrase corresponding to the simple code as a text to the server system, the server system uses the text to provide various services. Likewise, even when the input value is sent to the server system as a numeral and the server system interprets the numeral, the server system interprets the simple code and uses it for various services. The case where the client-system sends a DTMF tone to the server system and the server system uses the transmitted input value is also one of the examples in which the client sends the numeral value to the server.

When an input value infringes the language restriction in the language restricted concurrent input method (i.e., the input value does not form effective syllables of a specific language), the system considers the input value as a simple code and the simple code index may not contain the simple code corresponding to the input value. In this case, the system considers the input value as a full code again. For example, when the user enters “7799” for [symbol] in FIG. 4-5 but the simple code index of the client system does not store “7799” or [symbol] corresponding to “7799”, the system simply considers the input value as [symbol] For example, when the client sends the input value “7799” or [symbol] corresponding to the input value “7799” to the server in the stock information system, the stock information server interprets “7799” without any problem (it is supposed that the stock information server stores the simple code “7799” and its corresponding word [symbol] But when the client considers the input value “7799” as a simple code and the simple code index of the client system does not contain “7799”, the client system secondly considers the input value as a full code and sends a text [symbol] to the server. In this case, the stock information server cannot use the text.

If the text [symbol] sent from the client is a meaningless value, the stock information server extracts “7799” used for entry of [symbol] and searches for the corresponding word [symbol] and uses the searched word. In another method available only in the case where the syllable-based initial code is used as the simple code in Korean, the system searches for [symbol] that is in accord with the word [symbol] corresponding to the simple code in the first consonants of the syllables, to provide services. The syllable-based initial code of [symbol] is also “7799”. In this case, “7799” is interpreted as [symbol] so that the system searches for words or phrases in which the first consonants of syllables are [symbol] as well as for words or phrases being identical in the first consonants of syllables to [symbol] Namely, the system searches for a word or phrase in which the first consonants of syllables are identical to the characters assigned together with [symbol] (considering that the aspirated consonant and the tense consonant are implicitly assigned to a button for a basic consonant).

The same is applied to the PC environments using a keyboard other than a keypad. In the stock information system using the existing PC as a client system, for example, the user has to enter [symbol] in order to search for the stock price of [symbol] When the user enters [symbol] and sends the input value to the server, the stock information server system, recognizing that [symbol] is not present as a listed company name, provides services using the two methods as described above (a method of extracting “7799” and searching for [symbol] or a method of searching for [symbol] that is identical in the first consonants of syllables to

[symbol]

In another method, the server index stores [symbol] (characters corresponding to simple code)” as well as “7799 (a simple code)” and [symbol] (a word corresponding to the simple code)” and the server determines that the input value [symbol] from the client does not form effective Korean syllables, and then compares the input value with the stored characters corresponding to simple code. Thus the system can find out [symbol] as intended by the user.

The above content is illustrated in FIG. 11-3, where (A), (B) or (C) is selectively available.

In case where the client using the existing PC enters characters via a keyboard or the like (e.g., using the word processor of PC), the syllable-based initial code is used to enter the first consonants of syllables and the (client or server) system converts the syllable-based initial code to a target word, thereby making it possible to rapidly enter characters or to use them in various information systems. For example, when the user enters [symbol] instead of [symbol] the system searches the index and provides the user with [symbol] that has [symbol] as the first consonants of syllables. Another method as described above (extracting the simple code of the input value based on a specific keypad, searching the simple code index, and storing characters corresponding to simple code in the index) can also be applied. Refer to FIG. 11-5, where (A), (B) or (C) is selectively available.

It has been so far described that a commonly used word or phrase is registered and entered simply with a combination of special function buttons and numeral buttons irrespective of the connection with the word or phrase. For example, [symbol] is stored as a commonly used word and entered with “alt+1”.

Likewise, the syllable-based initial code of [symbol] (satongjipdan: The applicant having no knowledge of Chinese pronunciations romanizes the Korean pronunciations of the word. But the same is applied to Chinese pronunciations)” is “6242” that corresponds to “s, t, j, d”. When the user entering “6242”, and “6242” and [symbol] are not stored in the client system, the client system provides “sdjd” to the user. As the user sends “sdjd” to the server, the server considering that “sdjd” does not form effective Chinese syllables extracts “6242” from “sdjd” and searches for [symbol] corresponding to the simple code (syllable-based initial code, in this example) “6242” (it is supposed that the server system stores the simple code and the word or phrase corresponding to the simple code).

As in the case of Korean where the system searches for a word identical in the first consonants of syllables to [symbol] and the characters assigned together with the individual consonants, the system provides the user with a word identical in the first consonants of syllables to “sdjd” and other variable combinations of consonant (e.g., sixteen combinations including “xdjd”, “stjt”, “sdjt” and so on) in FIG. 10-2.

The character set “sdjd” corresponding to the simple code is stored in the server system, and “sdjd” from the client does not form effective Chinese syllables. Thus the system compares the input value with the characters corresponding to simple code in the index and finds out that the user intended to enter

[symbol]

The above content is illustrated in FIG. 11-4, where (A), (B), or (C) is selectively available.

Information communication device such as a PC also searches for a word [symbol] identical in the first consonants of syllables in romanization to the input value “stjd” entered by the user, and provides the word to the user. Alternatively, upon the user entering “stjd”, the system (i.e., PC) registers the simple code (characters corresponding to simple code) as the first consonants of the individual syllables “stjd” and, upon the user entering the second consonant, considers the input value as a simple code (considering the user performs a short-cut input) because the input value infringes the Chinese language restriction (two Roman alphabet consonants other than sh, ch, or zh appear). Extraction of the simple code (e.g., 6242) from the input value “stjd” can be performed with a negotiated keypad (e.g., FIG. 10-2). Refer to FIG. 11-6, where (A), (B) or (C) is selectively available.

The same is applied to any other modified character set (there can be various types of character sets realized on the screen) as well as the PC keyboard or the keypad.

16. Concurrent Input Method Without Using Simple Code Index in Entry of Syllable-Based Initial Code

In the case of using a syllable-based initial code as a simple code in the above-stated method, a comparison between the simple code with the first consonants of the individual syllables can be usefully applied to the case where the client does not have an index of simple codes (e.g., “6242”, “satongjipdan” and [symbol] but an index of specific words or phrases (e.g., “satongjipdan” and [symbol] For example, upon the user selecting the second button [2] of “62...”, the system recognizes that the input value infringes the Chinese language restriction, and searches for a word of the index identical in the first consonants of the individual syllables to the input value “62...=sd..., st..., xd..., xt... (expediently, referred to as “available alphabet combinations”). As the number of strokes of the button increases, the number of available alphabet combinations increases. The available alphabet combinations are used for comparison/searching of the words from the index. Refer to FIG. 11-7. In the index of FIG. 11-7, the system retains a multiple catalog (2**4=16, 16 are possible) of “stjp”, “sd ...”, “xd ...”, “xt ...” etc in the row (i.e., record) of [symbol] and then the system provides [symbol] corresponding to “sd . . .” by comparing “sd ...” and values in the multiple catalog. The concept is the same, but it is not recommended.

Likewise, supposing that the client does not have an index of simple codes (e.g., “7799” and [symbol] but an index of specific words or phrase (e.g., [symbol] ) and that the user enters “77 . . . ” for [symbol] Upon the user selecting the second button [7], the system recognizes that the input value infringes the Korean language restriction, and searches for a word of the index identical in the first consonants of the individual syllables to the input value [symbol] (expediently, referred to as “available alphabet combinations”). Refer to FIG. 11-8.

Without a word identical to the input value in the index, the system considers the input value as a full code and provides it. This has the same effect as the concurrent input method on the system having an index of words instead of an index of simple codes, only when the user enters a syllable-based initial code. This method is also the same in the procedure of the system's recognizing that the input value infringes the full code production rule in the FIM-based Concurrent Input Method, or the language restriction in the FIM-based Language Restricted Concurrent Input Method, but different in the procedure of searching for a word or phrase corresponding to the input value. Namely, upon recognizing that the input value infringes the full code production rule or the language restriction, the system considers the input value as not to be a full code and interprets (or searches for) a word corresponding to the input value for the user, without using a simple code, considering that the input value is the syllable-based initial code.

It is the point of the concurrent input method that the system automatically recognizes that the input value infringes the full code production rule or the language restriction, and considers the input value as a simple code (i.e., considering that the user performs short-cut input rather than full input). Thus this is a modification of the above-described concurrent input method in regard to the step of searching for a word corresponding to the input value in a specified case (using a syllable-based initial code).

17. Selection of Function

Spacing is an essential function in entering a word (phrase). Deleting (i.e., input canceling) is also necessary. Entering function may be achieved by entering nothing during a predetermined time after an input, but generally enter function is also essential. These three functions are referred to as “three basic functions”. Minuscule/capital transition is also necessary for the languages containing capital letters, such as English. Among the up, down, right and left move functions, right and left cursor functions may be replaced with spacing and deleting functions, respectively, and the up and down move functions are not essential.

There are some examples of listing various functions for entering a word or phrase in the order of necessity as follows, examples of which are given for references and may be changed according to circumstances. For example, English-Chinese transition may be the essential function in entering the Chinese characters on an English keypad. Chinese transition is also of significance to the languages in the Chinese culture area, such as Korean and Japanese.

1. spacing-entering-deleting-minuscule/capital transition-mother language/numeral/English mode transition-up/down/right/left move;

2. spacing-deleting-entering-mother language/numeral/English mode transition-minuscule/capital transition-up/down/right/left move;

3. spacing-entering-deleting-Chinese transition-mother language/numeral/English mode transition-up/down/right/left move; and

4. Chinese transition-spacing-entering-English/numeral mode transition-move

17.1 Selection of Function Using Control Processing

It has been described that characters and various symbols can be selected using control processing. The same is applied to the selection of various functions. FIG. 12-1 shows an example that numeral buttons are allocated to various functions and are associated with “function controls”. The individual numeral buttons are designated in association with various functions so that the user can be readily reminded of the functions. In FIG. 12-1, right/left/up/down arrow buttons are recognizable by intuition and the enter button is positioned in the center of the keypad to readily remind the user of the numeral buttons and their associated functions. The other necessary functions are also associated with the buttons for characters related to their name, which is to remind the user of the functions. In FIG. 12-1, the shift function is associated with button [7] allocated to “S”.

In FIG. 12-1, supposing that aspirated consonant control and tense control are selected according to the number of strokes of button [*], as in the case of Korean according to the prior document, and then function control is selected with the stroke of button [*], the entry is given as “enter=[5]+{function}=[5]+[*]+[*]+[*]. If the character selected with one stroke of button [5] contains no aspirated/tense consonant, the enter function is selected until the strokes of [5]+[*] by the Jump Control Processing Method.

The functions associated with the individual buttons may be marked on the numeral buttons or not. It has been pointed out that marking the numeral buttons associated with the symbol groups on a part of the LCD screen maintains a simple arrangement and provides convenience in use without marking functions on the corresponding numeral buttons. The same is applied to this case. Refer to FIG. 12-2. As mentioned in regard to the entry of symbols, the user can re-designate the functions associated with numeral buttons.

If button [*] or [#] is not used as another control button as in the case of English, “function control” is selected with one stroke of button [*]. Thus, in FIG. 12-1, the function can be chosen with one stroke of the numeral button associated with the function and button [*].

17.2 Selection of Function Using Multi-Dimensional Cross Control Processing (Using Cross Combination of Control Buttons)

A method of using one control button for the input of one character is called “one-dimensional control processing”. When the same control button is repeatedly used, one-dimensional control processing is still applied.

When buttons [*] and [#] are used as control buttons and the one-dimensional control processing is applied to enter characters and various symbols, various functions can be selected using a cross combination of the control buttons (i.e., [*]+[#] or [#]+[*]). When the control buttons are not repeatedly used, the function can be selected with a combination of the control buttons, such as [*]+[*] or [#]+[#]. The entry of “[*]+[#]” that forms a shape proceeding from the left to the right can be used for the right cursor function (or spacing function) to readily remind the user of the function. Contrarily, the entry of “[#]+[*]” that proceeds from the right to the left can be used for the left cursor function (or deleting function) to readily remind the user of the function.

This can be understood from the standpoint of the multi-dimensional cross control processing method. For example, if the control is set to be selected after representative character, when the user intends to enter “ˆa=a+[*]” and enters “a+[*]+[#]”, the system recognizes the input value as “ˆa” upon the user's entering “a+[*]”. [#] cannot appear in the next stage (even though button [#] is used as another control button), and the system recognizes the input of “[*]+[#]” as the selection of the right move function the moment the user enters [#]. The same is applied to the case of where the control is set to be selected before representative character.

For the Japanese language, two-dimensional control processing is applied. In this case, the function is activated with an alternate combination of three or more strokes of control buttons. For example, entries are given as “spacing=[*]+[#]+[*]”, and “deleting=[#]+[*]+[#]”. In the case of the spacing function, the selecting pattern of [*]+[#]+[*] brings up the image of a right arrowhead and readily reminds the user of the spacing function. Likewise, the selecting pattern of [#]+[*]+[#] suggests a left arrowhead and readily reminds the user of the deleting function. The reason of this is as described above.

In summary, an alternate combination of two strokes of control buttons is used in the one-dimensional control processing method and an alternate combination of three strokes of control buttons is used in the two-dimensional control processing method to select various functions. Namely, various functions can be selected using an alternate combination of N+1 strokes of control buttons in the case of the N-dimensional control processing method for the input of characters or various symbols.

18. Chinese Transition (Chinese Shift)

Korean characters or Roman characters for romanization of Chinese and Chinese character are in a one-to-multiple ratio. For example, there are so any Chinese characters (e.g., [symbol] . . . ) that correspond to Korean [symbol] .

For the Chinese language, the Chinese characters corresponding to “beijing” includes [symbol] [symbol] or the like. Thus the “Succession Characters in Chinese” are selected with multiple strokes of the Chinese transition button (e.g., [symbol] (2^{nd}), [symbol] (3^{rd})). For example, after entering “beijing”, one stroke of the Chinese transition button selects [symbol] and then one more stroke of the Chinese transition button selects [symbol] Alternatively, the user may select the Chinese characters from a given list.

For the Chinese language, an index has to store all the Chinese characters to be entered (expediently, referred to as “target Chinese characters”). Thus the target Chinese character confirmed by system can be provided for the user even in the course of entering Roman characters for romanization of Chinese. For example, when there is no word but [symbol] that starts with “beij...”, the system provides [symbol] for the user the moment the user enters “beij”.

For the Japanese language, Hiragana and Katakana are in a one-to-one ratio, and Hiragana or Katakana and Chinese character are in a one-to-multiple ratio. As described previously, a selection of Katakana transition control (e.g., [symbol] control in FIG. 2-1) after the input of Hiragana may convert Hiragana mode to Katakana mode. In FIG. 2-1, an affixed character is entered using the cross control processing method and [symbol] control is selected with two strokes of button [0]. The Chinese characters corresponding to Hiragana or Katakana can be selected with multiple strokes of button [0]. For example, when the [symbol] control is set to be selected after representative character, [0]+[0] after the input of a Hiragana word (or character) converts the input to Katakana corresponding to the input Hiragana and one more stroke of button [0] converts Katakana to Chinese character. Contrarily, [0]+[0] after the input of Katakana in the Katakana mode converts the Katakana to the corresponding Hiragana and another stroke of button [0] converts the Hiragana to Chinese character.

19. Construction of Index of Simple Code

The simple code proposed by the applicant, “Fully Associated Simple Code”, “Syllable Based Initial Code”, “Consonant Associated Simple Code”, “First Vowel+Consonant Associated Simple Code”, and “Word Based Initial Code” may be extracted mechanically (i.e., automatically) from a word or a phrase. Thus, the system constructs an index of simple code automatically for the words which are input using Full Input Method (FIM), and the index of simple code may be used for CIM. In the enviroment like FIG. 5-5, the index of simple code may be strored in the client side or server side, or may be stored in the client and server side.

Various kinds of simple code (e.g., “Fully Associated Simple Code” and “Initial Based Initial Code”) may be generated for the same word. It may be generally convenient for a user to use a specific kind of simple code, so it is needed for the user to know the kind of simple code. It is beneficial for the automatic construction of the index of simple code that the more words the user inputs, the richer the index of simple code is.

To extract Syllable Based Initial Code from a specific word of a specific language, the system should separate syllables from the words. It is possible to separate syllables from words according to the syllable separation rule of a specific language. It is easy to separate syllables from a word, because there are syllable separation rules in specific languages, so this is not described in detail.

20. Interpretation of a Target Word or Phrase From a Word or Phrase Without Special Symbol (e.g., Affix)

When a tone symbol is not affixed on the vowel, “beijing” corresponds to [symbol] and [symbol] and and in this case, a target word or phrase may be selected by pressing a predefined button repeatedly or it may be selected from the list by a user.

Likewise, in a language as well as Chinese, when only (a) basic vowel(s) in a word is/are input without a sound tone symbol or an affix, the system recognizes a target word or phrase by sensing repeated pressing of a predefined button. Or the system searches an index and provide a user with a list which includes corresponding words or phrases with affixes, and then the system recognizes a target word or phrase by sensing selection from the list.

This is useful when there are many affixed characters and tone symbols like in Vietnamese. However, the system must maintain the index which retains words or phrases with affixes. Likewise, the index which retains words or phrases with affixes may be constructed from the user's inputs. For example, when a word “ˆ+abc (‘ˆ’ is affixed on ‘a’)” is input, the system stores “ˆ+abc” (the system stores both “abc” and “ˆ+abc” which corresponds “abc”). When “abc” is input and then a predefined button is pressed, the system provides a user with “ˆ+abc”, or the system provides a user with the list which includes “abc”, “ˆ+abc”, and other words which corresponds to “abc”. When the word “abc” is a target word, the user will not press a predifined button, or select “abc” when the list is provided. The list may be provided to a user at any point of time, for example at the end of input of a word or during input of a word.

### Effect of the Invention

This invention shows that words or phrases may be input without ambiguity in some languages and with a little ambiguity in most languages by applying (language restricted) RSM in CVSK.

Moreover, this invention proposes an innovative system which recognizes in early stage of input whether an input value is a simple code or a full code by CIM (i.e., Language Resctriced CIM) with a language restricted input method as FIM.

1. A method for entering characters from a keypad, which has a plurality of buttons, each button arranging at least one of alphabet characters or symbols, the method comprising:
(a) detecting a selection of button on which at least one of alphabet characters are arranged; and
(b) recognizing a target word or phrase using available alphabet character combination excluding unavailable alphabet character combination when the number of button selection is two or more.

2. (canceled)

3. The method of claim 1, wherein consonant buttons of the keypad are separated from vowel buttons of the keypad, each consonant button arranging one or more consonants and each vowel button arranging one or more vowels.

4. The method of claim 1, wherein the target word or phrase is composed of Chinese characters, the step (b) recognizes the target word or phrase using a language restriction rule (i.e., word production rule or character coupling rule) which same consonant or vowel of Roman alphabet should not succeed in the Chinese Pinyin.

5. A method for entering characters from a keypad, which has a plurality of buttons, each button arranging at least one of alphabet characters or symbols, the method comprising:
wherein consonant buttons of the keypad are separated from vowel buttons of the keypad, each consonant button arranging one or more consonants and each vowel button arranging one or more vowels, the method comprising:
(a) detecting a selection of vowel button or consonant button; and
(b) recognizing a target word or phrase responsive to the selection of the button.

6. The method of claim 5, wherein the consonant button or vowel button arranges consonants or vowels based on similarity of pronunciation.

7. The method of the claim 5, wherein the consonant button or the vowel button is to enter a language (including Chinese Pinyin) using Roman alphabet, wherein vowel “a” and vowel “i” are not grouped into a same group and are arranged on different vowel buttons.

8. The method of claim 5, wherein the consonant button or the vowel button is to enter a language (including Chinese Pinyin) using Roman alphabet, wherein vowel “e” and vowel “i” are not grouped into a same group and are arranged on different vowel buttons.

9. The method of the claim 5, wherein the consonant button or the vowel button is to enter a language (including Chinese Pinyin) using Roman alphabet, wherein vowel “o” and vowel “u” are not grouped into a same group and are arranged on different vowel buttons.

10. The method of claim 5, wherein the consonant button or the vowel button is to enter Chinese Pinyin, one or more alphabet characters selected from alphabet character group including vowel “a”, “e”, “o” and one or more alphabet characters selected from the alphabet character group including vowel “i” and “u” are arranged on different vowel buttons.

11. A method for entering characters from a keypad, which has a plurality of buttons, each button arranging at least one of alphabet characters or symbols, the method comprising:
(a) detecting a selection of button arranging one or more alphabet characters;
(b) determining whether the selected button is available alphabet character combination or not, based on language restriction rule of a specific language when the number of button selection is two or more; and
(c) processing the selected button value as simple code when the selected button is determined as unavailable alphabet character combination.

12. The method of claim 11, wherein the selected button value is processed as a predetermined full code when the phrase corresponding selected button value is determined not to exist in index.

13. The method of claim 11, wherein step (c) further comprises:
recognizing an available alphabet character combination corresponding to the selected button; deriving the alphabet character combination from the word or phrase stored in the index on the basis of the type of a predefined simple code; and
processing the simple code by comparing the recognized alphabet character combination with the derived alphabet-character combination.

14. The method of claim 11, wherein step (c) processes the simple code by comparing the selected button value with a specific simple code stored in index.

15. The method of claim 11, wherein step (c) further comprises:
recognizing an available alphabet character combination corresponding to the selected button; and
processing the simple code by comparing the recognized alphabet character combination with alphabet character combination stored in index based on specific simple code.

16. The method of claim 11, wherein the language restriction rule is based on word production rule of the Chinese Pinyin, wherein step (c) processes the selected button value as simple code or full code using the language restriction rule that consonants do not appear in succession from the start of word except “ch..”, “sh..”, “zh”.

17. The method of claim 11, wherein the language restriction rule is to enter alphabet character using Roman alphabet, wherein step (c) processes the selected button value as simple code or full code using the language restriction rule that consonants do not appear in succession from the start of word except “st..”, “sp..”.

18. A method for entering characters from a keypad, which has a plurality of buttons, each button arranging at least one of alphabet characters or symbols, the method comprising:
(a) detecting a selection of button on which at least of alphabet characters is arranged;
(b) counting the number of button selection; and
(c) processing as simple code when the button selection number is no more than a predetermined number and processing as full code when the button selection number is larger than the predetermined number.

19. A method for inputting characters from a keypad, which is to construct an index of simple code, the method comprising:
(a) dividing the syllables from a word or phrase which is input by the user;
(b) extracting predefined type of a simple code from each syllables; and
(c) storing simple code corresponding to the word or phrase.

20. (canceled)

21. (canceled)

22. A method for entering characters from a keypad, which has a plurality of buttons, each button arranging at least one of alphabet characters or controls, the method comprising:
(a) detecting input of simple code; and
(b) processing the simple code by comparing the recognized alphabet character combination by the simple code with alphabet character combination stored in index based on specific simple code.

23. The method of claim 22, wherein consonant buttons of the keypad are separated from vowel buttons of the keypad, and each consonant button arranging one or more consonants and each vowel button arranging one or more vowels.

24. A method for entering characters from a keypad, which has a plurality of buttons, each button arranging at least one of alphabet characters or controls, the method comprising:
(a) detecting input of simple code;
(b) deriving the alphabet character combination from the word or phrase stored in the index on the basis of the type of a predefined simple code; and
(c) processing the simple code by comparing the recognized alphabet character combination by the simple code with the derived alphabet character combination.

25. The method of claim 24, wherein consonant buttons of the keypad are separated from vowel buttons of the keypad, and each consonant button arranging one or more consonants and each vowel button arranging one or more vowels.

26. A method for entering characters from a keypad, which has a plurality of buttons, each button arranging at least one of alphabet characters or controls, the method comprising:
wherein consonant buttons of the keypad are separated from vowel buttons of the keypad, each consonant button arranging one or more consonants and each vowel button arranging one or more vowels, the method comprising:
(a) detecting input of simple code; and
(b) processing the simple code by comparing the inputted simple code with simple code stored in index.

27. The method of claim 5, wherein the consonant button or the vowel button is to enter Hindi, and short vowels (i.e., basic vowels) [symbol]
are not grouped into a same group and are arranged on different vowel buttons.

28. The method of claim 27, wherein the consonant button or the vowel button is to enter Hindi, and “a short sound vowel (i.e., a basic vowel)”, “a long sound vowel”, and “compound vowel(s)” are grouped into a group and arranged on a button.

29. The method of claim 5, wherein the consonant button or the vowel button is to enter Hindi, and vowels arranged in a button are selected according to the number of times of pressing the button in the order of “a short sound vowel (i.e., a basic vowel)-a long sound vowel-compound vowel(s).”

30. The method of claim 5, wherein the consonant button or the vowel button is to enter Hindi, and compound vowels are input by the predefined combination of short sound vowel or long sound vowel.

31. The method of claim 5, wherein the consonant button or the vowel button is to enter Russian, and vowels “a(a)”, “o(o)” which can be regarded as strong vowels are grouped into same group and arranged in the same button and vowels “y(u)”, “3(e)”, and “ [symbol] (i)” which can be regarded as weak vowel are not grouped with strong vowels group.

32. The method of claim 5, wherein the consonant button or the vowel button is to enter Indonesian, and vowel “a” and vowel “i” are not grouped into a same group and are arranged on different vowel buttons.

33. The method of claim 5, wherein the consonant button or the vowel button is to enter Indonesian, and vowel “a” and vowel “u” are not grouped into a same group and are arranged on different vowel buttons.

34. The method of claim 5, wherein the consonant button or the vowel button is to enter a language (including Chinese Pinyin) using Roman alphabet, and vowel “a” and vowel “i”, and vowel “e” and vowel “i” are not grouped into a same group and are arranged on different vowel buttons.

35. The method of claim 5, wherein the consonant button or the vowel button is to enter a language (including Chinese Pinyin) using Roman alphabet, and vowel “e” and vowel “i”, and vowel “o” and vowel “u” are not grouped into a same group and are arranged on different vowel buttons.

36. The method of claim 5, wherein the consonant button or the vowel button is to enter a language (including Chinese Pinyin) using Roman alphabet, and vowel “o” and vowel “u”, and vowel “a” and vowel “i” are not grouped into a same group and are arranged on different vowel buttons.

37. The method of claim 5, wherein the consonant button or the vowel button is to enter a language (including Chinese Pinyin) using Roman alphabet, and vowel “a” and vowel “i”, vowel “e” and vowel “i”, and vowel “o” and vowel “u” are not grouped into a same group and are arranged on different vowel buttons.
